(19) United States
(12) Patent Application Publication
(10) Pub. No.: US 2005/0289182 A1
(43) Pub. Date: Dec. 29, 2005

(54) Document management system with enhanced intelligent document recognition capabilities

(75) Inventors: Suresh S. Pandian, Cupertino, CA (US); Thyagarajan Swaminathan, Cupertino, CA (US); Subramaniyan Neelagandan, Santa Clara, CA (US); Krishna K. Srinivasan, Fremont, CA (US); Randal J. Martin, Naples, FL (US)

Correspondence Address: NIXON & VANDERHYE, PC, 901 NORTH GLEBE ROAD, 11TH FLOOR, ARLINGTON, VA, 22203, US

(73) Assignee: Sand Hill Systems Inc., Sunnyvale, CA (US)

(21) Appl. No.: 10/894,338

(22) Filed: Jul. 20, 2004

Related U.S. Application Data
(60) Provisional application No. 60/579,277, filed on Jun. 15, 2004.

(51) Int. Cl. G06F 17/00

(52) U.S. Cl. 707/104.1

(57) ABSTRACT

An intelligent document recognition-based document management system includes modules for image capture, image enhancement, image identification, optical character recognition, data extraction and quality assurance. The system captures data from electronic documents as diverse as facsimile images, scanned images and images from document management systems. It processes these images and presents the data in, for example, a standard XML format. The document management system processes both structured document images (ones which have a standard format) and unstructured document images (ones which do not have a standard format). The system can extract images directly from a facsimile machine, a scanner or a document management system for processing.

### CROSS-REFERENCE TO RELATED APPLICATION

This application claims the benefit of Provisional Application No. 60/579,277, filed on Jun. 15, 2004, which application is hereby incorporated by reference in its entirety.

### FIELD OF THE INVENTION

The invention generally relates to methods and apparatus for managing documents. More particularly, the present invention relates to methods and apparatus for document management, which capture image data from electronic document sources as diverse as facsimile images, scanned images, and other document management systems and provides, for example, indexed, accessible data in a standard format which can be easily integrated and reused throughout an organization or network-based system.

### BACKGROUND AND SUMMARY OF THE INVENTION

For many organizations, efficiently managing documents and transaction-centric business processes is a major challenge. Key business processes involving the use of numerous printed documents and/or document images are far too often fraught with inefficiencies and opportunities for error.

Without a mechanism for efficiently capturing and accessing documents and related content on-line, organizations have little opportunity to use and build on the vast information in their documents by integrating such information with the companies business processes, such as, for example, its customer relationship management process.

The widespread use of paper and form-based processes also limits an organization's ability to take full advantage of the information flowing into, within and out of the company.

Many organizations are moving toward the goal of a paperless office by implementing document-management solutions which allow them to store documents and forms as electronic images in a document management repository. In many organizations, a document is received, scanned and then a bit-mapped document image is circulated among relevant personnel. Although this approach may eliminate multiple circulating hard copies of documents, the documents must be read, understood, and often times later retrieved by the various personnel quickly from different applications.

A need exists for a document management system which efficiently analyzes and indexes such bit mapped images of documents to determine the nature of the document, and to efficiently generate index information for the document. Such index information, for example, would identify that the document is a bank statement from a particular bank, for a particular month.

The inventors have recognized that a need exists for methods and apparatus for efficiently storing, retrieving, searching and routing electronic documents so that users can easily access them.

The illustrative embodiments describe exemplary document management systems which increase the efficiency of organizations so that they may quickly search, retrieve and reuse information that is embedded in printed documents and scanned images. The illustrative embodiments permit manually associating key words as indices to images using the described document management system. In this fashion, key words are extracted and data from the images become automatically available for reuse in various other applications.

The illustrative embodiments provide integrated document management applications which capture and process all the types of documents an organization receives, including e-mails, faxes, postal mail, applications made over the web and multi-format electronic files. The document management applications process these documents and provide critical data in a standard format which can be easily integrated and reused throughout an organization's networks.

In an illustrative embodiment of the present invention, a client-server application referred to herein as the “Image Collaborator” is described. Image collaborator is also referred to herein as IMAGEdox, which may be viewed as an illustrative embodiment of the Image Collaborator. The Image Collaborator is used as part of a highly scalable and configurable universal platform based server which processes a wide variety of documents: 1) printed forms, 2) handwritten forms, and 3) electronic forms, in formats ranging from Microsoft Word to PDF images, Excel spreadsheets, faxes and scanned images. The described server extracts and validates critical content embedded in such documents and stores it, for example, as XML data or HTML data, ready to be integrated with a company's business applications. Data is easily shared between such business applications, giving users the information in the form they want it. Advantageously, the illustrative embodiments make businesses more productive and significantly reduce the cost of processing documents and integrating them with other business applications.

In accordance with an exemplary embodiment described herein, the Image Collaborator-based document management system includes modules for image capture, image enhancement, image identification, optical character recognition, data extraction and quality assurance. The system captures data from electronic documents as diverse as facsimile images, scanned images and images from document management systems. It processes these images and presents the data in, for example, a standard XML format.

The Image Collaborator described herein, processes both structured document images (ones which have a standard format) and unstructured document images (ones which do not have a standard format). The Image Collaborator can extract images directly from a facsimile machine, a scanner or a document management system for processing.

In accordance with an exemplary embodiment, a sequence of images which have been scanned may be, for example, a multiple page bank statement. The Image Collaborator may identify and index such a statement by, for example, identifying the name of the associated bank, the range of dates that the bank statement covers, the account number and other key indexing information. The remainder of the document may be processed through an optical character recognition module to create a digital package which is available for a line of business application.

The system advantageously permits unstructured, non-standard forms to be processed by processing a scanned page and extracting key words from the scanned page. The system has sufficient intelligence to recognize documents based on such key words or variations of key words stored in unique dictionaries.

The exemplary implementations provide a document management system which is highly efficient, labor saving and which significantly enhances document management quality by reducing errors and providing the ability to process unstructured forms.

A document management method and apparatus in accordance with the exemplary embodiments may have a wide range of features which may be modified and combined in various fashions depending upon the needs of a particular application/embodiment. Some exemplary features which are contemplated and described herein include:

Image Capture
Scanned images are placed in a monitored directory. As files are detected in this directory they are processed.—
Quality Assurance
   Data Verification
   Use of a knowledge base of corrections required for various situations so that the Quality assurance process can become more autonomous

Data extraction from unstructured documents
Using Unique Dictionaries/gesture files
Call outs to validate the extracted data

Data extraction from structured documents may be accomplished by using various unstructured techniques including locating a marker, e.g., a logo, and using that as a floating starting point for structured forms.

In addition to above supporting structured documents data extraction using location based mechanism (Zone based)

Indexing & Collation Logic

Predictive Modeling and auto-tuning

Intelligent Document Recognition
The process of extracting data from semi/unstructured documents is referred to as intelligent document recognition
Data Extraction is performed on the server to maximize performance and flexibility

### BRIEF DESCRIPTION OF THE DRAWINGS

These, as well as other features of the present exemplary embodiments will be better appreciated by reading the following description of the preferred embodiments of the present invention, taken in conjunction with the accompanying drawings of which

FIG. 1 is an illustrative block diagram of a document management system in accordance with an illustrative embodiment of the present invention.

FIG. 2A and FIG. 2B are exemplary block diagrams depicting components of the Image Collaborator server 6.

FIG. 3 is an exemplary block diagram showing the data extraction process of an exemplary implementation.

FIG. 4 is an Image Collaborator system flowchart delineating the sequence of operations performed by the server and client computers.

FIG. 5A and FIG. 5B are a block diagram of a more detailed further embodiment of an Image Collaborator system sequence of operations.

FIG. 6 is a flowchart delineating the sequence of operations performed by the image pickup

FIG. 7 is a flowchart delineating the sequence of operations involved in image validation/verification processing.

FIG. 8 is a flowchart delineating the sequence of operations involved in pre-identification image enhancement processing.

FIG. 9 is a flowchart delineating the sequence of operations involved in image identification processing.

FIG. 10 is a flowchart delineating the sequence of operations involved in post-identification image enhancement.

FIG. 11 shows image character recognition processing.

FIG. 12 is a flowchart of a portion of the dictionary entry extraction process.

FIG. 13 is a more detailed flowchart explaining the dictionary processing in further detail.

FIG. 14 is a flowchart delineating the sequence of operations involved in sorting document images into different types of packages.

FIG. 15 is a flowchart delineating the sequence of operations involved in image enhancement in accordance with a further exemplary implementation.

FIG. 16 is a flowchart delineating the sequence of operations involved in image document/dictionary pattern matching in accordance with a further exemplary embodiment.

FIG. 17 is a flowchart delineating the sequence of operations in a further exemplary OCR processing embodiment.

FIG. 18 is an IMAGEdox initial screen display window and is a graph which summarizes the seven major steps involved in using IMAGEdox after the product is installed and configured.

FIG. 19 is an exemplary applications setting window screen display.

FIG. 20 is an exemplary services window screen display.

FIG. 21 is an exemplary output data frame screen display.

FIG. 22 is an exemplary Processing Data Frame screen display.

FIG. 23 is an exemplary General frame screen display.

FIG. 24 shows an illustrative dictionary window screen display.

FIG. 25 shows an illustrative “term” pane display screen.

FIG. 26 is an exemplary Add Synonym display screen.

FIG. 27 is an exemplary Modify Synonym—Visual Clues window.

FIG. 28 is an exemplary font dialog display screen.

FIGS. 29A, 29B, 29C, 29D are exemplary Define Pattern display screens.

FIGS. 30A and 30B are exemplary validation script-related display screens.

FIG. 31 is an exemplary verify data window display screen.

FIG. 32 is a further exemplary verify data window display screen.

FIG. 33 is a graphic showing an example of a collated XML file.

FIG. 34 is an exemplary expanded collated XML file.

FIG. 35A is an exemplary IndexVariable.XML file.

FIG. 35B is an exemplary index XML file.

FIG. 36 is an exemplary unverified output XML file.

FIG. 37 is an exemplary verified output XML file.

### DETAILED DESCRIPTION OF THE ILLUSTRATIVE EMBODIMENTS

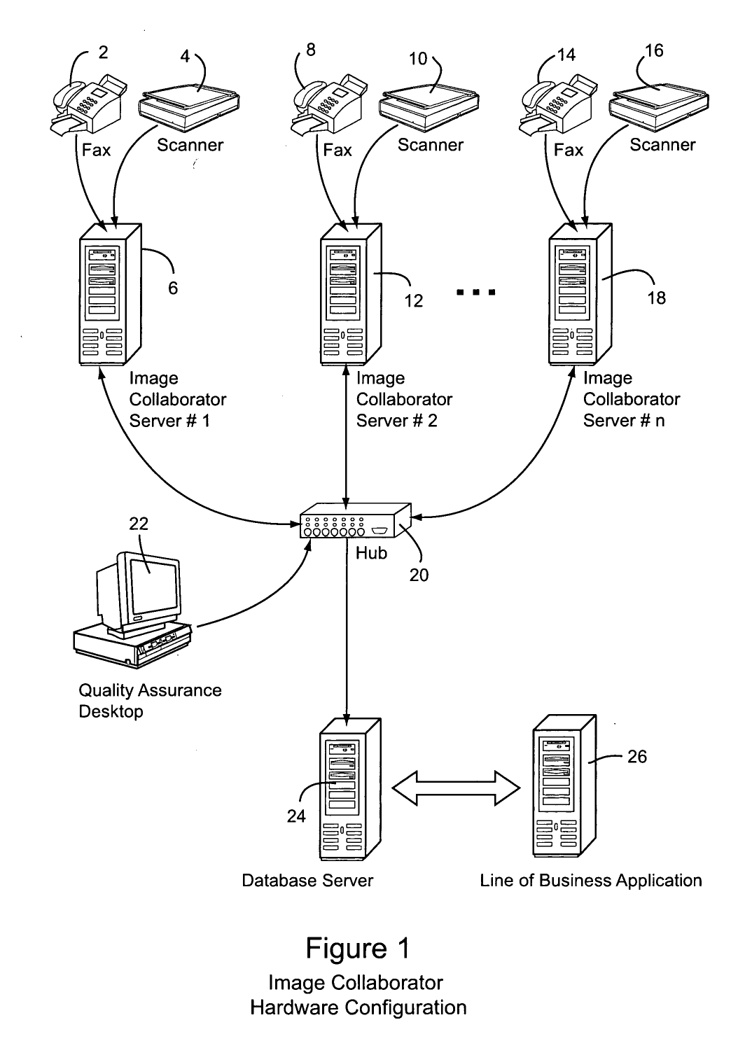

FIG. 1 is a block diagram of an illustrative document management system in accordance with an exemplary embodiment of the present invention. The exemplary system includes one or more Image Collaborator servers 1, 2 . . . n (6, 12 . . . 18), which are described in detail herein. Although one Image Collaborator server may be sufficient in many applications, multiple Image Collaborator servers 6, 12, 18 are shown to provide document management in high volume applications.

As shown in FIG. 1, each Image Collaborator 6, 12, 18 is coupled to a source of electronic documents, such as facsimile machines 2, 8, 14, or scanners 4, 10, 16. The Image Collaborator servers 6, 12 and 18 are coupled via a local area network to hub 20. Hub 20 may be any of a variety of commercially available devices which connect multiple network nodes together for bidirectional communication.

The Image Collaborator servers 6, 12 and 18 have access to a database server 24 via hub 20. In this fashion, the results of the document management processing by Image Collaborator 6, 12 or 18 may be stored in database server 24 for forwarding, for example, to a line of business application 26.

Each Image Collaborator server 6, 12, and 18 is likewise coupled to a quality assurance desktop 22. As explained below, in an exemplary implementation, the quality assurance desktop 22 runs client side applications to provide, for example, a verification function to verify each record about which the automated document management system had accuracy questions.

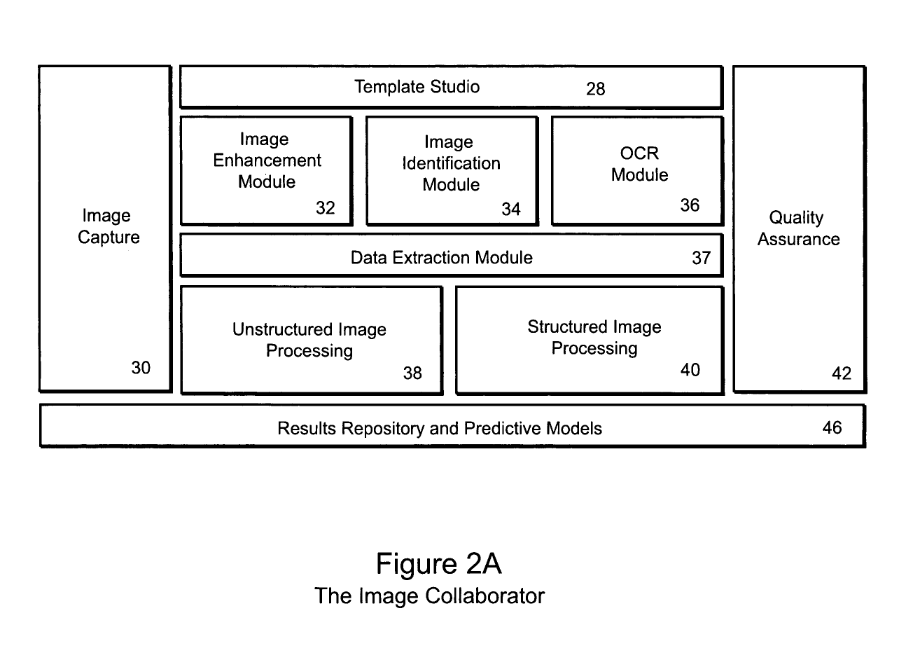

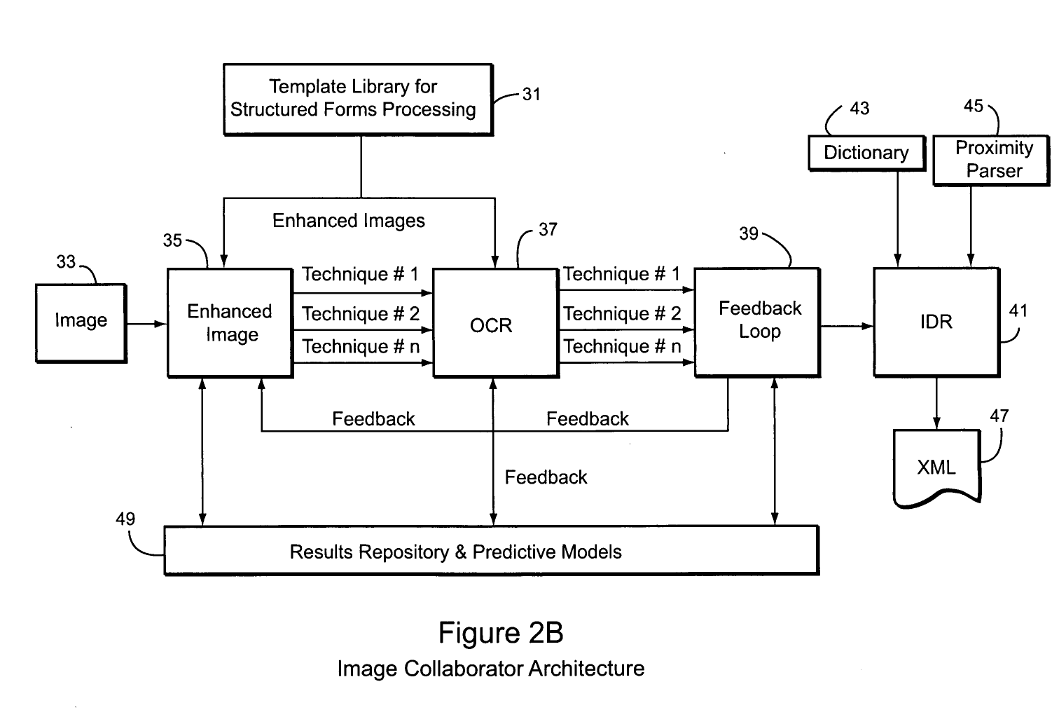

FIG. 2A is an exemplary block diagram depicting components of Image Collaborator server 6 shown in FIG. 1 in accordance with an illustrative embodiment. In this illustrative embodiment, Image Collaborator 6 is a client-server application having the following modules: image capture 30, image enhancement 32, image identification 34, optical character recognition 36, data extraction 37, unstructured image processing 38, structured image processing, 40, quality assurance/verification 42, and results repository and predictive models 46.

The application captures data from electronic documents as diverse as facsimile images, scanned images, and images from document management systems interconnected via any type of computer network. The Image Collaborator server 6 processes these images and presents the data in a standard format such as XML or HTML. The Image Collaborator 6 processes both structured document images (ones which have a standard format) and unstructured/semi-structured document images (ones which do not have a standard format or where only a portion of the form is structured). It can collect images directly from a fax machine, a scanner or a document management system for processing. The Image Collaborator 6 is operable to locate key fields on a page based on, for example, input clues identifying a type of font or a general location on a page.

As shown in FIG. 2A, the Image Collaborator 6 includes an image capture module 30. Image capture module 30 operates to capture an image by, for example, automatically processing input placed in a storage folder received from a facsimile machine or scanner. The image capture module 30 can work as an integral part of the application to capture data from the user's images or can work as a stand alone module with the user's other document imaging and document management applications. When the image capture module 30 is working as part of the Image Collaborator 6 it can acquire images from both fax machines and scanners. If the user has batch scanners, the module may, for example, extract images from file folders from document management servers.

The image enhancement module 32 operates to clean up an image to make the optical character recognition more accurate. Inaccurate optical character recognition is most often caused by a poor quality document image. The image might be skewed, have holes punched on it that appear as black circles, or have a watermark behind the text. Any one of these conditions can cause the OCR process to fail. To prevent this, the illustrative document Image Collaborator pre-processes and enhances the image. The application's image enhancement module 32 automatically repairs broken horizontal and vertical lines from scanned forms and documents. It preserves the existing text and repairs any text that intersected the broken lines by filling in its broken characters. The document image may also be enhanced by removing identified handwritten notations on a form.

The image enhancement tool 32 also lets the user remove spots from the image and makes it possible to separate an area from the document image before processing the data. The Image Collaborator, in the exemplary embodiment, uses a feedback algorithm to identify problems with the image, isolate it and enhance it. The image enhancement module 32 preferably is implemented using industry standard enhancement components such as, for example, the FormFix Forms Processing C/C++ Toolkit. Additionally, in the present implementation, the Image Collaborator optimizes the image for optical character recognition utilizing a results repository and predictive models module 46, which is described further below.

The Image Collaborator 6 also includes an image identification module 34 which, for example, may compare an incoming image with master images stored in a template library. Once it finds a match, the image identification module 34 sends a master image and transaction image to an optical character recognition module 36 for processing. The image identification module 34, provides the ability to, for example, distinguish a Bank of America bank statement from a Citibank bank statement or from a utility bill.

The optical character recognition module 36 operates on a received bit-mapped image, retrieves characters embodied in the bit mapped image and determines, for example, what type face was used, the meaning of the associated text, etc. This information is translated into text files. The text files are in a standard format such as, for example, XML or HTML. The optical character recognition module 36 provides multiple-machine print optical character recognition that can be used individually or in combination depending upon the user's requirements for speed and accuracy. The OCR engine, in the exemplary embodiment, supports both color and gray scale images and can process a wide range of input file types, including .tif, .tiff, JPEG and .pdf.

The Image Collaborator 6 also includes a data extraction module 37, which receives the recognized data in accordance with an exemplary embodiment from the character recognition module 36 either as rich text or as HTML text which retains the format and location of the data as it appeared in the original image. Data extraction module 37 then applies dictionary clues, regular expression rules and zone information (as will be explained further below), and extracts the data from the reorganized data set. The data extraction module 37 can also execute validation scripts to check the data against an external source. Once this process is complete, the Image Collaborator server 6 saves the extracted data, for example, in an XML format for the verification and quality assurance module 42. The data extraction module 37, upon recognizing, for example, that the electronic document is a Bank of America bank statement, operates to extract such key information as the account number, statement date. The other data received from the optical character recognition module 36 is made available by the data extraction module 37.

The Image Collaborator 6 also includes an unstructured image processing module 38, which processes, for example, a bank statement in a non-standard format and finds key information, such as account number information, even though the particular bank statement in question has a distinct format for identifying an account number (e.g., by acct.).

The Image Collaborator 6 unstructured image processing module 38 allows users to process unstructured documents and extract critical data without having to mark the images with zones to indicate the areas to search, or to create a template for each type of image. Instead, users can specify the qualities of the data they want by defining dictionary entries and clues, descriptions of the data's location on the image, and by building and applying regular expressions—pattern-matching search algorithms. Dictionary entries may, for example, specify all the variant ways an account number might be specified and identify these variants as synonyms.

Unstructured forms processing module 38 also allows the user to reassemble a document from the image by marking a search zone on the image and extracting data from it. The user can copy the data extracted from the search zone to the clipboard in Windows and paste it into a document-editing application.

When users mark a search zone, they can also indicate the characteristics of the data they want—for example, data types (dates, numerals, alphanumeric characters) or qualities of the text (hand-printed, dot-matrix, bolded text, font faces).

Another advantage of Image Collaborator's unstructured image processing module 38 is that users can do free-form processing of a document image to convert it into an editable document and still keep the same formatting as the original.

Exemplary features the Image Collaborator application uses to process unstructured images includes:
Preliminary image enhancement
Automatic image noise reduction
Auto-zoning and auto-recognition
Automatic data extraction
Keyword search
Integrated quality assurance
Document editing
Dictionary, custom dictionary, clues, and regular expressions
Business terms and synonyms dictionary definition
Business terms and synonyms search in the OCR text
Custom scripting call-out to validate data after it has been extracted
XML output
Line of business applications integration

The Image Collaborator 6 additionally includes a structured image processing module 40. The structured image processing module 40 recognizes that a particular image is, for example, a standard purchase order. In such a standard document, the purchase order fields are well defined, such that the system knows where all key data is to be found. The data may be located by, for example, well-defined coordinates of a page.

Normally, if a user wants to extract data from a structured image such as a form, he must create a template that identifies the data fields to search and all the locations on the document where the data may occur. If he needs to process several types of documents, the user needs to create templates for each of them. The Image Collaborator 6 with its structured image processing module 40 makes this easy to do, and once the templates are in place, the application processes the forms automatically.

Even though a business may build templates before processing its structured documents, it is cost-effective if the company has standard forms, such as credit applications or subscription forms, since the company can then rapidly do document management and data capture.

In accordance with the exemplary embodiments, the following features are used by the Image Collaborator application to process structured images:
Master image template registration
Zone definition—defining areas to search
Image Capture module integration—fax server, scanner
Preliminary image enhancement
Automatic image noise reduction
Image identification, to compare the image with a master template
Optical character recognition of data zones
Data extraction
Integrated quality assurance
Custom scripting call-out to validate data after it has been extracted
XML output
Line of business integration

Further details of structured image processing module 40 may be found in the applicants' copending application Ser. No. 10/837,889 and entitled “DOCUMENT/FORM PROCESSING METHOD AND APPARATUS USING ACTIVE DOCUMENTS AND MOBILIZED SOFTWARE” filed on May 4, 2004 by PANDIAN et al., which application is hereby incorporated by reference in its entirety. Still further details of structured image processing module 40 may be found in the applicants' copending application Ser. No. 10/361,853 and entitled “FACSIMILE/MACHINE READABLE DOCUMENT PROCESSING AND FORM GENERATION APPARATUS AND METHOD filed on Feb. 3, 2003 by Riss et al, which application is hereby incorporated by reference in its entirety.

The quality assurance/verifier module 42 allows the user to verify and correct, for example, the extracted XML output from the OCR module 36. It shows the converted text and the source image side-by-side on the desk top display screen and marks problem characters in colors so that an operator can quickly identify and correct them. It also permits the user to look at part of the image or the entire page in order to check for problems. Once the user finishes validating the image, Image Collaborator 6 via the quality assurance module 42 generates and saves the corrected XML data. It then becomes immediately available to the organization's other business applications.

The Image Collaborator 6 also includes a results repository and predictive models module 46. This module, for example, monitors the quality assurance/verifier module 42 to analyze the errors that have been identified. The module 46, in an exemplary embodiment, determines the causes of the problems and the solutions to such problems. In this fashion, the system may prevent recurring problems which are readily correctable to be automatically corrected.

In accordance with an exemplary embodiment, the above-described Image Collaborator 6 allows a user to specify data to find. In accordance with such an illustrative embodiment, the system also includes a template studio 28 which permits a user to define master zone templates and builds a master template library which the optical character recognition module 36 uses as it processes and extracts data from structured images.

In accordance with an exemplary embodiment, a user may define dictionary entries in, for example, three ways: by entering terms and synonyms in a dictionary, by providing clues to the location of the data on the document image, and by setting up regular expressions—pattern-matching search algorithms. With these tools, the Image Collaborator 6 can process nearly any type of structured or unstructured form.

Defining Zones

When a user defines a zone, the user can specify the properties of the data he or she wants to extract: a type of data (integer, decimal, alphanumeric, date), or a data-input format (check box, radio button, image, table), for example. The user can build regular expressions, algorithms that further refine the search and increase its accuracy. The user can also enter a list of values he wants to find in the zone. To define a zone called “State,” for example, the user could enter a list of the 50 states. He can also associate a list of data from an external database, and can specify the type of validation the application will do on fields once the data is extracted.

Defining Entries in the Dictionary

The Image Collaborator 6 uses a dictionary of terms and synonyms to search the data it extracts. Users can add, remove, and update dictionary entries and synonyms. The Image Collaborator 6 can also put a common dictionary in a shared folder which any user of the program can access.

Defining Clues and Regular Expressions

In an exemplary embodiment, the Image Collaborator 6 allows the user to define clues and regular expressions. Coupled with the search terms and synonyms in the dictionary, these make it possible to do nearly any kind of data extraction. Clues instruct the extraction engine to look for a dictionary entry in a specific place on the image (for example, in the top left-hand corner of the page). Regular expressions allow the user to describe the format of the data he wants.

Using these tools permits a user to do highly sophisticated searches. For example, he or she can set up generic clues and regular expressions in a standard dictionary then create a custom dictionary with other synonyms, clues, and regular expressions. If the user loads these two dictionaries into Image Collaborator, the application will use both of them to process and extract data. The program uses the custom dictionary for the first pass and the default dictionary for the second.

There can be multiple regular expressions for each synonym in the dictionary. For example, the user can write an algorithm which says, “Statement Date is a date field. It may occur in any of the following formats: mm/dd/yy, mm/dd/yyyy, mnim/dd/yy, or month/ddlyyyy.”

Here is an example of dictionary entries, synonyms, clues, and regular expressions:

A Set of Dictionary Entries

| | | | |
|---|---|---|---|
| Statement | Date | Look at the top | mm/dd/yyyy - mm/dd/yyyy |
| date | Thru | right-hand side | mon/dd/yyyy thru mon/dd/yyyy |
| | From date | of | mm/dd/yyyy |
| | To date | the page for the | mm/dd/yyyy |
| | | date or dates | |

Image collaborator 6 is a client server application that extracts data from document images. As indicated above, it can accept structure images, from documents with a known, standard format or unstructured images which do not have the standard format.

The application extracts data corresponding to key words from a document image. It allows the user to find key words, verify their consistency, perform word analysis, group related documents and publish the results as index files which are easy to read and understand. The extracted data is converted to, for example, a standard format such as XML and can be easily integrated with line of business applications.

It should be understood, that the components used to implement the Image Collaborator represented in FIG. 2A may vary widely depending on application needs and engineering trade-offs. Moreover, it should be understood that various components shown in FIG. 2A may not be used in a given application or consolidated in a wide variety of fashions.

FIG. 2B is a further exemplary embodiment depicting illustrative Image Collaborator architecture. As shown in FIG. 2B, an input image is received via a facsimile transmission or a scanned document (33), and input into an enhanced image module 35. As is explained further below, the enhanced image processing may, in an exemplary implementation, include multiple image enhancement processing stages by using multiple commercially available image enhancement software packages such as FormFix and ScanSoft image enhance software.

As described above, the image enhancement module 35 operates to clean up an image to make character recognition more accurate. The image enhancement module 35 uses one or more image enhancement techniques 1, 2 . . . n, to correct, for example, the orientation of an image that might be skewed, eliminate hole punch marks that appear as black circles on an image, eliminate watermarks, repair broken horizontal or vertical lines, etc. Additionally, as is explained further below, the image enhancement processing also utilizes various parameters which are set and may be fine tuned to optimize the chances of successful OCR processing. In an exemplary embodiment, these parameters are stored and/or monitored by results repository and predictive models module 49.

The enhanced image is then processed by OCR module 37. OCR module 37 attempts to perform an OCR operation on the enhanced image and generates feedback relating to the quality of the OCR attempt which, for example, is stored in the results repository and predictive models module 49. The feedback may be utilized to apply further image enhancement techniques and/or to modify image parameter settings in order to optimize the quality of the OCR output. The OCR module 37 may, for example, generate output data indicating that, with a predetermined set of image parameter settings and image enhancement techniques, the scanned accuracy was 95 percent. The results repository and predictive model module 49 may then trigger the use of an additional image enhancement technique designed to improve the OCR accuracy.

OCR module 37, as is explained further below, utilizes various OCR techniques 1, 2 . . . n. The OCR output is coupled to feedback loop 39, which in turn is coupled to the results repository and predictive models module 49. Feedback loop 39 may provide feedback directly to the enhanced image module 35 to perform further image enhancing techniques and also couples the OCR output to the results repository and predictive models module 49 for analysis and feedback to the enhanced image module 35 and the OCR module 37. Thus, based on an analysis of results, the optimal techniques can be determined for getting the highest quality OCR output. This process is repeated multiple times until the OCR output is obtained of the desired degree of quality.

In accordance with an exemplary implementation, a template library 31 for structured forms processing is utilized by the enhanced image module 35 and OCR module 37 for enabling the modules 35 and 37 to identify structured forms which are input via input image module 33. In this fashion, a form template may be accessed and compared with an input image to identify that the input image has a structure which is known, for example, to be a Bank of America account statement. Such identification may occur by identifying, for example, a particular logo in an area of an input image by comparison with a template. The identification of a particular structured form from the template library 31 may be utilized to determine the appropriate image enhancement and/or OCR techniques to be used.

After an OCR has been obtained of the desired degree of quality, further processing occurs as is explained in detail below, via an intelligent document recognition system 41. The intelligent document recognition system 41 includes all the post OCR processing that occurs in the system that is explained further below. This processing includes dictionary-entry extraction to identify key fields in an input image, verification of extracted data and generation of indexed and collated documents preferably in a standard format such as XML (47).

Dictionary module 43 represents one or more dictionaries that are described further below that identify, for example, the set of synonyms that represent a key document term such as a user's account number, which may be represented in the dictionary by acct., account no., acct. number, etc. As is explained further below, the intelligent document recognition module 41 accesses one or more dictionaries during the document recognition process.

Proximity parser 45 provides to the intelligent document recognition module 41, information indicating, for example, that certain data should appear in a predetermined portion of a particular form. For example, proximity parser 45 may indicate that a logo should appear in the top left hand corner of the form, thereby identifying a certain proximate location of the logo.

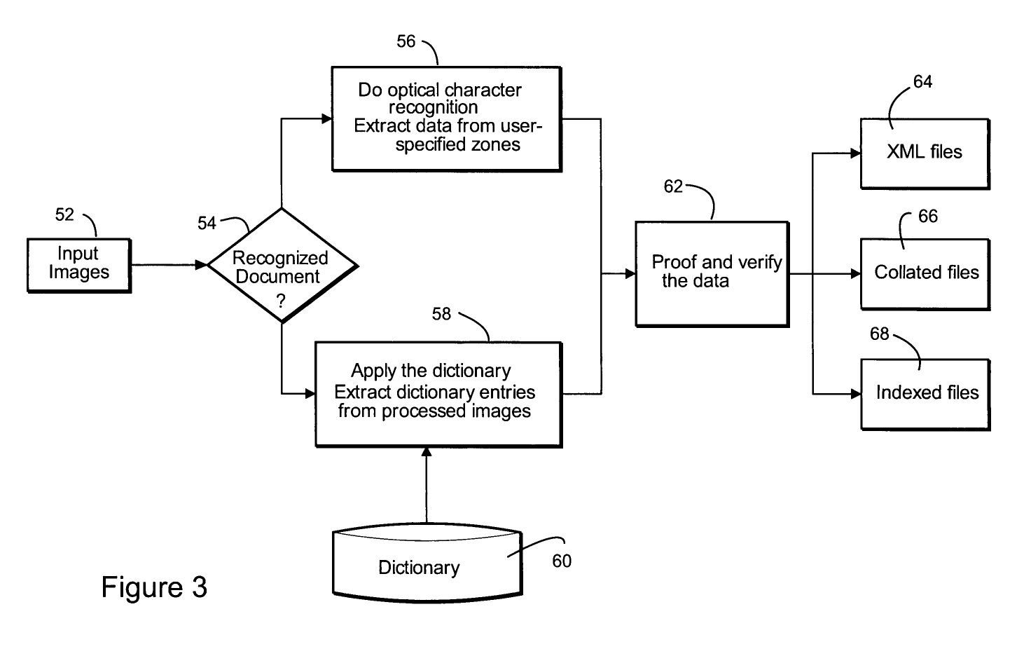

FIG. 3 is an exemplary flow diagram showing the data extraction process in an exemplary Image Collaborator implementation. The Image Collaborator 6 receives input images from a facsimile machine, a scanner or from other sources (52). A determination is made at block 54 as to whether the input image is a recognized document/form. If the document/form is recognized as a known structured form, (e.g. an IBM purchase order) then a template file is located for this form and an optical character recognition set of operations is performed in which data is extracted from user-specified zones, identified in the template file (56). The optical character recognition (56) may be performed utilized commercially available optical character recognition software which will operate to store all recognized characters in a file, including information as to the structure of the file and the font which was found, etc.

If the document is not recognized, then one or more dictionaries is utilized (58) to extract dictionary entries from processed images to retrieve, for example, a set of “synonyms” relating to an account number, date, etc. In this fashion, all variant representations of a particular field are retrieved from dictionary 60. The dictionary 60 is applied by scanning the page to search for terms that are in the dictionary. In this fashion, the bank statement may be scanned for an account number, looking for all the variant forms of “account number” and further searched to identify all the various fields that are relevant for processing the document.

The data extraction process also involves proofing and verifying the data (62). A quality assurance desktop computer may be used to display what the scanned document looks like together with a presentation of, for example, an account number. An operator is then queried as to whether, for example, the displayed account number is correct. The operator may then indicate that the account number is accurate or, after accessing a relevant data base, correct the account number as appropriate.

The output of the data extraction process is preferably a file in a standardized format, such as XML or HTML (64). The processed image document may, for example, contain the various indexed fields in a specially structured XML file. The actual optical character recognition output text may also be placed in an XML file. The system also stores collated files 66 to permit users to group together associated files to identify where a multiple page file begins and ends. The indexed files 68 contain the key fields that were found in the dictionary together with the field values to include, for example, the account numbers and dates for a given bank statement.

The Image Collaborator 6 will now be described in further detail. As indicated above, in an illustrative embodiment, the Image Collaborator 6 is a client-server application that extracts data from structured images from documents with a known, standard format, or unstructured or semi-structured images, which do not have a standard format. In accordance with an exemplary embodiment, the application includes the following illustrative features:
Image validation checks the input data files to make sure they have the appropriate types of compression, color scale, and resolution before sending them for processing.
Pre-identification image enhancement cleans up images for better identification and processing.
Image identification and categorization identifies and categorizes images by matching them to document templates to identify structured images and to assist data extraction.
Post-identification image enhancement (manual zoning): applying zones from the structured image template to the image allows user identified zones to be used for data extraction.
Data capture extracts, correlates, and standardizes the extracted content.
Data mining finds important information in large amounts of data.
Dictionary. A reference file the application uses for data extraction. It allows the user to define the entries to search.
Collation re-groups related page files into a single document. file.
Indexing organizes the extracted XML data.

In accordance with an exemplary embodiment, as indicated above, the Image Collaborator 6 is built on a client-server framework. Image enhancements and processing are performed in the server. Verification of the extracted data occurs on the client. In this illustrative implementation, the server operates automatically without waiting for instructions from the user.

A significant feature of the application is to extract valuable information from a set of input documents in the form of digital images. In an illustrative embodiment, the user specifies the desired data to extract by entering keywords in a dictionary.

In the illustrative embodiment, while processing the input images, the application first checks the validity of the input images. The image pickup service picks up, for example, TIF (or JPEG) images and processes them only if they satisfy the image properties of compression, color scale, and resolution required for image identification and OCR extraction. Next, the application checks the input images for quality problems and corrects them if necessary.

The Image Collaborator 6 allows the user to store image templates for easy identification and zone information, to mark document images with the areas from which to extract data. When the input image's pattern matches a pre-defined template, the file is identified and grouped separately. The application applies zone information from the template to the image before sending it for optical character recognition.

If an input image does not match a predefined template (if it doesn't have zones to search), the OCR module extracts data from the entire document image. The application then performs a regular-expression-based search on the output of the OCR module, in order to extract the values for the dictionary entries.

The user then uses the Data Verifier 42 to validate the extracted data.

In accordance with exemplary embodiments, the application also:
Exports the contents of images as HTML or Word document files.
Collates documents, grouping related images into a single document.
Indexes documents images for easy storage and retrieval.

Since it presents the extracted data as XML, the industry standard data type, Image Collaborator 6 allows the user to immediately work with it in his line of business applications.

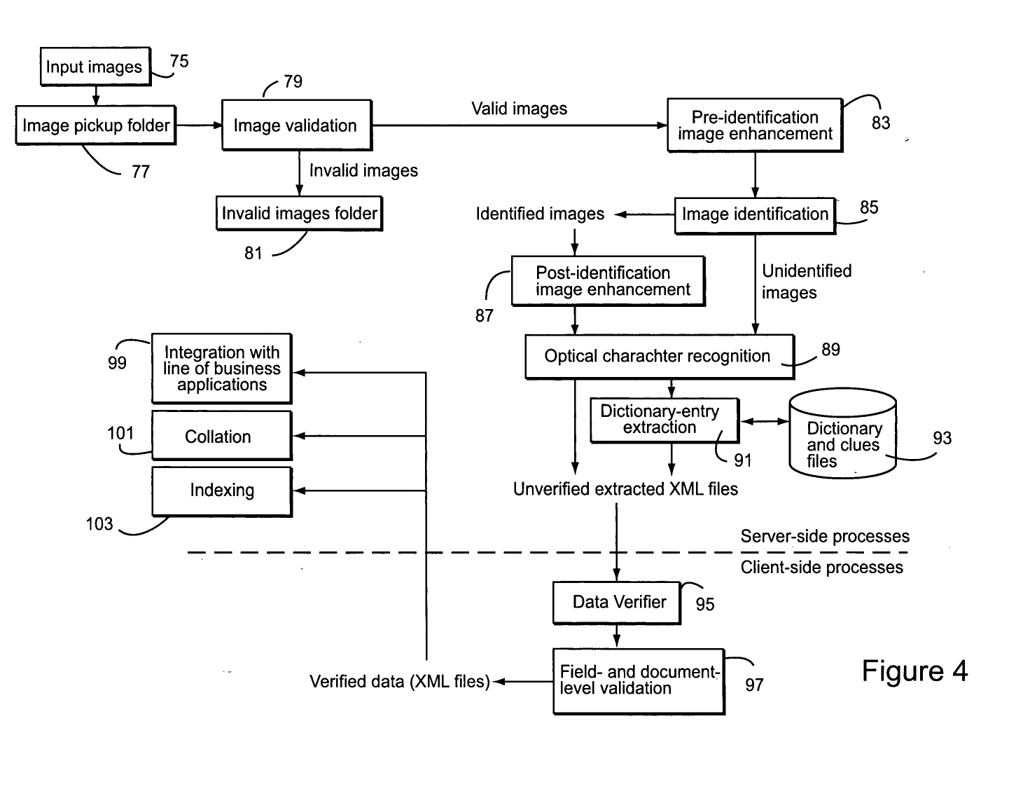

FIG. 4 is an Image Collaborator system flowchart delineating the sequence of operations performed by the server and client computers. In the exemplary implementation, the server side processes operate automatically, without even the need for a user interface. User interfaces can, if desired, be added to provide, for example, any desired status reports. The system operates automatically in response to an image input being stored in a predetermined folder.

Once the input image (75) from a facsimile or scanner is received in an image pickup folder (77), the system automatically proceeds to process such image data without any required user intervention. Thus, upon a user scanning a five page bank statement and transmitting the scanned statement to a predetermined storage folder (77), the system detects that image data is present and begins processing.

In an exemplary implementation, the Image Collaborator may require the image files to be in a predetermined format, such as in a TIF or JPEG format. The image validation processing (79) assures that the image is compatible with the optical character recognition module requirements. The image validation module 79 validates the file properties of the input images to make sure that they have the appropriate types of compression, color scale, and resolution and then sends them on for further processing.

If the files don't have the appropriate properties, the module 79 puts them in an invalid images folder (81). The particular file properties that are necessary to validate the image file will vary depending upon the optical character recognition system being utilized. Input images in the invalid images folder (81) may be the subject of further review either by a manual study of the input image file or, in accordance with alternative embodiments, an automated invalid image analysis. If the input image is from a known entity or document type, the appropriate corrective action may be readily determined and taken to correct the existing image data problem.

If the image data is determined to be valid, pre-identification image enhancement processing (83) takes place. The pre-identification image enhancement processing serves to enhance the OCR recognition quality and assist in successful data extraction. The pre-identification enhancement module 83 cleans and enhances the images. As indicated above, in an illustrative embodiment, the module 83 removes watermarks, handwritten notations, speckles, etc. The pre-identification image enhancement may also perform deskewing operations to correctly orient the image data which was misaligned due, for example, to the data not being correctly aligned with respect to the scanner.

The image collaborate 6, after pre-identification image enhancement, performs image identification processing (85). In image identification processing 85, the application attempts to recognize the document images by matching them against a library of document templates.

If a match is found, the application applies post identification enhancement (87) to the image by applying search zones to them. In this fashion, for example, the image identification 85 may recognize a particular logo in a portion of the document, which may serve to identify the document as being a particular bank statement form by Citibank. The image identification software may be, for example, the commercially available FormFix image identification software.

As a result of the image identification processing (85), images are either identified or not identified. Upon identification of an image, the image data undergoes post-identification image enhancement (87). In the post-identification image enhancement module 87, the application uses the zone fields in the document template to apply zones to the document image. Zones are the areas the user has marked on the template from which the user desires to extract data. Thus, the zones identify the portion of an identified image which has information of interest such as, for example, an account number. For identified images image enhancement can be optimized for the type of document. As an illustrative example, a particular document may be known to always contain a watermark, therefore, enhancement can be tuned accordingly.

If a match is not found, the image file is forwarded to module 89 where an optical character recognition extraction is performed on unidentified/unrecognized image files. Thus, OCR extraction is performed on document images which have no zones. Such image data cannot be associated with a template, and is therefore characterized as being “unidentified.” Therefore, the OCR module extracts the content from the entire data file. Under these circumstances, the OCR module will scan the entire page and read whatever it can read from an unidentified document.

For identified objects, after post-identification image enhancement (87) has been performed, the OCR module 89 processes images which have been identified by matching them to a template. In this case, OCR module 89 performs optical character recognition only on the data within the zones marked on the image. The template may also contain document specific OCR tuning information., e.g. a particular document type may always be printed on a dot matrix printer with Times Roman 10 point font.

After optical character recognition processing 89, dictionary-entry extraction and pattern matching operations are performed (91). In the exemplary embodiment, a HTML parser conducts a regular-expression search for the dictionary entries in dictionary and clue files 93. The application writes the extracted data to, for example, an XML or HTML file and sends it to a client side process for data verification. In this fashion, the output of the optical character recognition module 89 is scanned to look for terms that have been identified from the dictionary and clues file 93 (e.g., account number, date, etc.) and extract the values for such terms from the image data. In an illustrative implementation, the user defines the dictionary entries he or she wants to extract. The application writes them to the dictionary and clues file 93.

The output of the optical character recognition module 89 or the output of the dictionary-entry extraction module 91 results in unverified extracted files of a standard format such as XML or HTML. These files are forwarded to a data verifier module 95. The data verifier module 95 permits a user to verify and correct extracted data. When the user/administrator at the data verifier module 95 accepts the batch of images, the application saves the data as, for example, XML data. After data verification operations (95), a field and document level validation (97) may be performed to, for example, verify document account numbers or other fields. The output of the field and document level validation consists of verified data in, for example, either an XML or HTML file.

The verified data may then be sent to a line of business application 99 for integration therewith or to a module for collation into a multi-page document (101) and/or for indexing (103) processing. Indexing (103) is a mechanism that involves pulling out key fields in an image file, such as account number, date. These key fields are then used for purposes of indexing the files for retrieval. In this fashion, bank statements, indexed to a particular account number are readily retrieved. Thus, in an illustrative embodiment, the application collates the image files into multi-page documents, indexes them and integrates them with the dictionary entries in the verified XML output.

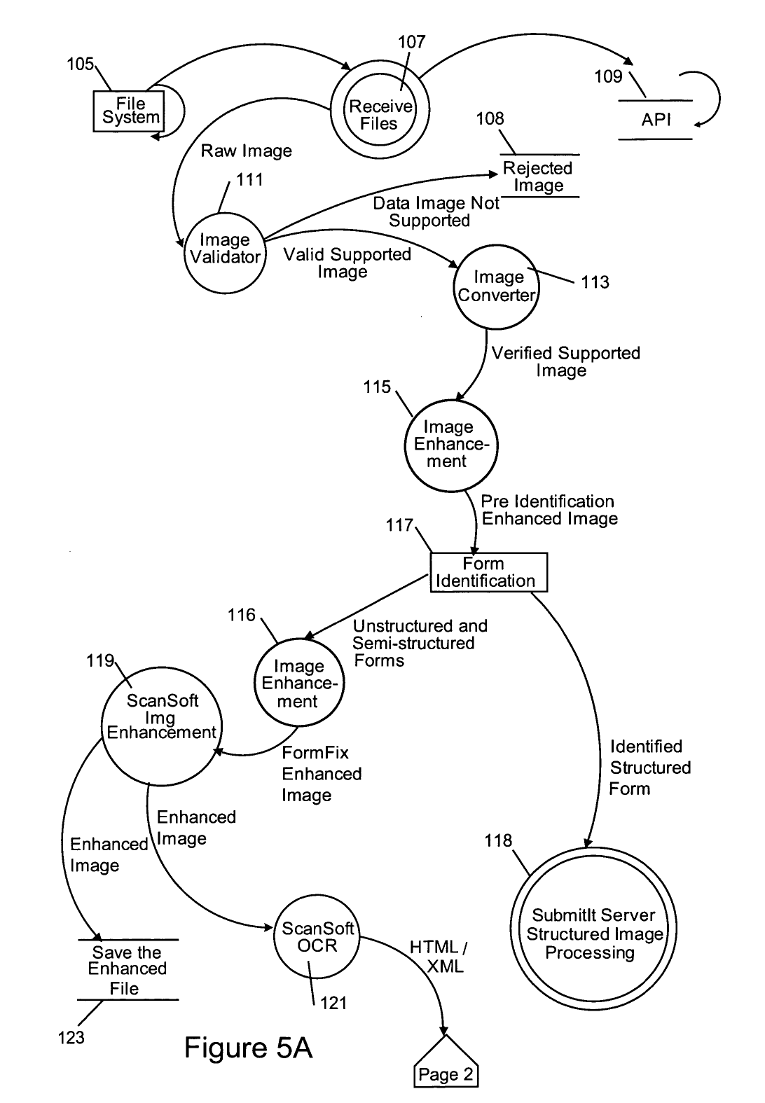

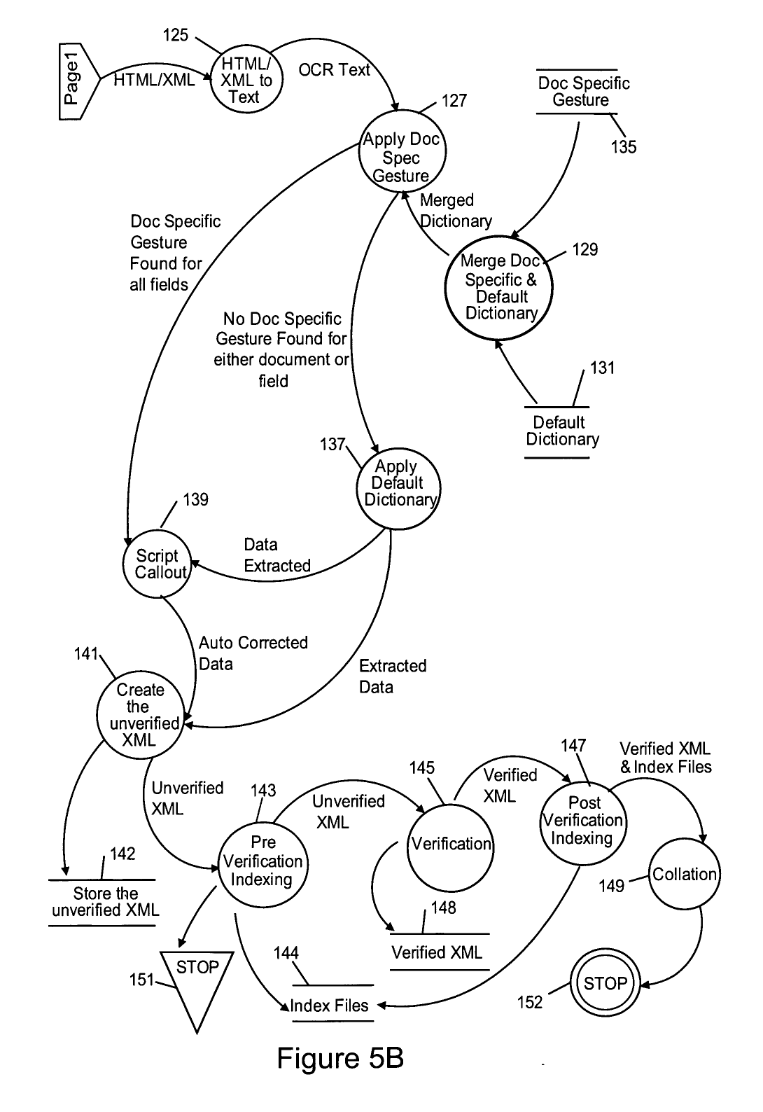

FIGS. 5A and 5B contain a block diagram of a more detailed further embodiment of an Image Collaborator system sequence of operations. Before examining the components of the FIG. 4 system flowchart in further detail, the FIG. 5A and FIG. 5B illustrative embodiment of a more detailed Image Collaborator system flowchart is first described. As described previously in conjunction with FIG. 4, the Image Collaborator 6 monitors a file system folder (105) and whenever it is detected that files are present in the folder, a processing mechanism is triggered. The detected image files are moved into a received files folder (107).

The Image Collaborator provides access to the system API (109) to permit a user to perform the operations described herein in a customized fashion tailored to a particular user's needs. The API gives the user access to the raw components of the various modules described herein to provide customization and application specific flexibility.

The raw image data from the image files is then processed by an image validator/verifier (111), which as previously described, verifies whether the image data is supported by the system's optical character recognition module (121). If the image fails the validation check, then the image file is rejected and forwarded to a rejected image folder (108).

If it is verified that the image data is supported by the system, the image data is transferred to an image converter (113). The image converter 113 may, for example, convert the image from a BMP file to an OCR-friendly TIF file. Thus, certain deficiencies in the image data which may be corrected, are corrected during image converter processing (113).

After processing by image converter 113, an OCR friendly image is forwarded to an image enhancement module 115 for pre-identification image enhancement, where, for example, as described above, watermarks, etc. are removed. Thereafter, a form identification mechanism 117 is applied to identify the document based on an identified type of form. In this embodiment, structured forms are detected by Form Identification 117, and directed to, for example, the applicants' SubmitIT Server for further processing as described in the applicants copending application FACSIMILE/MACHINE READABLE DOCUMENT PROCESSING AND FORM GENERATION APPARATUS AND METHOD, Ser. No. 10/361,853, filed on Feb. 11, 2002. For unstructured and semi-structured forms, depending upon the detected type of form, the image data may be processed together with forms of the same ilk in different processing bins. Thus, in this fashion, bank statements from, for example, Bank of America may be efficiently processed together by use of a sorting mechanism. After processing by Form Identification 117, an unstructured or semi-structured form is forwarded to post identification image enhancement where an identified form may be further enhanced using form specific enhancements. As indicated in FIG. 5A, the image enhancement 115, 116 may, for example, be performed using a commercially available “FormFix” image software package. Further image enhancement is performed in the FIG. 5A exemplary embodiment using commercially available ScanSoft image enhancement software (119). Depending upon a particular application, one or both image enhancement software packages may be utilized. Cost considerations and quality requirements may be balanced in this way. The enhanced image output of the ScanSoft image enhancement 119 may be saved (123) for subsequent retrieval.

The output from the image enhancement module 119 is then run through an OCR module 121 using, for example, commercially available ScanSoft OCR software. The output of OCR module 121 may be XML and/or HTML. This output contains recognized characters as well as information relating to, for example, the positions of the characters on the original image and the detected font information.

In FIG. 5B, this XML and/or HTML (125) is processed into a simple text sequence to facilitate searching. Additionally, a table is created that can be used to associate the text with for example, its font characteristics.

As represented in FIG. 5B, in an exemplary implementation, both a default dictionary 131 and a document specific “gesture” dictionary 135 are utilized. The default dictionary 131 is a generic dictionary that would include entries for fields, such as “date” pertinent to large groupings of documents. As date may be represented in a large number of variant formats, the dictionary would include “synonyms” or variant entries for each of these formats to enable each of the formats to be recognized as a date. Additionally, a document specific “gesture” or characteristic-related dictionary is utilized to access fields relating to, for example, specific types of documents. This dictionary contains a designation of a key field or set of fields that must be present in an image for it to be considered of the specific type. For example, such a dictionary may relate to bank statements and include account number as a key field., and for example, include a listing of variants for account number as might be included in a bank statement document. As represented by module 129, in this exemplary implementation, the system merges the document specific and default dictionaries.

For each key field in the document specific dictionary, the processing at 127 will search the OCR text. For each match, it filters the match with the document specific abstract characteristics or “gestures” to accept only matches that satisfy all requirements. If all required key fields are found the document is deemed to be of the specific type. As such, all remaining fields in the document specific dictionary are search for in like manner. If all required key fields are not found in the image, the document specific dictionary processing is bypassed. After applying document specific dictionary 127 is complete, the default dictionary is applied 137. The OCR text is searched for all fields in the default dictionary and similarly filtered with the default dictionary abstract characteristics.

If a match is found for an entry in a document specific dictionary or an entry in the default dictionary and that entry specifies a script callout, the script callout is executed (139), which will attempt to validate the data in the associated field. The script callout 139 may perform the validation by checking an appropriate database. Thus, for every element that is in the dictionary, an opportunity exists for specialized script to be created to initiate, for example, a validation check. In this fashion, a particular user may verify that the account number is a valid account number for a particular entity, such as Bank of America.

After the script callout 139 validation, if any is specified, the system creates an unverified XML file (141) which may be stored (142) for subsequent later use and to ensure that the OCR operations need not be repeated.

After creating the unverified XML, pre-verification indexing processing (143) is performed to determine whether verification is even necessary in light of checks performed on indexing information associated with the file. If the document need not go through the verification process, it is stored in index files 144 or, alternatively, the routine stops if the document cannot be verified (151).

If the unverified XML needs to be verified, it is forwarded to a client side verification station, where a user will inspect the XML file for verification purposes. The verified XML file may be stored 148 or sent to post-verification indexing to repeat any prior indexing since the verification processing may have resulted in a modified file. In this fashion, the index file is indexed, for example, based on a corrected account number, which was taken care of during verification processing at 145. Thereafter, collation operations on, for example, a multi-page file such as bank statement may be performed (149) after which the routine stops (153).

Turning back to the FIG. 4 Image Collaborator system flowchart, the processing occurring in each of the components shown therein will now be described in further detail. As each step is completed in the system 4 flowchart processing, the image file is moved from one file folder to another file folder. By having separate file folders, parallel processing operations are performed thereby increasing system throughput.

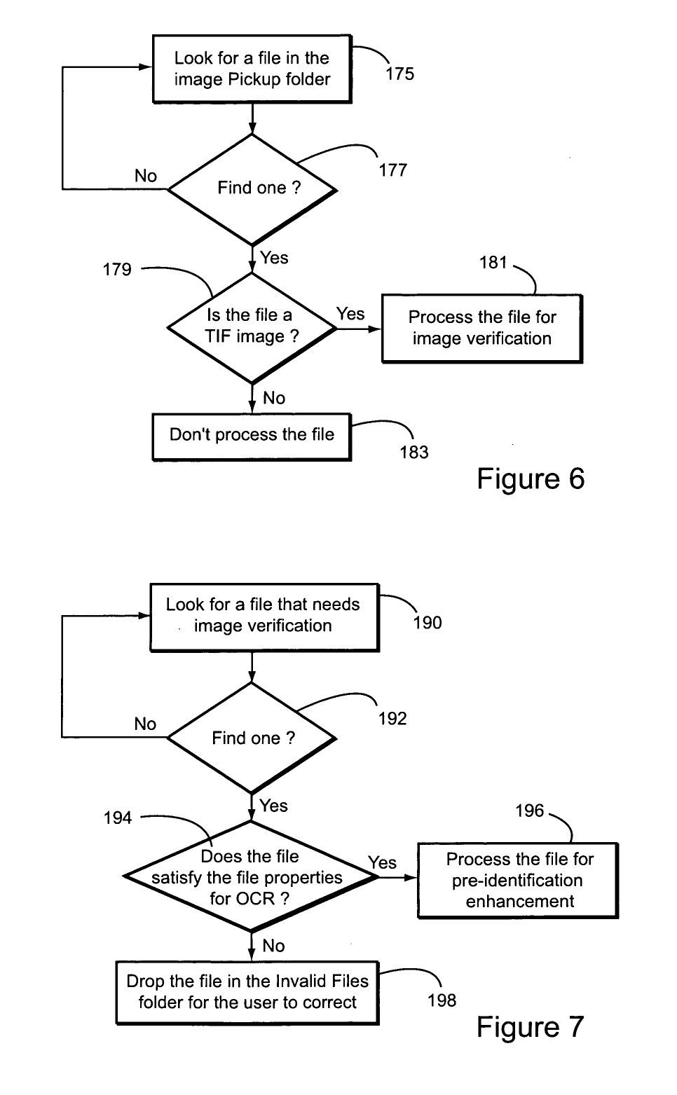

Turning first to the FIG. 4 input images module (75), FIG. 6 is a flowchart delineating the sequence of operations performed by the image pickup module (75). The image pickup service constantly checks the image pickup folder for images that need to be processed. In an exemplary embodiment, the service only accepts TIF images (although in other exemplary embodiments JPEG images are accepted). When a TIF image appears in the folder, the service automatically picks it up and sends it for further processing. The image folder can be integrated with a line of business application, such as a document management system, using an API, or the folder can be configured to a default output folder for a scanner application. The service validates all the images it picks up. Users specify the image pickup folders path name under application settings, often making it the same folder in which their scanner placed its output. In that case, the Image Collaborator, in accordance with an exemplary embodiment, picks up the document images where the scanner left them.

As shown in FIG. 6, the system looks for a file in the image pickup folder (175). A check is then made to determine whether a file is present in the image pickup folder (177). If no file is present in the image pickup folder, the routine branches back to block 175 to again look for a file in the image pickup folder. If an image file is found in the image pickup folder, then a determination is made as to whether, in the exemplary embodiment, the file is a TIF image. If the file is a TIF image, then the file is processed for image verification (181). If the file is not a TIF image, then the file is not processed (183). As indicated above, in accordance with a further exemplary embodiment, even if the file is not a TIF image, the file may be processed and converted to a TIF image and thereafter processed for image verification.

Turning next to the FIG. 4 image validation processing (79), in accordance with an exemplary embodiment, the Image Collaborator 6 requires that input images have certain file properties such as specific types of compression, color scale, and resolution before it will submit them for identification and optical character recognition. The application uses the image verifier/validation 79 to check for those properties and to identify and transfer any invalid files to an invalid files folder. As will be appreciated by those skilled in the art, the file properties that a given Image Collaborator application supports or does not support may vary widely from application to application. For example, in certain applications only bi-level color may be supported. In other applications 4-bit Grayscale, 8-bit Grayscale, RGB_Palette, RGB, Transparency_Mask, CMYK, YcbCr, CIELab may be supported. Similarly, in accordance with an exemplary embodiment, some forms of file types supported by a compression function may be PackBits, CCITT_D, Group3_Fax, Group4_Fax, while uncompressed LZW and JPEG files may not be supported. However, it should be recognized that the properties which are supported, as noted above, may vary depending upon the Image Collaborator application. In accordance with an exemplary embodiment, a user can resubmit previously invalid image files after examining them and correcting the file properties.

FIG. 7 is a flowchart delineating the sequence of operations involved in image validation/verification processing. As shown in the FIG. 7, the image validation/verifier looks for a file in its folder that needs image verification (190). A check is then made to determine whether a file that needs image verification is found (192). If no file is found that needs image verification, the routine branches back to block 190 to once again look for a file that needs image verification.

If a file is found that needs image verification, a check is made at block 194 to determine whether the file satisfies certain file properties for OCR compatibility, such as those identified above, which properties may vary depending upon a given application implementation. If the file satisfies the file properties criteria, then the file is processed for pre-identification enhancement (196). If the file does not satisfy the file properties, then the file is placed in the invalid file folders for the user to correct (198). In accordance with an exemplary embodiment, all files which may be automatically converted to have file properties which are compatible with the particular OCR software used in a given application will be automatically converted and not placed in an invalid file folder for manual correction.

Turning next to the FIG. 4 pre-identification image enhancement module 83, the Image Collaborator 6 automatically identifies and enhances low-quality images. The pre-identification image enhancement module cleans and rectifies such low-quality images, producing extremely clear, high quality images that ensure accurate optical character recognition. The pre-identification enhancement settings are used, for example, for repairing faint or broken characters and removing watermarks. The settings identify forms correctly, even when the image input file contains a watermark that was not on the original document template. They remove the watermark.

Additionally, the pre-identification enhancement module straightens skewed images, straightens rotated images, and removes document borders and background noise. For example, a black background around a scanned image adds significantly to the size of the image file. The application's pre-identification enhancement settings automatically remove the border.

Further, the pre-identification enhancement settings may, in an exemplary embodiment, be used to ignore annotations such that forms will be identified correctly, even when the input image files contain such annotations that were not part of an original document template. Similarly, the settings are used to correctly identify a form even when the image contains headers or footers that were not on the original document template.

The pre-identification enhancement processing additionally removes margin cuts and identifies incomplete images. Thus, the settings identify forms even when there are margin cuts in the image. The application aligns a form with a master document to help find the correct data. The settings correctly identify incomplete images.

In an exemplary embodiment, white text on black background will be turned into black text on a white background. Since in this exemplary embodiment, the OCR software cannot recognize white text in black areas of the image, the pre-identification enhancement settings create reversed out text by converting the white text to black and removing the black boxes. Further, in accordance with an exemplary embodiment, the pre-identification enhancement processing removes lines and boxes around text, removes background noise and dot shading. Thus, the system has a wide range of pre-identification enhancement settings that may vary from application to application. By way of example only, illustrative settings may be as follows:

| Setting = Value | Setting = Value |
|---|---|
| textdeskew = 0 | fixwhitetext = 1 |
| mindetectlength = 150 | invheight = 75 |
| maxacceptableskew = 100 | invwidth = 300 |
| deskewprotect = 0 | invedge = 0 |
| horizontalregister = 0 | invreportlocation = 0 |
| resultantleftmargin = 150 | subimage = 0 |
| horzlineregister = 0 | subimagetopedge = 0 |
| horzcentralfocus = 0 | subimagebottomedge = 0 |
| horzaddonly = 0 | subimageleftedge = 0 |
| horzignoreholes = 0 | subimagerightedge = 0 |
| verticalregister = 0 | subimagepad = 0 |
| resulantuppermargin = 150 | despeckhorizontal = 0 |
| vertcentralfocus = 1 | despeckvertical = 0 |
| vertaddonly = 0 | despeckisolated = 0 |
| vertlineregister = 0 | turnbefore = 0 |
| deshade = 0 | turnafter = 0 |
| deshadeheight = 0 | maxperiodheight = 0 |
| deshadewidth = 0 | expectedfrequency = 0 |
| maxspecksize = 0 | stealthmode = 0 |
| horzadjust = 0 | options = |
| vertadjust = 0 | smooth = 0 |
| protect = 0 | dialation = 0 |
| deshadereportlocation = 0 | erosion = 0 |
| horzlinemanage = 1 | autoportrait = 0 |
| horzminlinelength = 150 | autoupright = 0 |
| horzmaxlinewidth = 20 | autorevert = 0 |
| horzmaxlinegap = 0 | cropblack = 0 |
| horzcleanwidth = 2 | cropwhite = 0 |
| horzreconstructwidth = 30 | customdialate = 0 |
| horzreport = 0 | |
| vertlinemanage = 1 | |
| vertminlinelength = 150 | |
| vertmaxlinewidth = 20 | |
| vertmaxlinegap = 0 | |
| vertcleanwidth = 2 | |
| vertreconstructwidth = 30 | |
| vertreport = 0 | |

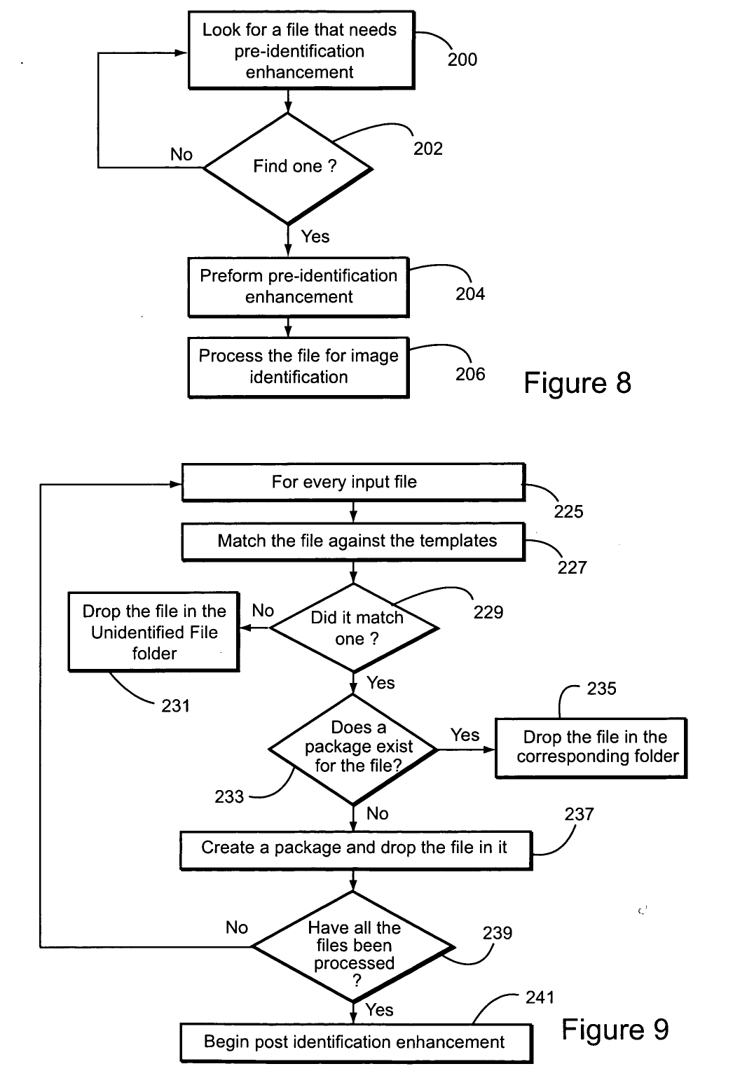

FIG. 8 is a flowchart delineating the sequence of operations involved in pre-identification image enhancement processing. Initially, the routine looks for a file that needs pre-identification enhancement (200) based on the above-identified criteria (200). Thereafter, a check is made to determine whether a file has been found that needs pre-identification enhancement (202). If no file is found that needs pre-identification enhancement, the routine branches back to block 200 to continue looking for such a file.

If a file is found which needs pre-identification image enhancement, then such pre-identification image enhancement is performed (204) and the file is processed for image enhancement (206) to repair faint or broken characters, remove watermarks, straighten skewed images, straighten rotated images, remove borders and background noise, ignore annotations and headers and footers, remove margin cuts, etc.

Turning next to the FIG. 4 system flowchart image identification module 85, the image identification processing involves matching an image document to a stored template. A structured image is an image of a document which is a standard format document. The Image Collaborator 6 has a library of user defined templates taken from structured documents. Each template describes a different type of document and is marked with zones which specify where to find the data the user wants to extract.

In the document image identification process, the image identification processing module 85 compares input images with the set of document templates in its library. The application looks for a match. If it finds one, it puts the document in a “package,” which is a folder containing other documents of that type. If no package exists, the application creates one. When the application finds more documents of that type, it drops them into the same package, so that all similar documents are in the same folder.

If a document image doesn't match any of the templates, the application drops it into an unidentified images folder.

An unstructured image is one which doesn't have a standard format. It is most often the type of image the application considers “unidentified.” The unstructured images are, however, processed utilizing the dictionary methodology described herein. Settings for the image identification module are stored in the application settings in a package identification file.

FIG. 9 is a flowchart delineating the sequence of operations involved in image identification processing. For every input file (225), the file is matched against the templates (227) stored, for example, in a library of templates. A check is then made at block 229 to determine whether the file matches a template. If no match is found, the file is placed in an unidentified file folder (231).

If a match does exist, a check is then made to determine whether a package exists for the file (233). If a package exists for the file, thereby indicating that a folder exists for other documents of that type, then the file is placed in the corresponding folder (235), to thereby appropriately sort the file.

If the check at block 233 indicates that a package does not exist for the file, then a package is created and the file is placed in it (237).

A check is then made at block 239 to determine whether all files have been processed. If all files have not been processed, the routine branches back to block 225 to access a further file. If all files have been processed, then post-identification enhancement is initiated (241).

Turning back to the FIG. 4 Image Collaborator system flowchart, post-identification image enhancement processing (87), this processing involves applying zones from a template to the image. In a structured image, i.e., one taken from a structured document, data is arranged in a standard, predictable way. It is known that on a certain document, a company name always appears, for example, at the top left-hand corner of a page. Given this knowledge, one can therefore reliably mark areas which contain the desired information. The Image Collaborator 6 uses zones, e.g., boxes around each area, to do this. The user can create them for every dictionary entry. Every zone has a corresponding field name, validation criteria, and the coordinates which mark the location of the zone on the image. The application stores this information in a “zone file” in the document template.

When the post identification image enhancement processing module 87 finds a match for a structured-document image (when it locates a template that matches and knows what type of document it is), the application maps the zones from the template onto the image. Later, when it performs the optical character recognition, the OCR module searches for data only within those zones. The application stores the extracted values against the same field name in the zone file. It can also merge the extracted data into a clean, master image, preserving the values in non-data fields.

For unstructured, unidentified images, OCR is performed on the entire image. Afterward, the extraction of the necessary data takes place means of the dictionaries and search logic, which is described herein.

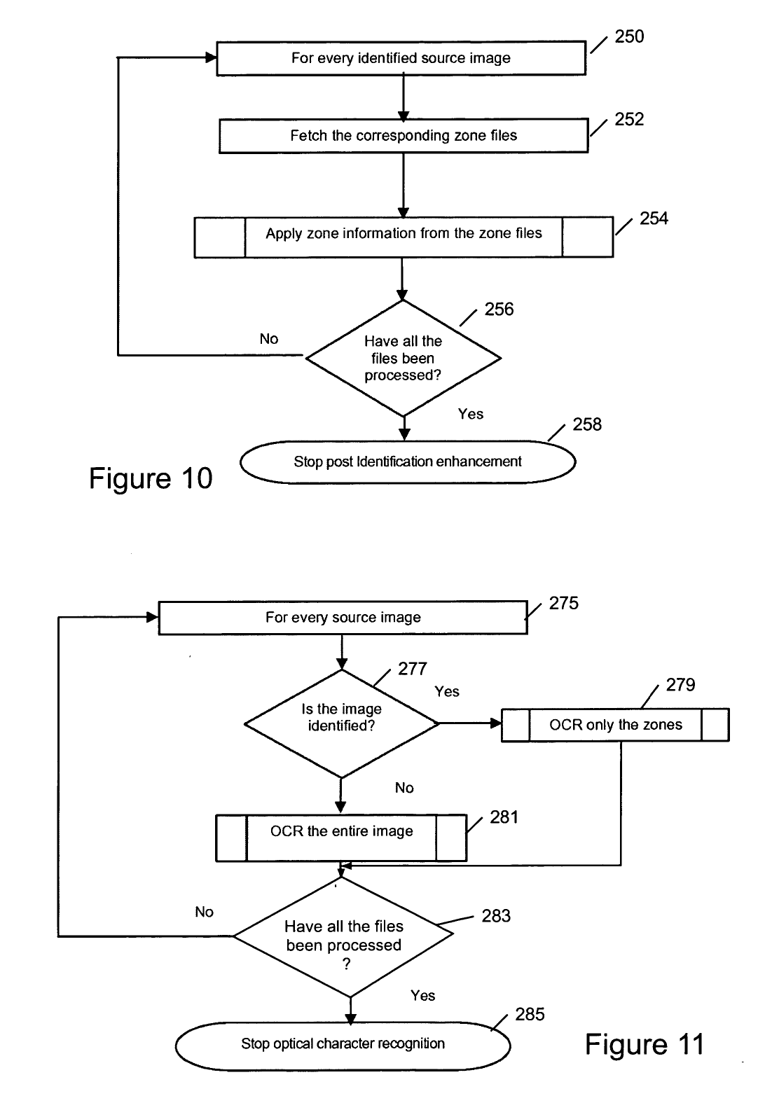

FIG. 10 is a flowchart delineating the sequence of operations involved in post-identification image enhancement of structured images. Turning to FIG. 10, for every identified source image (250), the corresponding zones files are fetched (252). In one exemplary embodiment, the zone files are incorporated as sections within the document template. After the corresponding zones files are fetched, the zone information is applied from the zone files (254). The zone information from the zone files is then applied to the OCR mechanism as is further explained below.

A check is then made to determine whether all the image files have been processed (256). If all the files have not been processed, the routine branches back to block 250 to process the next file. If the check at block 256 indicates that all the files have been processed, then post-identification enhancement processing stops (258). Thus, as result of the post-identification enhancement for structured documents, the zone information is accessed and it is made available for OCR.

Turning next to the Image Collaborator system flowchart optical character recognition processing module 89, this module performs optical character recognition on the image documents and extracts the necessary data, storing it, for example, in an XML or HTML format. The optical character recognition on the images resulting in the extraction of necessary data is stored as HTML in an exemplary embodiment for compatibility with the searching mechanism that is utilized to find synonyms for a given term.

Turning back to FIG. 2B Image Collaborator includes a feedback mechanism (43) which allows the image enhancement (35) and OCR (37) to be optimized by the use of predictive models (49). Image enhancement module (35) is controlled by a configuration file that contains a large number of “tunable” parameters as illustrated above. Similarly, OCR(37) has a configuration file that contains a similarly large number of tunable parameters illustrated below.

In an exemplary embodiment an image 33 would be enhanced 35 using image enhancement technique #1. OCR 37 would process the enhanced image using OCR technique #1 and make an entry in the results repository 49 as to the quality of the conversion, e.g. percent conversion accuracy. The feedback loop mechanism 39 would apply a predictive model to suggest a change to be made, for example, to image enhancement technique #1 yielding image enhancement technique #2. Next it would cause return control to image enhancement 35 where image enhancement technique #2 would be applied along with OCR technique #1. The feedback mechanism 39 would analyze the results to determine if the change improved or degraded the overall quality of the results. If the result was deemed beneficial, the change would be made permanent. Next, the feedback mechanism might adjust OCR technique #1 into technique #2 and the process would repeat. In this way the configurations of image enhancement 35 and OCR 37 could be optimized.

If zone files are available for structured images, the required dictionary entries are extracted directly. For unstructured images, when zone files are not available, in an exemplary embodiment, a HTML parser extracts the dictionary entries.

All images have undergone pre-identification enhancement, so OCR accuracy is optimized, ensuring that the optical character recognition in the exemplary embodiment is much more accurate than in basic OCR engines.

The various parameter values for OCR tuning vary from application to application. The following Table is an illustrative example of parameters for tuning the optical character recognition module:

Exemplary Values for OCR Tuning

| Parameters | Recommended values |
|---|---|
| ImageInputConversion | CNV_NO |
| ImageInputConversionBrightness | 50 |
| ImageInputConversionTreshold | 128 |
| ImageBinarization | CNV_AUTO |
| ImageResolutionEnhancement | RE_AUTO |
| ImageDespeckle | true |
| ImageInversion | INV_AUTO |
| ImageDeskew | DSK_AUTO |
| ImageDeskewSlope | 0 |
| ImageRotation | ROT_AUTO |
| ImageLineOrder | TOP_DOWN |
| ImagePadding | PAD_WORDBOUNDARY |
| ImageRGBOrder | COLOR_RGB |
| ImageStretch | STRETCH_DELETE |
| CodePage | Windows ANSI |
| MissingSymbol | \hat{ } |
| RejectionSymbol | ˜ |
| DefaultFillingMethod | FM_OMNIFONT |
| RecognitionTradeoff | TO_ACCURATE |
| Fax | false |
| SingleColumn | false |
| CharacterSetLanguages | LANG_ENG |
| LanguagePlus | |
| Filter | FILTER_ALL |
| FilterPlus | |
| OMRFrame | FRAME_AUTO |
| OMRSensitivity | SENSE_NORMAL |
| Decomposition | DCM_AUTO |
| NonGriddedTableDetect | True |

FIG. 11 is a flowchart delineating the sequence of operations involved in image character recognition processing. For every source image (275), a check is made to determine whether the image is identified (277). If the check at block 277 indicates that the image is identified, then the optical character recognition module OCR's only the zones (279). If the image is not identified, then the entire image is OCR'ed (281).

A check is then made to determine whether all the files have been processed (283). If all the files have not been processed, the routine branches back to block 275 to process the next file. Once all the files have been processed, the optical character recognition processing ends (285).

Turning next to the Image Collaborator system flowchart dictionary-entry extraction (91). In an exemplary embodiment, an HTML parser extracts the dictionary entries. It converts the HTML source generated during OCR extraction into a single string. In the exemplary embodiment, the parser writes the content that is between the <Body> and the </Body> HTML tags in the string to a TXT file. The parser then conducts a regular-expression-based search on the text files for the dictionary entries and extracts the necessary data. It populates the extracted entries into an extracted XML file.

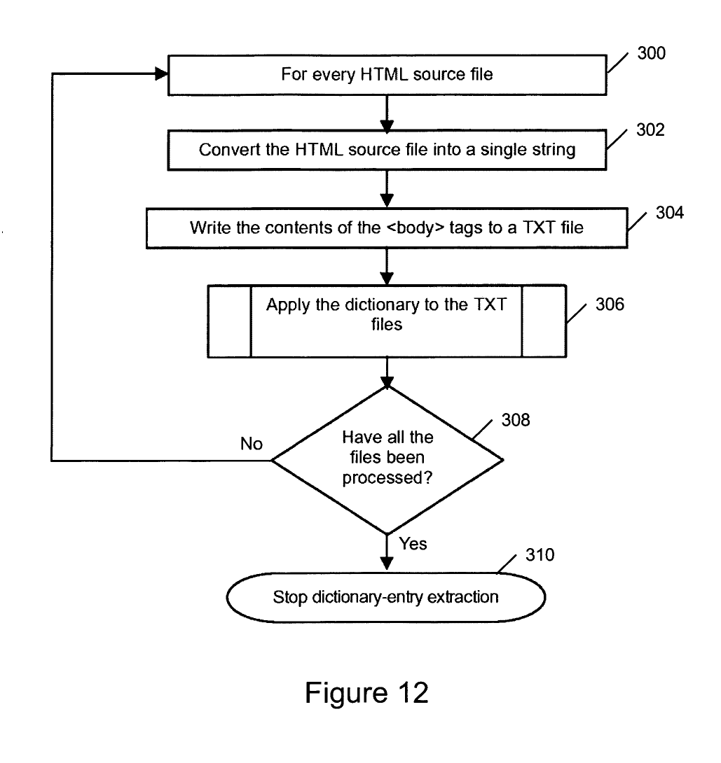

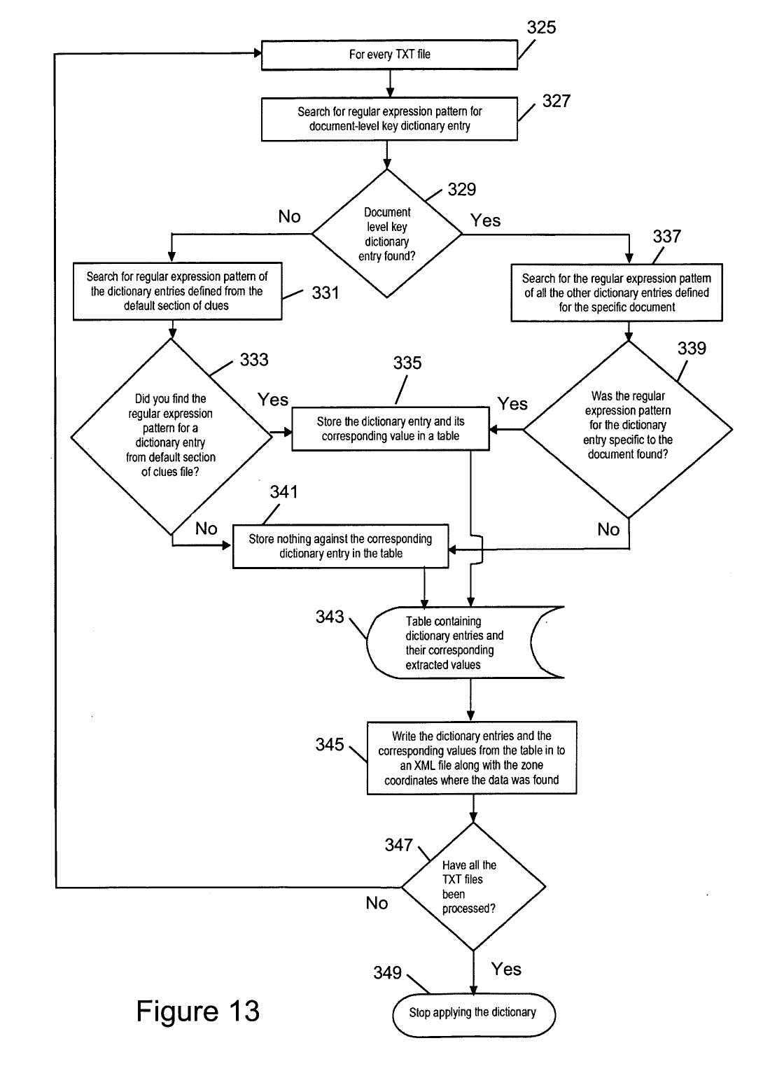

FIG. 12 is a flowchart of a portion of the dictionary entry extraction process and FIG. 13 is a more detailed flowchart explaining the dictionary processing in further detail. As shown in FIG. 12, for every HTML source file (300), the HTML source file is converted into a single string (302) in order to make the searching operation easier to perform. In accordance with an exemplary embodiment, an HTML source file exists for each image document. In the case where the document includes multiple zones, an HTML source file may exist in an exemplary implementation for each zone. In accordance with the exemplary implementation, the contents of the <Body> tags are written to a TXT file (304). The text file is then provided to the search mechanism which is explained in conjunction with FIG. 13 such that the dictionaries are applied to the text files (306).

A check is then made to determine whether all files have been processed (308). If all files have not been processed then the routine branches to block 300 to process the next file. When all the files have been processed, the dictionary entry extraction processing ends (310).

The dictionary and the clues file contain the dictionary entries the user wants to extract and their regular expressions. Sometimes the application misses a certain field while extracting dictionary entries from a set of images. The Image Collaborator 6 allows the user to write a call-out, a script to pull data out of the processing stream, perform an action upon it, and then return it to the stream. The call-out function helps the user to integrate Image Collaborator 6 with the user's system during the data-extraction process. With a call-out script, a user can check the integrity of data, copy a data file, or update a database. One exemplary embodiment of this script would be Microsoft Visual Basic Script (VBScript). Two types of call-out scripts are supported. Field level call-out scripts are performed on a field by field basis as the data is being extracted. Document level call-out scripts are performed once per document image at the completion of the extraction process. Therefore, a document level call-out script allows the document as a whole to be evaluated for consistency and completeness.

In data validation in processing a set of bank statements, for example, the dictionary entries might be “Bank Name”, “Account Number,” and “Transaction Period.” If, on a given page, the application fails to extract “Bank Name,” but correctly identifies “Account Number”, the document level call-out function reasons that that account number can only refer to one bank name. It makes the correct inference and fills in the value for “Bank Name” that corresponds to the account number it has discovered.

The user sets up the call-out script in the dictionary editor. The script can do data validation at the field- and document-levels.

Using a Call-Out for Field-Level Validation

On a bank statement, the dictionary entries might be “Bank Name”, “Account Number,” and “Transaction Period.” To validate extracted field level results, the user can define a field level validation in the dictionary editor. He can specify that “Account Number” for Bank XYZ must be exactly 10 digits. During data extraction, if the data for the field “Account Number” for Bank XYZ does not meet this requirement, the administrator can create an error message for the application to display in the Data Verifier as a quick reminder to the user.

Using a Call-Out for Document-Level Validation

A call-out can also do validation at the document level. For example, again extracting dictionary entries from a bank statement, if the OCR process has correctly extracted the dictionary entries, but has interchanged the values of the “From” date and “To” date in a particular document. This error, then, leads to wrong transaction dates, since a “From” date cannot be later then a “To” date. The user can write a script in the dictionary editor to reverse the problem, or show an error message.

As noted above in conjunction with FIG. 12, in an exemplary embodiment, an HTML parser creates a TXT file. As shown in FIG. 13, for every such TXT file (325), a search is conducted for regular expression patterns for document level key dictionary entries (327). Regular expressions are well known to those skilled in the art. In one exemplarity embodiment the regular expressions used, are as defined in the Microsoft NET Framework SDK

For each regular expression pattern, a check is made at 329 to determine whether a document specific key dictionary entry is found. If a document specific key dictionary entry is found, then a search is conducted for the regular expression pattern of all the other dictionary entries defined for the specific document (337).

If the document specific dictionary entry is not found as indicated by the check at 329, then a search for the regular expression pattern of the dictionary entries is defined from the default section of clues (331). Thus, the check at block 329 determines if the document being searched is the type of document for which the document specific dictionary was designed.

After the search is performed at block 337 for other entries defined for the specific document, a check is made as to whether the regular expression pattern for the dictionary entry specific to the document was found (339). If so, the dictionary entry and its corresponding value are stored in a table (335).

Similarly, after the search is performed at block 331, a check is made as to whether the regular expression pattern is found for a dictionary entry from the default section of the clues file (333). If a regular expression pattern is found based on the check at block 333, the dictionary entry and its corresponding value is stored in a table (335).

If the processing at blocks 333 or 339 do not result in a regular expression pattern being found, the routine branches to 341 and nothing is stored against the corresponding dictionary entry in the table (341). The result of the storage operation at 335 results in the generation of a table containing dictionary entries and their corresponding extracted values (343).

Thereafter, the dictionary entries and the corresponding values are written from the table (343) into an XML file along with the zone coordinates where the data was found (345). The zone coordinates define a location on the document where the data was found.

A check is then made to determine whether all the TXT files have been processed. If not, the routine branches back to block 325 for the next TXT file. If the check at 347 reveals that all the text files have been processed, then the dictionary-related routine ends (349).

The Image Collaborator 6, as noted previously, also performs various client side functions to allow a user to perform the following functions:

Data Verifier

The Image Collaborator 6 extracts dictionary entries from the input images and stores the content as temporary XML files in the Output folder. The user can then verify the data with the Data Verifier module. It displays both the dictionary entry and the source image it came from. The user can visually validate and modify the extracted data for all of the fields on a document. Users can also customize messages to identify invalid data. The Data Verifier also stores the values the user has recently accessed, allowing the user to easily fill in and correct related fields.

The application saves the data the user has verified in the Output folder as XML.

In order to simplify the user's work and improve his efficiency, Image Collaborator provides the following functionalities in the Data Verifier.

Smart Copy

The Smart Copy function enables the Data Verifier to fill in or replace a field value with the value of a similar field on the last verified page.

For example: If the value of the “Bank Name” field on the last verified page of a bank statement is SunTrust Bank, but the field is blank or incorrect on the current page, the Smart Copy function gives the user the option to fill in the value “SunTrust Bank” by clicking the “Bank Name” field on the current page and selecting Smart Copy. The application copies in the previously-verified value.

Copy All Indexes

Copy All Indexes operates like Smart Copy. It copies the values of all of the fields from the page the user last verified to the same fields on the current page.

Indexing

Image Collaborator allows users to index the verified XML data. The indexes are defined in the Index Variable file, under Application Settings.

Collation

Collating regroups a document's separate pages into one document again. Inputs to Image Collaborator are single-page image files. They were often originally a part of a complete document but were separated in order to be scanned. Once Image Collaborator has processed the page files, the application needs to collate them in order to recombine them into a single document file again. It groups them together based on a set value, the collation key, defined in the Application Settings.XML file. The key is usually a field-name defined in the dictionary or clues file.

The user collates the verified documents by clicking the Approve Batch button in the Data Verifier.

Integration With Line of Business Applications

Since the output from Image Collaborator is XML, it is immediately available to the user's line of business applications.

In using the Image Collaborator application, before document image data is processed, the user will configure the Image Collaborator based on the needs of a given implementation and define dictionary entries that are desired to be found. Application parameters are configured in an application's setting window. Resource files that are needed are located, folder locations are chosen for input data/output data, intermediate storage, air logs, reports, etc.

In an illustrative implementation, the following resource files and folder locations may be used:

Resource Files

The resource files generally used are:

1. Document (document-specific) dictionary. The clues (XML) file to which the dictionary entries defined in the dictionary are written.

2. Standard (default) dictionary. The dictionary that contains the entries to be extracted from the input images.

3. Image-checking parameter file. The file that contains the required file properties that need to be verified before processing an input image.

4. Image classification file. The file that contains image templates with zones for extracting data.

5. OCR settings file. The file that contains all configurable parameters that directly affect the OCR output.

6. Package identification file. This file contains package templates for various image types. These templates are matched with input images. If a match is found, a separate package is created for the matched image.

7. Pre-identification enhancement configuration file. This file contains all the necessary parameters for cleaning up an input image.

8. Unidentified enhancement configuration file. This file contains all the necessary parameters for cleaning up and processing the input image that do not match a template images.

9. Image index variable file. This file contains the variables which the application uses to index the output files.

Folder Locations

The folder locations include:

1. Image pickup folder. The location from which the application picks up the input images for processing.

2. Collated image output folder. Once the user verifies the images and approves the batch, the application collates the images, regrouping them into documents again, and puts the collated images in this folder.

3. Invalid files folder. When the input images do not meet the required image properties the application stops processing them and puts them in this folder.

4. Package(s) folder. The location where packages are created for the identified input images.

5. Unverified output folder. The XML file to which the application writes extracted dictionary entries.

6. Processed input files folder. The folder, in which the application stores processed, enhanced images.

7. Zone files folder. The folder which contains the zone files that provide zone information for the identified files.

8. Indexed files folder. The folder which holds the indexed XML files the application creates after processing and data verification.

9. Intermediate files folder. The folder in which the application temporarily stores all intermediate files.

Other application settings include ones for setting up the package folder prefix, the unidentified package name, the unidentified document name, and the general settings for displaying and logging error messages.

With respect to creating and managing a dictionary, dictionary entries and regular expressions and clue entries may be defined as follows:

Defining Dictionary Entries

A dictionary is a reference file containing a list of words with information about them. In Image Collaborator, the dictionary contains a list of terms that the user is looking for in a document.

The user defines the dictionary entries he needs, and provides all the necessary support information by creating or editing a dictionary file.

Support information for a dictionary entry includes synonyms (words which are similar to the original entry) and regular expressions, pattern-matching search algorithms.

Defining Regular Expressions

A regular expression is a pattern used to search a text string. We can call the string the “source.” The search can match and extract a text sub-string with the pattern specified by the regular expression from the source. For example:

‘1[0-9]+’ matches 1 followed by one or more digits.

Image Collaborator gives users the flexibility to define regular expressions for the dictionary entries they want to find, at both the field and the document level.

At the field level, the user defines regular expressions for every dictionary entry, including all possible formats in which they may occur. For example, a regular expression for “From” date might include the following:

Last Statement:\s+(?<FromDate>\w+\s+\d+, \s+\d+)

BEGINNING DATE\s+(?<FromDate>\w+\s+\d+, \s+\d+)

At the document level, the user defines regular expressions for all the dictionary entries he wants to find in a given type of document. The application identifies the document based on a “key” dictionary entry. For example, while processing bank statements, the regular expressions for a bank named “Bank One” could be defined as:

Key dictionary entry: “Bank Name”=Bank One

| Dictionary entries | Regular expressions |
|---|---|
| “Bank Name” = Bank | (?<BankName>Bank One) |
| One | |
| “From” date | (?<FromDate>\w+\s*\d+)\s* |
| to “To” date | through\s* |
| | (?<ToDate>\w+\s*\d+,\s*\d+) |
| “Account Number” | ACCOUNT |
| | NUMBER\s+(?<AccountNumber>[0-9\−]+) |

The document-level regular expressions narrow the search to a limited set of regular expressions defined for a specific document. For example, while processing bank statements, when the application recognizes a specific bank name, the HTML parser searches for only those regular expression patterns defined at the document level for that particular bank.

The working of field-level regular expressions and document-level regular expressions can be better illustrated after defining the clues.

The Clues File

The clues file is an XML file that contains the dictionary entries the user wants to extract from the processed images.

All the information defined in the dictionary is written to an XML file when the dictionary is loaded. The user can create and keep a number of dictionaries, and can choose and apply one at a time while processing a set of documents.

Dictionary entries and their regular expressions are grouped into two categories in the clues file: document and default.

The document group contains all regular expressions specific to a document based on the key.

The default group contains all possible regular expressions for the fields defined.

When the parser makes a search, it looks for the key dictionary entry. If it finds a match for a document specific term it searches for the remaining dictionary entries only based on the regular expression patterns defined for that specific document.

The search looks up default regular expressions only when it fails to find a match for an entry in the document group.

The application then stores the matched values for the dictionary entries in a table. It creates an XML file, made up of the extracted values for the dictionary entries and the X and Y coordinates of the location where the information was found in the processed document.

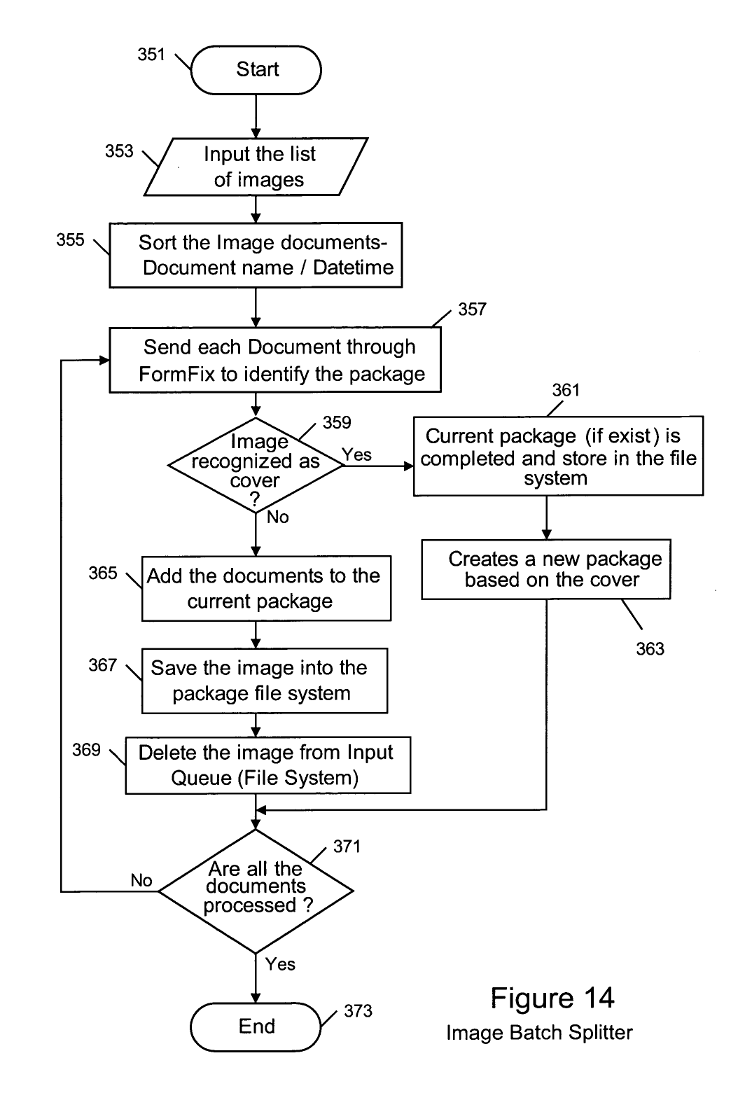

FIG. 14 is a flowchart delineating the sequence of operations involved in sorting document images into different types of packages. This image batch splitter routine starts by inputting a list of images from an input image directory (351, 353). Initially, the image documents are sorted by document name and date/time (355). Then, each document is sent through the commercially available FormFix software to identify the package (357).

A determination is then made whether the image is recognized based on the image document cover page (359). If a cover page is recognized, then a determination is effectively made that it is the beginning of the next batch and that the current package (if it exists) is completed (and stored in the file system) (361).

Thereafter, a new package is created based on the detected cover page (363) and the routine branches to block 371 to determine whether all the documents have been processed.

If the image is not recognized as a cover page as determined by the check at block 359, then the documents are added to the current package/batch (365). Thereafter, the image is saved into the package file system (367) and the image document is deleted from the file system input queue (369).

A check is then made to determine whether all documents are processed (371). If not, the routine branches to 357 to process the next document. If all the documents have been processed, the routine ends (373).

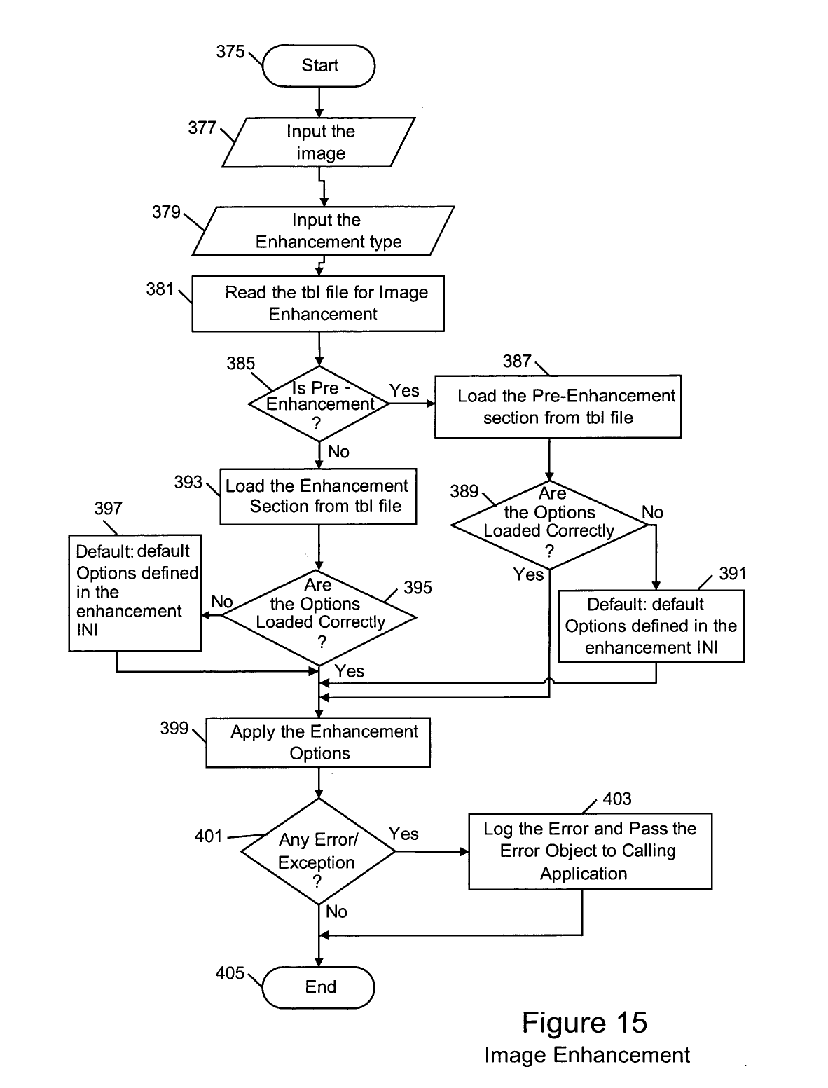

FIG. 15 is a flowchart delineating the sequence of operations involved in image enhancement in accordance with a further exemplary implementation. The image enhancement processing begins by inputting the image document (375, 377). Thereafter, the enhancement type is input (379). This type indicates whether pre-identification image enhancement (FIG. 5A 115) or post-identification image enhancement (FIG. 5A 116) is to be performed. The tbl file for image enhancement is then read to thereby identify those aspects of the image document that need to be enhanced (381). The tbl file includes the image enhancement information relating to both pre-identification image enhancement and post-identification image enhancement.

A check is then made at block 385 to determine whether the enhancement is pre-identification enhancement. If so, then the pre-enhancement section from the tbl file is loaded (387). A check is then made to determine whether the options are loaded correctly (389). If the options are not loaded correctly, then default options are defined in the enhancement INI options. If the forms are not identified, the default enhancement INI options are used (391). If the options are loaded correctly as determined by the check at 389, the routine branches to 399 to apply the enhancement options.

If the check at block 385 reveals that the image enhancement is not a pre-identification enhancement, the enhancement section is loaded from the tbl file (393). A check is then made to determine whether the options are loaded correctly (395). If so, then the enhancement options are applied (399). If the options are not loaded correctly, then default options defined in the enhancement INI are utilized. As noted above, if the forms are not identified, then the default enhancement INI options are utilized.

After the enhancement options have been applied, a determination is made as to whether there is any error or exception (401). If so, then the error is logged and the error object is passed to the calling application (403). If there is no error the routine ends (405).

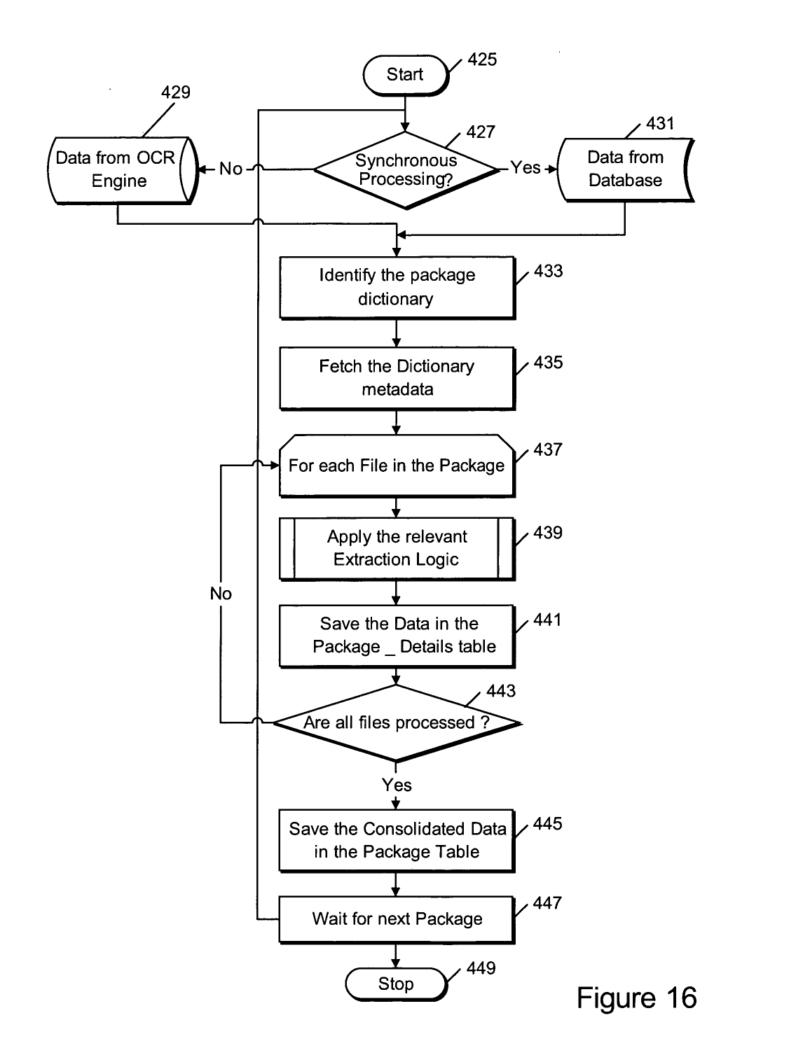

FIG. 16 is a flowchart delineating the sequence of operations involved in image document/dictionary pattern matching in accordance with a further exemplary embodiment. The pattern matching routine begins (425) with the determination being made as whether synchronous processing is to occur (427). In the synchronous processing mode, data is accessed from the database (431) and processed in accordance with a pre-defined timing methodology.

If the processing mode is not a synchronous mode as determined by the check at block 427, then an event occurred, such as a package having been created, thereby triggering data being obtained from the OCR engine (429). Whether the data is obtained from the database or from an OCR engine, a package dictionary is then identified (433), thereby determining the appropriate dictionary, e.g., the document specific dictionary or the default dictionary, to use as explained above in conjunction with FIGS. 5A and 5B.

Thereafter, the dictionary metadata is obtained (435) to, for example, obtain all the synonyms for a particular document term such as “account number.” Thereafter, for each file in the package (437), the relevant extraction logic is applied (439). Therefore, the page is processed against the document specific dictionary or the default dictionary as discussed above. Thereafter, the data is saved in a Package_Details table (441).

A check is then made at block 443 to determine whether all the files have been processed. If all the files have not been processed, then the routine branches to block 437 to retrieve the next file. If all the files have been processed then the consolidated data is saved in the package table (445) and the routine waits for the next package (447) by branching back to block 427. Thereafter, the routine stops after all the packages have been processed.

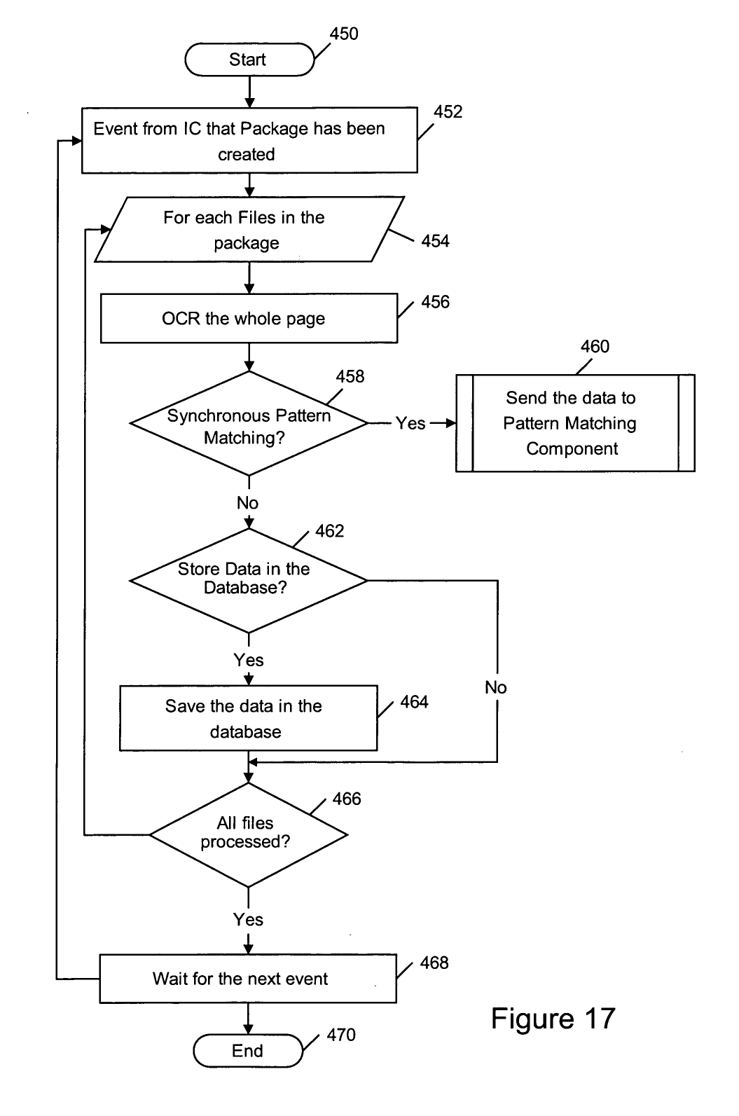

FIG. 17 is a flowchart delineating the sequence of operations in a further exemplary OCR processing embodiment. As shown in FIG. 17, after the OCR routine begins, notification event is signaled from Image Collaborator indicating that a package has been created (450, 452). The routine enters a waiting mode until such an event occurs. Thereafter, for each file in the package (454) an OCR is performed on the whole page (456).

A check is then made at block 458 to determine whether synchronous pattern matching is to be performed. If so, then the data is sent to the pattern matching component (460) as explained in conjunction with the processing in FIG. 16 to trigger the execution of the FIG. 16 related pattern matching routine. Synchronous pattern matching is another name for data extraction. It is employed when data extraction is to be performed contemporaneously with OCR, as is illustrated in FIGS. 5A and 5B.

If the check at block 458 reveals that no synchronous pattern matching is to be performed, then a check is made as to whether the data is to be stored in the database (462). If the data is to be stored in the database, then the data is saved in the database (464). If the data is not to be stored in the database, then a check is made as to whether all files have been processed (466). If all files have not been processed then the routine branches back to 454 to retrieve the next file.

If all the files in the package have been processed, then the routine waits for the next event by branching back to 452, after which the routine ends (470).

In one embodiment of the present invention data extraction is deferred until a later time. In such an embodiment pattern matching would not be synchronous and the results of OCR processing would be stored in a database to enable pattern matching at another time.

The above-described Image Collaborator system may be implemented in accordance with a wide variety of distinct embodiments. The following exemplary embodiment is referred to hereinafter as IMAGEdox and provides further illustrative examples of the many unique aspects of the system described herein.

IMAGEdox Overview

IMAGEdox automates the extraction of information from an organization's document images. Using configurable intelligent information extraction to extract data from structured, semi-structured, and unstructured imaged documents, IMAGEdox enables an organization to:
Automatically locate and recognize specific data on any form
Automatically recognize tables and process data in all rows and columns even if the data spans across multiple pages
Process all types of document formats
Retrieve source image documents from existing document management platforms
Perform character recognition in the area of interest on demand
Verify and proof-read recognized data

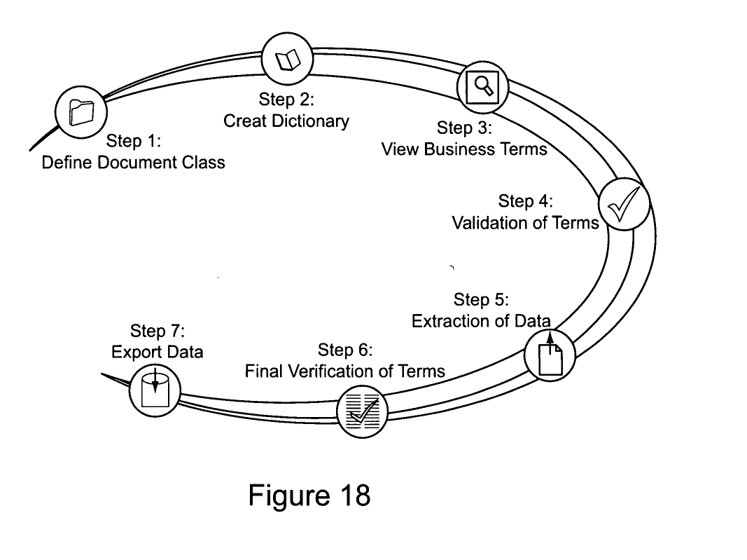

FIG. 18 is an IMAGEdox initial screen display window and is a graph which summarizes the seven major steps involved in using IMAGEdox after the product is installed and configured. Steps 1 through 4 are typically performed by an administrator user working together with domain experts to define the terms and information a user wants to extract from documents. Steps 5 through 7 are typically performed by an end-user. This user does not need to understand the workings of the dictionary. Instead, he or she only needs to extract, monitor, and verify that the information being extracted is the correct information and export it to the back-end system that uses the extracted data.

The examples below describe the processing of a common type of document: a bank statement. IMAGEdox can be used to process any type of document simply by creating a dictionary that contains the commonly used business terms that the user wants to recognize and extract from that specific type of document.

It is assumed that the documents that are being processed are scanned images from paper documents.

The steps illustrated in the graphic are described below. Configuration steps are described in the next section.

Configuring IMAGEdox

The IMAGEdox installation program creates default configuration settings. The configuration settings are stored in a number of files that can be accessed or modified using the Application Settings screen. These settings are grouped into the following five categories:
Input Data
Output Data
Processing Data
Package Splitter
General

The settings in each category are described in the sections that follow.

Editing Input Settings

Input Data settings define the folder that contains the user's scanned images and the dictionaries that are used to process them. Complete the following procedure to edit the user's input settings:

1. Click Options>Application Settings.

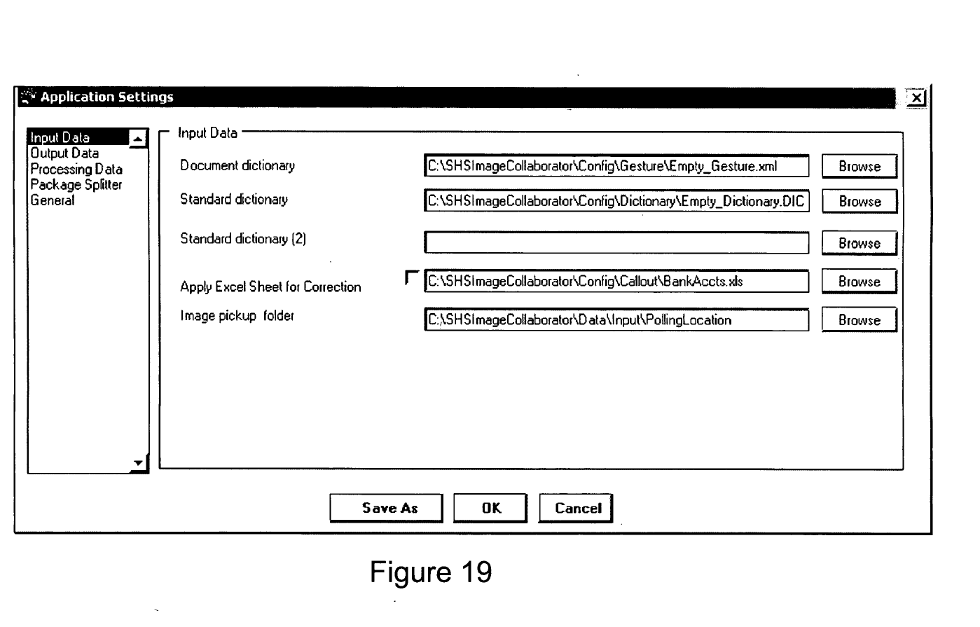

FIG. 19 is an exemplary applications setting window screen display.

The Applications Settings window is displayed with the Input Data option selected by default:

2. Click Browse to select a different document dictionary to process the documents in the associated Image Pickup Folder.

The document-specific dictionary is designed to extract data from known document types. For example, if you know that a Bank of America statement defines the account number as Acct Num: you can define it this way while creating the dictionary.

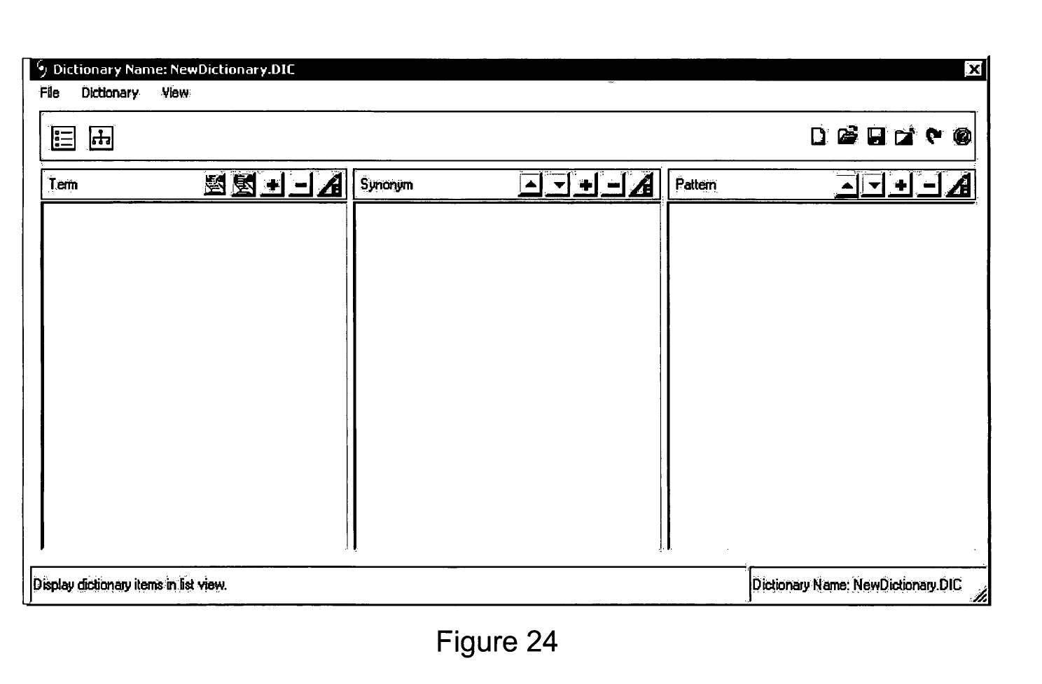

For more information about creating dictionaries, see the description beginning with the description of FIG. 24 below.

3. Click Browse to select a different standard dictionary to process the documents in the associated Image Pickup Folder.

The standard dictionary (also known as the default dictionary) is used if a match is not found in the document-specific dictionary. It should be designed for situations where the exact terminology used is not known. For example, if you were processing statements from an unknown bank, your standard dictionary must be able to recognize any number of Account Number formats, including Acct Num:, Account Number, Acct, Acct #, and Acct Number.

4. Click Browse to select a different second standard dictionary.

The second standard dictionary enables you to treat your preexisting dictionaries as modules that can be combined rather than creating yet another dictionary.

5. Click the Apply Excel Sheet for Correction check box if you want to specify an Excel file be used to check extracted data accuracy.

6. Click Browse to select a different document Image Pickup folder.

This is the folder where IMAGEdox looks for your scanned images to begin the data extraction process. To begin using IMAGEdox, you must manually copy your scanned images into this location, or configure your scanner to use this folder as its output folder.

7. Update the files that store your current configuration settings (serverAppsettings.xml and AppSettings.xml) as follows:
Click Save As to save the server settings.
In the Save As dialog box, locate and select the ServerAppSettings.xml file (which is installed in C:\SHSlmageCollaborator\bin by default). Click Save.
Click OK to save the client settings stored in the AppSettings.xml file.

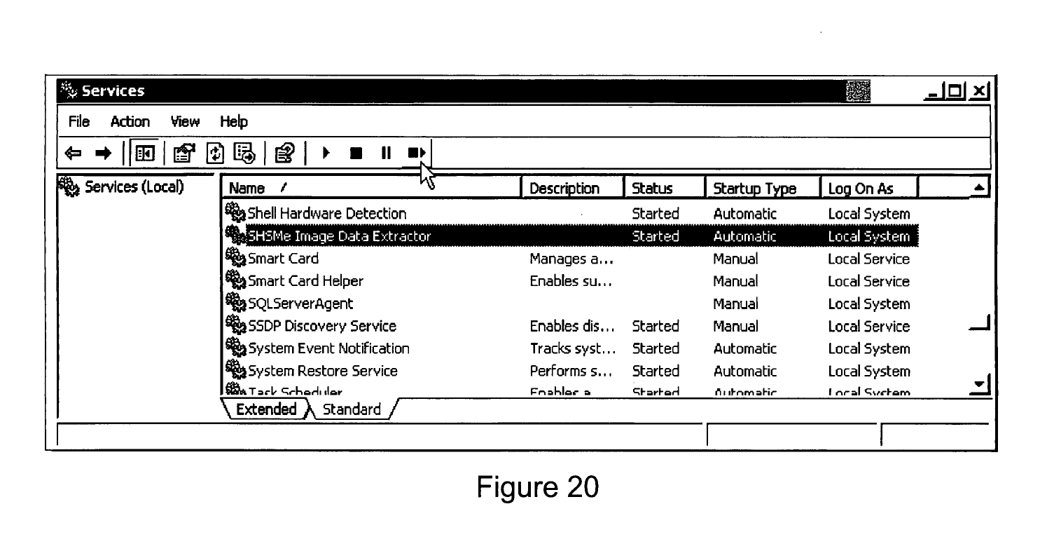

FIG. 20 is an exemplary services window screen display for Microsoft Windows XP.

8. Open the Services window (Start>Settings>Control Panel>Administrative Tools>Services).

9. Click the SHSMe Image Data Extractor service.

10. Click Restart Services [symbol] to stop and restart the service.

Continue the IMAGEdox configuration as described in the next section.

Editing Output Folders

Output Data settings define the folders where the data extracted from your scanned images, and the processed input files are stored. Extracted data is stored in XML files. Complete the following procedure to edit your output settings:

1. Click Options>Application Settings to display the Application Settings window if it is not already open.

2. Click the Output Data option.

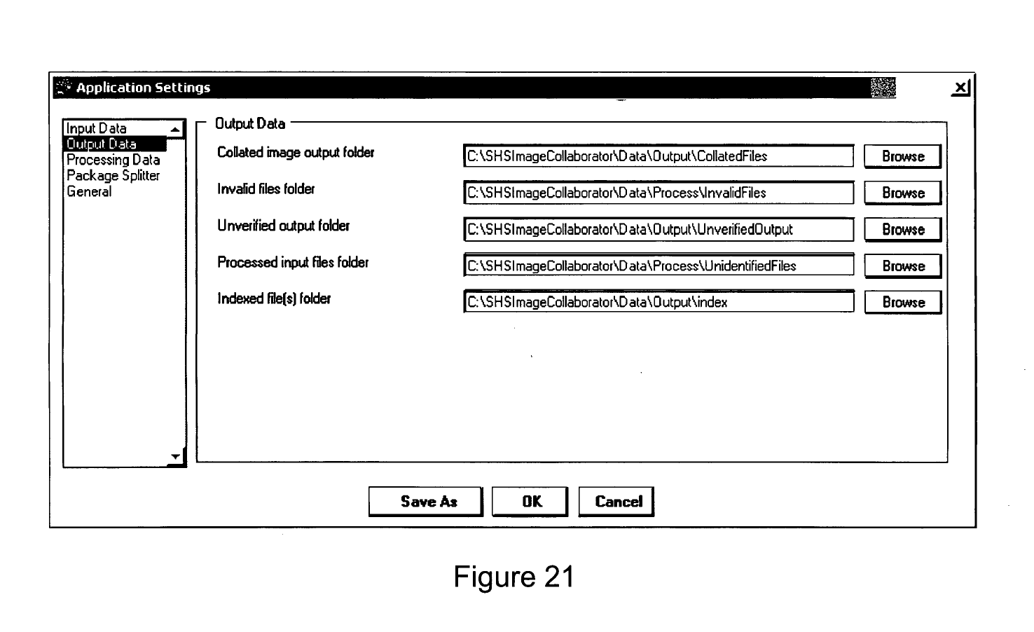

FIG. 21 is an exemplary output data frame screen display.

The Output Data frame is displayed:

3. Click Browse to specify a different Collated Image Output folder.

Collated images are created by combining multiple related files into a single file. For example, if a bank statement is four pages, and each page is scanned and saved as a single file, the four single page files can be collated into a single four page file during the data approval process.

4. Click Browse to specify a different Invalid Files folder.

Invalid files are the files that cannot be recognized or processed by the optical character recognition engine. These files will need to be processed manually.

5. Click Browse to specify a different Unverified Output folder.

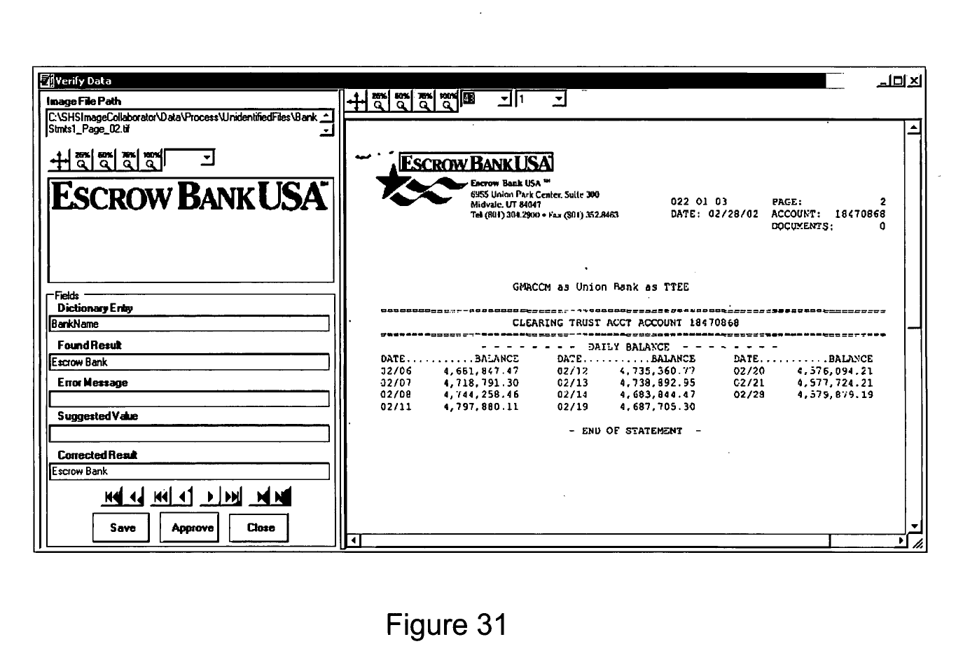

This folder stores all of the output data until it is verified by the end-user using the data verification functionality (as described in “Verifying extracted data” beginning with the description of FIG. 31 below).

6. Click Browse to specify a different Processed Input Files folder.

This folder stores all of the input files (your scanned images) after they have had the data extracted from them.

Note: IMAGEdox moves the files from the input file location (defined in step 5 above, in conjunction with the description of FIG. 19) to this location. These are not copies of the files. If these are the only version of these files, consider backing up this folder regularly.

7. Click Browse to specify a different Indexed Files folder.

This folder stores the files created by extracting only the fields you specify as index fields. For example, a bank statement may contain 20 types of information, but if you create an index for only four of them (bank name, account number, from date, and to date), only those indexed values are stored in the index files. The user-defined file that defines which terms should be considered index fields must be specified in the Application Setting Processing Data window, as specified in step 6 in the next section.

8. Click OK to update the files that store your current configuration settings (Appsettings.xml and ServerAppSettings.xml), or click Save As to create a new configuration file.

Continue the IMAGEdox configuration as described in the next section.

Defining Processing Data Settings

Processing Data settings specify the files that are used during the processing of images.

Complete the following procedure to edit your processing settings:

1. Click Options >Application Settings to display the Application Settings window if it is not already open.

2. Click the Processing Data option.

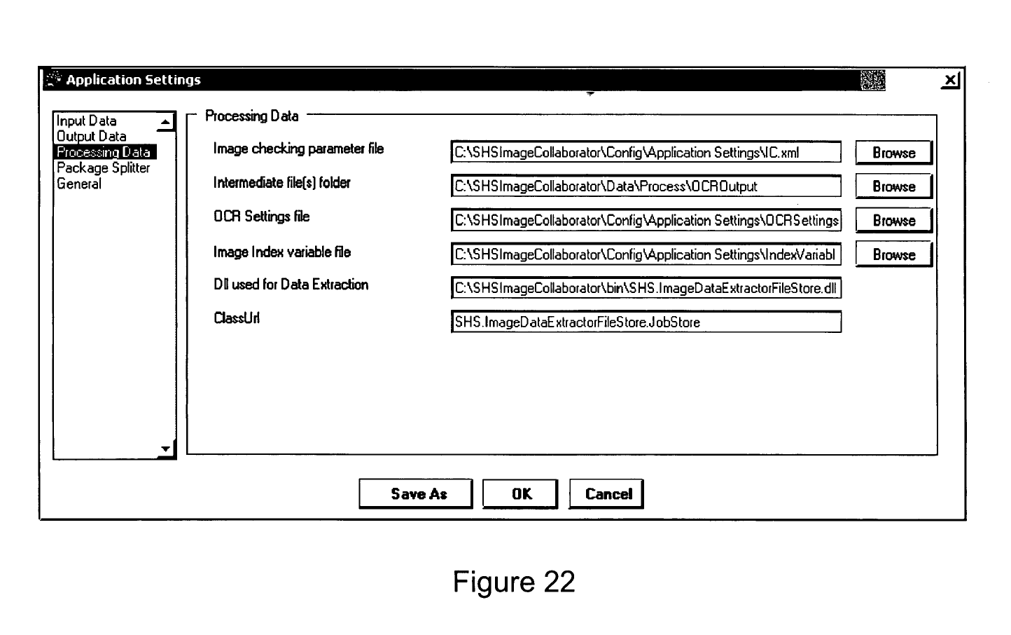

3. The Processing Data frame is displayed: FIG. 22 is an exemplary Processing Data Frame screen display.

4. Click Browse to specify a different location for Intermediate File folder.

This folder temporarily stores the files that are created during data extraction. The contents of the folder are automatically deleted after the extraction is complete.

5. Click Browse to specify a different location for the OCR Settings file.

You can edit the contents of this file to change the behavior of the OCR engine.

6. Click Browse to specify a different location for the Image Index Variable file folder.

This folder contains files that specify the index variables used to create index files.

7. Update the files that store your current configuration settings (serverAppsettings.xml and AppSettings.xml) as follows:
Click OK to save the client settings stored in the AppSettings.xml file.
Click Save As to save the server settings.
In the Save As dialog box, locate and select the serverAppsettings.xmi file (which is installed in C:\SHSlmageColiaborator\bin by default). Click Save.

Continue the IMAGEdox configuration as described in “Editing general settings”.

Editing Package Splitter Settings

These settings are not used in this release of IMAGEdox. Do not edit any of these settings.

Editing General Settings

Complete the following procedure to edit your general settings:

1. Click Options>Application Settings to display the Application Settings window if it is not already open.

2. Click the General option.

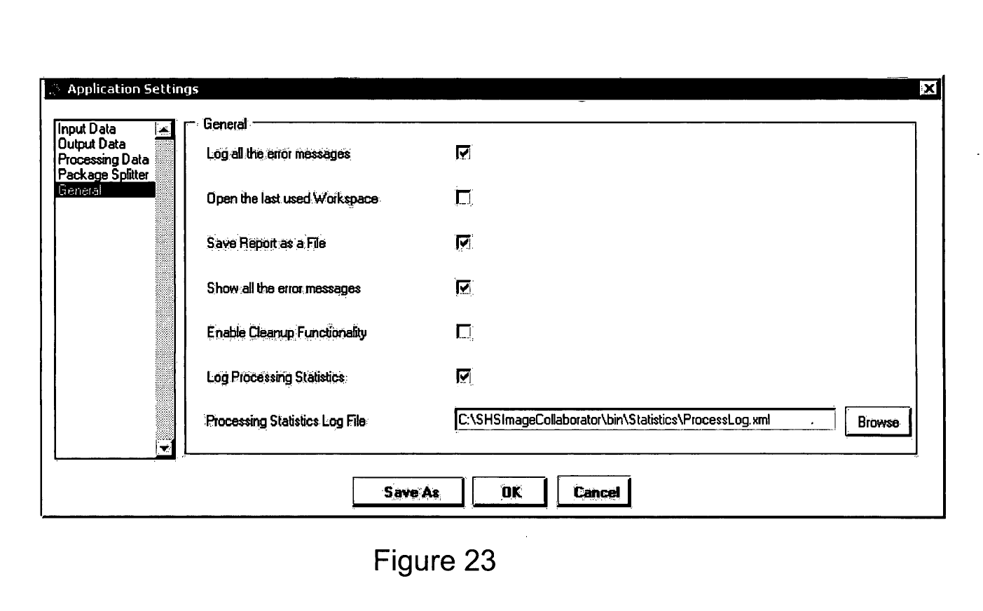

FIG. 23 is an exemplary General frame screen display.

3. The General frame is displayed:

4. Click any of the following check boxes to edit the default settings:
Log all the error messages
Show all the error messages
Enable Cleanup Functionality
Log Processing Statistics

(Open the last used Workspace and Save Report as a File are note supported in this release)

5. Click Browse to edit the default location of the Processing Statistics Log file.

This file logs the amount of time spent processing image enhancement, OCR, and data extraction.

6. Update the files that store your current configuration settings (serverAppsettings.xml and AppSettings.xml) as follows:
Click OK to save the client settings stored in the AppSettings.xml file.
Click Save As to save the server settings.
In the Save As dialog box, locate and select the serverAppsettings.xmi file (which is installed in C:\SHSlmageCollaborator\bin by default). Click Save.

Working With Dictionaries

A dictionary is a pattern-matching tool IMAGEdox uses to find and extract data. Dictionaries are organized as follows:

Term—A word or phrase you want to find in a document and extract a specific value. For example, for the term Account Number, the specific value that is extracted would be 64208996.

Synonym—A list of additional ways to represent a term. For example, if the dictionary entry is Account Number, synonyms could include Account, Account No., and Acct.

Search pattern—A regular expression you create and use to find data. It enables you to define a series of conditions to precisely locate the information you want. Every search pattern is linked to a dictionary entry and the entry's synonyms.

Dictionary Types

IMAGEdox enables a user to define two types of dictionaries:

Document-specific—Designed to extract data from known documents. For example, if you know that a Bank of America statement defines the account number as an eight-digit number proceeded by Acct Num: you can define it precisely this way while creating the dictionary used to process Bank of America statements.

Standard (also known as default)—Designed for situations where the exact terminology used is not known. For example, if you were processing statements from an unknown bank, your standard dictionary must be able to recognize any number of Account Number formats, including Acct Num:, Account Number, Acct, Acct #, and Acct Number. Also note that they are not grouped by primary dictionary entry such as Bank Name.

A user should create at least one of each type of dictionary.

When IMAGEdox processes a document image (for example, a bank statement), it first applies the document-specific dictionary in an attempt to match the primary dictionary entry: Bank Name. Until the bank name is found, none of the other information associated with a bank is important. If the document is from Wells Fargo Bank, IMAGEdox searches each section of the document until it recognizes “Wells Fargo Bank.”

After finding a match for the primary dictionary entry in the document-specific dictionary, it then attempts to match the secondary dictionary entry, for example, Account Number. If IMAGEdox cannot find a match, it processes the document image using the standard dictionary. It applies one format after another until it finds a match for the particular entry. After IMAGEdox exhausts all the dictionary entries in the standard dictionary, it processes the next document image.

Dictionaries are created and managed using the IMAGEdox Dictionary window which is introduced in the next section.

The Dictionary Window

FIG. 24 shows an illustrative dictionary window screen display. The Dictionary window is used to create, modify, and manage your dictionaries. This section describes the tools and fields included in the dictionary interface. The interface is displayed by starting IMAGEdox from the desktop icon, and clicking the Dictionary menu item.

The dictionary window contains four main sections: toolbar, Term pane, Synonym pane, and Pattern pane. The options available in each are described in the tables that follow.

| | Description: |
|---|---|
| Toolbar buttons | |
| and icons: | |
| [symbol] List view | Displays a list of corresponding items in each |
| | pane. |
| [symbol] Tree view | Displays a collapsible tree view of corresponding |
| | items in each pane. |
| [symbol] New dictionary | Creates a new dictionary. |
| [symbol] Open dictionary | Opens an existing dictionary. |
| [symbol] Save | Saves the currently displayed dictionary. |
| [symbol] Close dictionary | Closes the currently displayed dictionary. |
| [symbol] Refresh dictionary | Displays any changes made since opening the |
| | current dictionary. |
| [symbol] Help | Displays the IMAGEdox online help. |
| Term pane buttons: | |
| [symbol] Document level | Runs a user-defined validation script on the entire |
| validation script | document. |
| [symbol] Term level | Runs a user-defined validation script on the term |
| validation script | level of the document. |
| [symbol] Add term | Adds a new term to the currently displayed |
| | dictionary. |
| [symbol] Delete term | Deletes the selected term to the currently |
| | displayed dictionary. |
| [symbol] Modify term | Saves changes to a modified term in the currently |
| | displayed dictionary. |
| Synonym pane | |
| buttons: | |
| [symbol] Move up | Selects the previous synonym. |
| [symbol] Move down | Selects the next synonym. |
| [symbol] Add synonym | Adds a synonym to the currently displayed term. |
| [symbol] Delete synonym | Deletes the selected synonym from the currently |
| | displayed term. |
| [symbol] Modify synonym | Saves changes to a modified synonym. |
| Pattern pane buttons: | |
| [symbol] Move up | Selects the previous pattern. |
| [symbol] Move down | Selects the next pattern. |
| [symbol] Add pattern | Adds a pattern to the currently displayed term. |
| [symbol] Delete pattern | Deletes the selected pattern from the currently |
| | displayed term. |
| [symbol] Modify pattern | Saves changes to a modified pattern. |

Creating a Dictionary

The Dictionary window enables you to define the terms (and their synonyms) for which you want IMAGEdox to extract a value. After creating a new dictionary (as described in this section), there are three major steps to define the new dictionary:
Defining terms
Defining synonyms for each term
Defining search patterns

These general steps are described in detail in the sections that follow.

Complete the following procedure to create a new dictionary:

1. Double-click the desktop icon to start IMAGEdox.

The IMAGEdox window is displayed:

2. Click Dictionary.

The Dictionary window is displayed:

3. Click File>New or New Dictionary [symbol] A new dictionary called untitled.dic is created.

You cannot save and rename the untitled dictionary until you add a term to it as described in the next section.

A new dictionary is created by clicking on “create dictionary” in the screen display shown in FIG. 18. After a dictionary is created, terms need to be added.

Adding Terms to a Dictionary

Complete the following procedure to define terms for your dictionary.

1. If you have not already, create a new dictionary as described in the previous section.

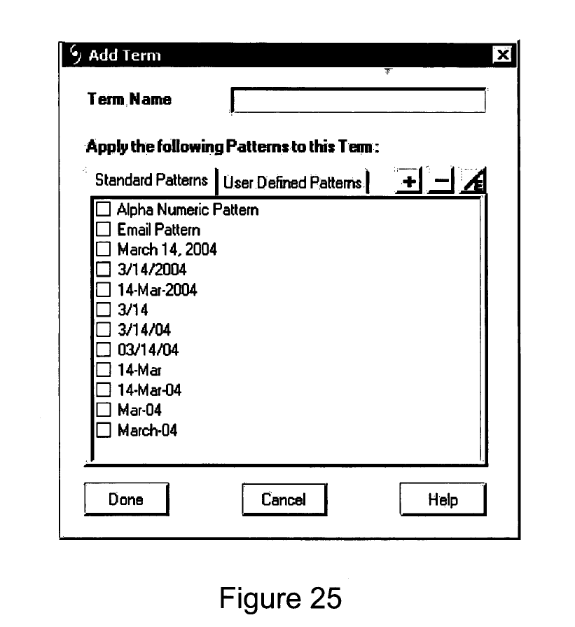

FIG. 25 shows an illustrative “term” pane display screen.

2. In the Term pane, click Add Term

[symbol]

The Add Term dialog box is displayed with the Standard Patterns tab selected:

3. Enter the name of the term that you want to define in the Term Name field.

You can click Done and configure the search pattern as described in “Modifying search patterns” below, or you can define a basic search pattern from this screen. If you are defining a date search, and the format is predefined (that is, it is in the list), continue with step 4, otherwise, define the search pattern later.

4. Double-click to select the standard patterns that you want to define for the term. There are three standard pattern types from which you can select:

Alphanumeric—Contains letters (a-z, A-Z) and numbers (0-9) only; cannot contain symbols, or spaces.

Email—Contains an email address using the username@dorna in. corn format.

Date—Ten date formats are predefined for your convenience.

If these standard patterns do not meet your needs, you can define custom search patterns as described in “Adding search patterns” below. These custom search patterns are displayed when on the User Defined Patterns tab.

5. Click Done.

The new term is added to the Terms pane, and its associated search pattern is displayed in the Pattern pane. Terms are listed in alphabetical order, and the pattern is only displayed for the term that is selected.

6. Click File>Save.

The Save Dictionary dialog box is displayed.

7. Enter a descriptive name for your dictionary and select the location for it.

Depending on which type of dictionary this is (document-specific or standard), the location of the dictionary must match the location specified in step 2 or 3 in “Editing input settings” above.

8. Click Save.

The new name and the location are displayed in the Dictionary window's title bar, and in the lower right-hand corner.

Unless you need to modify or delete terms (as described in the next sections), continue building your dictionary as described in “Adding synonyms” below.

Modifying Terms

1. Open the IMAGEdox dictionary that contains the term you want to modify.

2. In the Term pane, click the name of the term you want to modify.

3. Click Modify Term

[symbol]

The Modify Term dialog box is displayed.

4. Change the term name (effectively deleting the old term and creating a new term) or the search pattern.

5. Click Done.

Deleting Terms

1. Open the IMAGEdox dictionary that contains the term you want to delete.

2. In the Term pane, click the name of the term you want to delete.

3. Click Delete Term

[symbol]

You are prompted to confirm the deletion.

4. Click Yes.

Adding Synonyms for a Term

Synonyms are words (or phrases) that have the same, or nearly the same, meaning as another word. During the data extraction phase, IMAGEdox searches for dictionary terms and related synonyms (if defined). Synonyms are especially useful when creating a default (or standard) dictionary to process document images that contain unknown terminology. You can define one or more synonym for every term in your dictionary.

Complete the following procedure to define a'synonym for an existing term in your dictionary:

1. Open the IMAGEdox dictionary that contains the term for which you want to define a synonym.

2. In the Term pane, click the term for which you want to define a synonym.

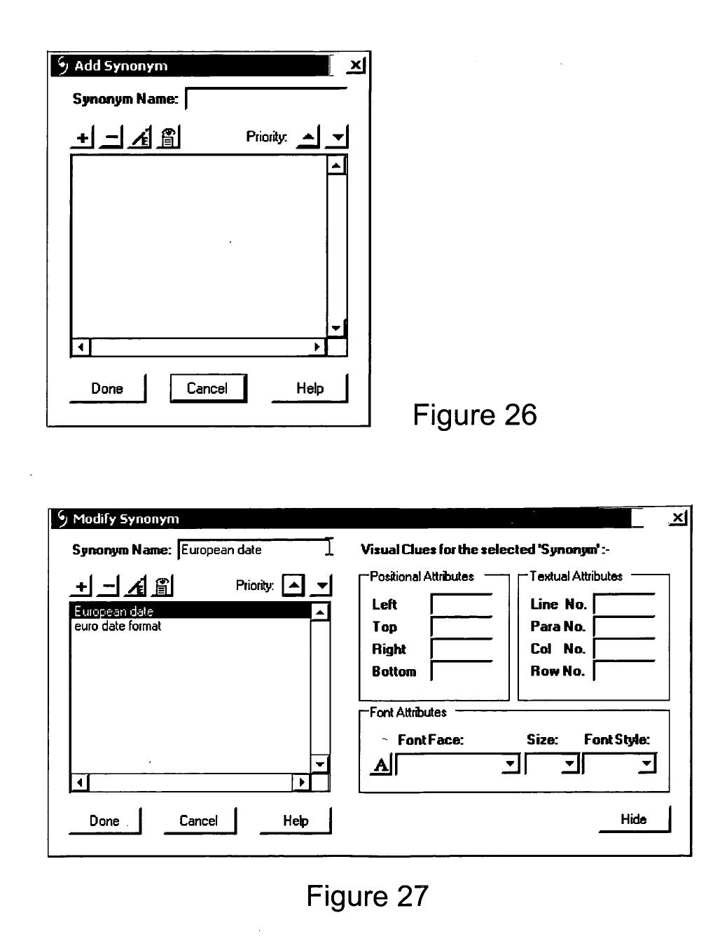

FIG. 26 is an exemplary Add Synonym display screen.

3. In the Synonym pane, click Add Synonym

[symbol]

The Add Synonym dialog box is displayed:

4. Enter the synonym in the Synonym Name field.

5. Either click Add Synonym [symbol] if you want to add more synonyms, or Done. The synonyms are added (and prioritized) in the order they are added.

You can change a synonym's priority using the Priority up [symbol] or Priority down [symbol] buttons either in the Add Synonym dialog box or the Dictionary window's Synonym pane. When IMAGEdox is searching for a term, the term's synonyms are prioritized from the first synonym (top of the list) to the last (bottom).

Unless you need to modify or delete synonyms (as described in the next sections), continue building your dictionary as described in “Creating visual clues” below.

Modifying Synonyms

1. Open the IMAGEdox dictionary that contains the synonym you want to modify.

2. In the Synonym pane, click the name of the synonym you want to modify.

3. Click Modify Synonym

[symbol]

The Modify Synonym dialog box is displayed. You can change the synonym's priority using the Priority up [symbol] or Priority down [symbol] buttons.

4. Click Visual Clue.

The Modify Synonym Visual Clue dialog box is displayed. For detailed information about defining visual clues see “Creating visual clues.”

5. Click Done.

Deleting Synonyms

1. Open the IMAGEdox dictionary that contains the synonym you want to delete.

2. In the Synonym pane, click the name of the synonym you want to delete.

3. Click Delete Term

[symbol]

You are prompted to confirm the deletion.

4. Click Yes.

Creating Visual Clues

IMAGEdox dictionaries can be configured to use visual information during the data extraction phase to recognize and extract information. Visual clues tell the OCR engine where in an image file to look for terms and synonyms whose value you want to extract. Additionally, visual clue information can tell the OCR engine to look for specific fonts (typefaces), font sizes, and font variations (including bold and italic).

Visual clues can be used with either document-specific or default (standard) dictionaries, but are extremely powerful when you can design a document-specific dictionary with a sample of the document (or document image) nearby.

Visual clues can also be useful when trying to determine which of duplicate pieces of information is the value you want to extract. For example, if you have a document image in which you are searching for a statement date and the document contains two dates: one in a footer that states the date the file was last updated and the one you are interested in-the statement date. You can configure your dictionary to ignore any dates that appear in the bottom two inches of the page (where the footer is) effectively filtering it out.

Complete the following procedure to define visual clues:

1. Open the Visual Clues window as described in “Modifying synonyms” above.

FIG. 27 is an exemplary Modify Synonym—Visual Clues window.

The Modify Synonym—Visual Clues window is displayed for the selected synonym:

2. Specify one or more of the following:

Positional attributes—Tells the OCR engine where to locate the value of the selected synonym using measurements. You can “draw” a box around the information you want to extract by entering a value (in inches) in the Left, Top, Right, and Bottom fields. If you enter just one value, for example 2″ in the Bottom field, IMAGEdox will ignore the bottom two inches of the document image.

Textual attributes—Tells the OCR engine where to locate the value of the selected synonym using text elements (line number, paragraph number, table column number, or table row number). For example, if the account number is contained in the first line of a document, enter 1 in the Line No field.

Font Attributes—Tells the OCR engine how to locate the value of the selected synonym using text styles (font or typeface, font size in points, and font style or variation). If you know that a piece of information that you want to extract is using an italic font, you can define it in the Font Style field.

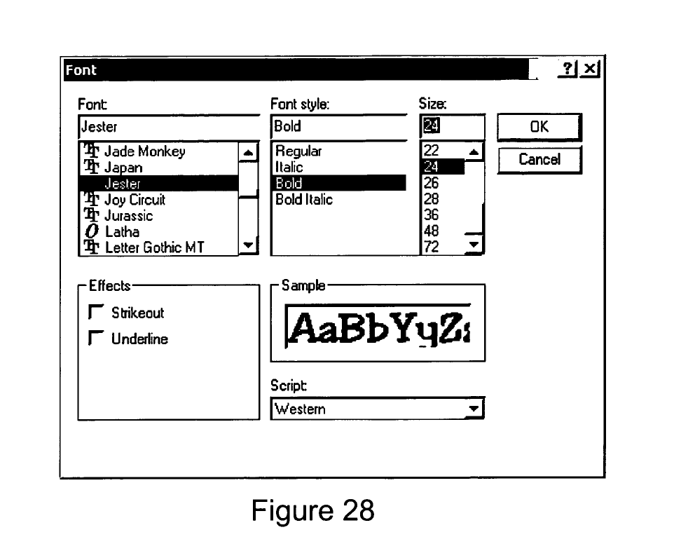

FIG. 28 is an exemplary font dialog display screen.

You can click Attribute [symbol] to display the Font dialog box where you can apply all three font attributes, and preview the result in the Sample field. When you click OK, the information is transferred to the Modify Synonym—Visual Clues window.

3. Click Done to add the visual clues to the selected synonym.

Continue building your dictionary as described in the next section.

Adding Search Patterns to a Dictionary

Search patterns define how IMAGEdox recognizes and extracts data from the document image being processed. You can define search patterns while creating terms (as described in conjunction with FIG. 25), or add new patterns an existing dictionary as described in this section.

To add new search pattern, complete the following procedure:

1. Open the dictionary that contains the term for which you want to add a search pattern.

2. Click a term in the Term pane.

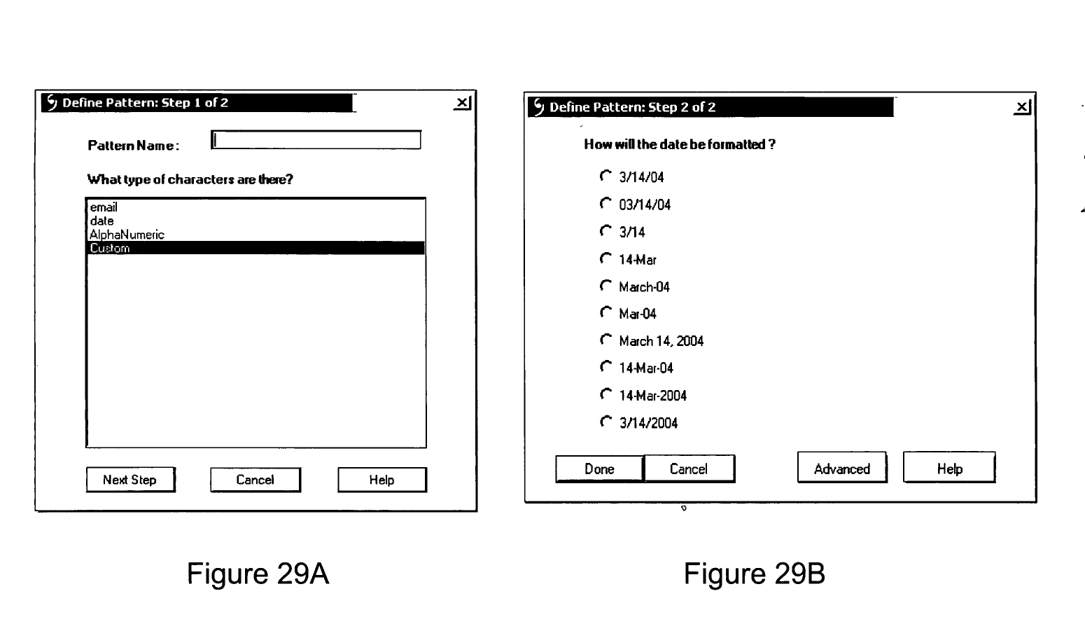

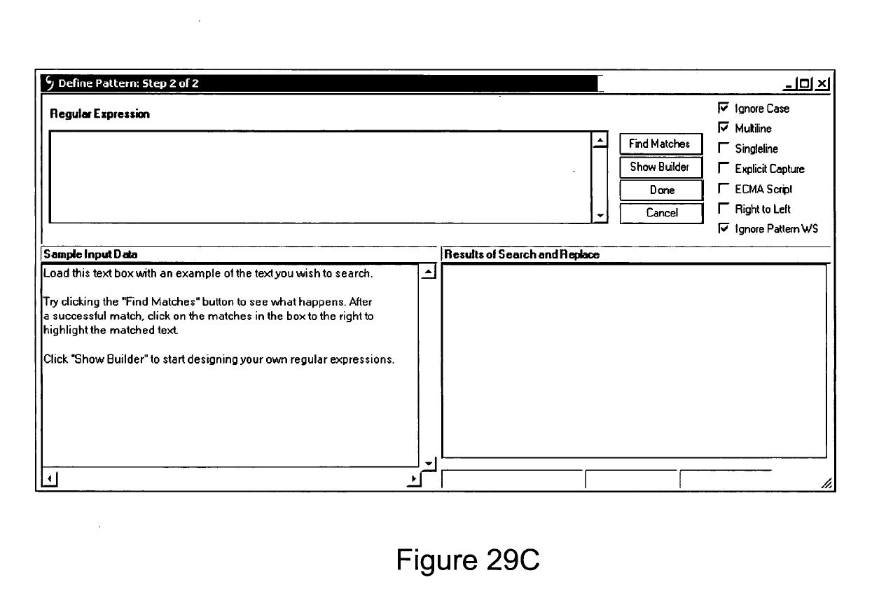

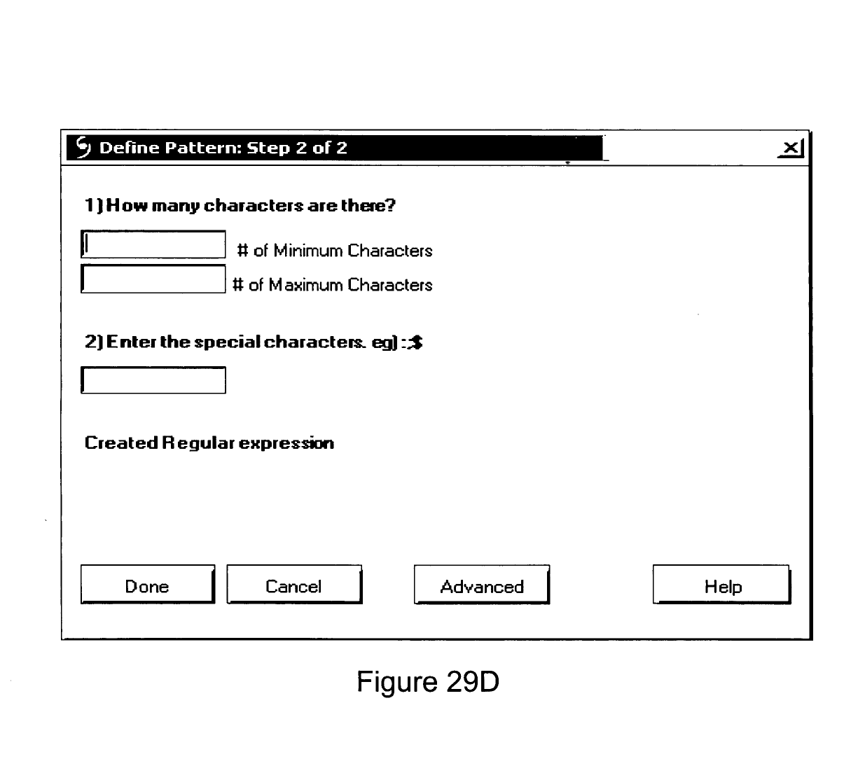

FIG. 29A, 29B, 29C and 29D are exemplary Define Pattern display screens.

3. In the Pattern pane, click Add Pattern

[symbol]

The Define Pattern (1 of 2) dialog box is displayed.

4. Enter the name of the pattern you are adding.

5. Select the type of pattern.

If you select Email or Custom, you are prompted to launch the Regular Expression Editor. Click No to apply a standard regular expression to validate the Email address, click Yes, to display the Regular Expression Editor (Define Pattern Step 2 of 2) where you can create a custom regular expression:

Define the regular expression that will be used to match the data you want to extract from the document images. For more information about regular expressions,refer to the Microsoft .NET Framework SDK documentation.

If you select Date, the Define Pattern (2 of 2) dialog box is displayed containing predefined formats available. Select a format, and click Done. The regular expression associated with the selected format is applied. You can also click Advanced to create a custom regular expression.

If you select Alphanumeric, the Define Pattern (2 of 2) dialog box is displayed. Enter the minimum and maximum number of characters allowed, and the special characters (if any) that can be included. The regular expression being created is displayed as you make entries, and applied when you click done. You can also click Advanced to create a custom regular expression.

Modifying Search Patterns

1. Open the dictionary that contains the term associated with the search pattern.

2. In the Term pane, click the term associated with the search pattern.

3. In the Pattern pane, click Modify Pattern

[symbol]

4. The Define Pattern (1 of 2) dialog box is displayed.

5. Edit the pattern name (effectively deleting the existing pattern and creating a new one) or type, or click Next Step to display the Regular Expression Editor where you can edit the regular expression.

Deleting Search Patterns

1. Open the dictionary that contains the term associated with the search pattern.

2. In the Term pane, click the term associated with the search pattern.

3. In the Pattern pane, click Delete Pattern

[symbol]

Creating Regular Expressions

The Dictionary window's Advanced Editor enables you to build and apply advanced search tools known as regular expressions. Regular expressions are pattern-matching search algorithms that help you to locate the exact data you want. Your regular expression can focus on two levels of detail:

Term level—You instruct the search engine how to extract the value of the term by defining a series of general formats that may describe the term's value. You create a regular expression for each of these general formats attempting to consider every way an account number could be represented. These are general descriptions that could be used for any bank.

For a new document, IMAGEdox may be able to find a match quicker using the term level, since it has no training in the specifics of the document.

Document level—For each bank, you write a regular expression to show the search engine how to extract the values of the document for that specific bank. In effect, you are telling IMAGEdox, “On a Wells Fargo Bank monthly statement, ‘Bank name’ looks like this . . . , ‘To’ date” looks like this . . . , and “From' date” looks like this.”

These formats, specific to a certain document for a certain bank, are more accurate than the general formats, but they are slower to apply.

Validation Scripts

Validation scripts are Visual Basic scripts that check the validity of the data values IMAGEdox has extracted as raw, unverified XML. You can create your own scripts, or contract Sand Hill Systems Consulting Services to create them. Validation scripts are optional and do not need to be part of your dictionaries.

The script compares the found value to an expected value and may be able to suggest a better match. You can run validation scripts on two levels:

Document level—Using your knowledge of the structure and purpose of the document, checks that all the parts of the document are integrated. For example, the script can ensure that the value of the Opening Date is earlier than the value of the Closing Date, or that the specific account number exists at that specific bank. If you know the characteristics of the statements that Bank of America issues, all you need to find is the name “Bank of America” to know whether the extracted account number has the correct number of digits and is in a format that is specific to Bank of America.

Term level—Checks for consistency in the data type for a term. For example, it ensures that an account number contains only numbers. This type of script can also check for data integrity by querying a database to see whether the extracted account number exists, or whether an extracted bank name belongs to a real bank.

To create and run a validation script, complete the following procedure:

1. Open the dictionary that contains the terms you want to validate.

2. In the Terms pane, click the button that corresponds with the level on which you want to run the script, either:
Document level [symbol] —Continue with step 3.
Term level [symbol] —Continue with step

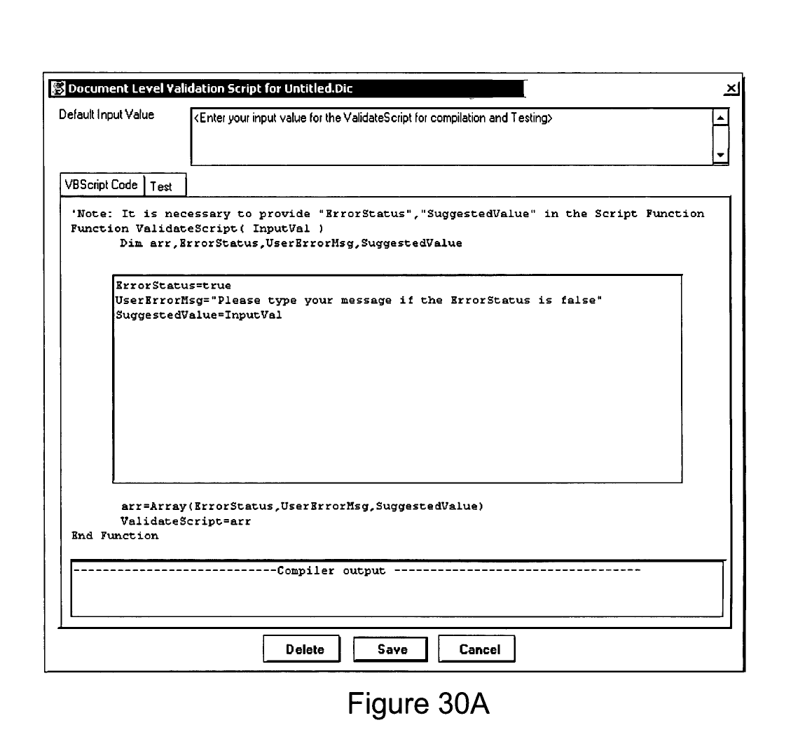

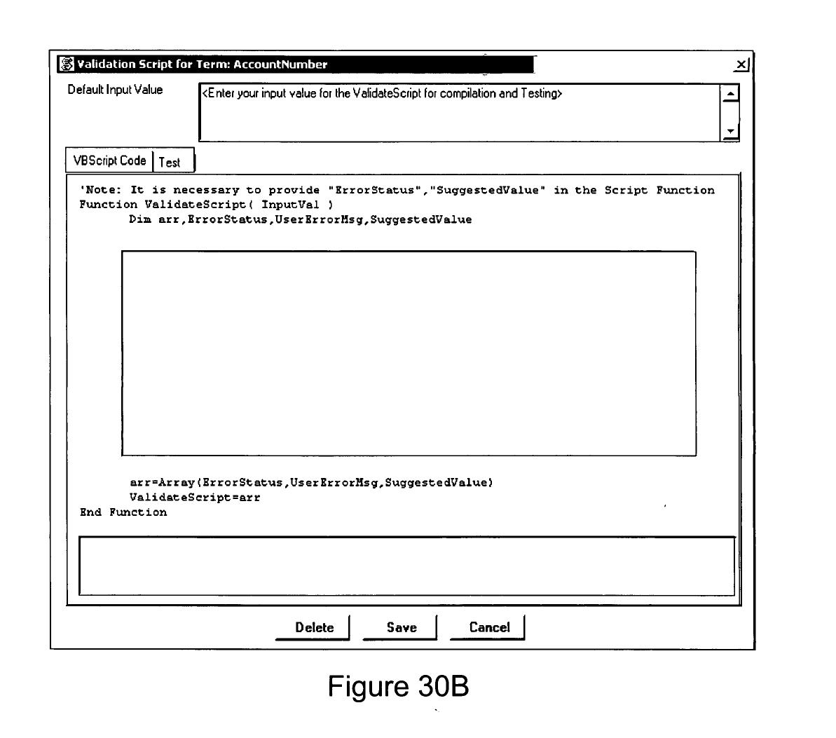

FIGS. 30 and 30A are exemplary validation script-related display screens.

The screen that corresponds with your selection is displayed, either Document Level:

or Term level (AccountNumber in this example):

3. In the Default Input Value field (of either screen), enter the sample value for the validation script to test.

4. On the VBScript Code tab, create the script that validates the extracted, unverified value.

For example, you may want the script to ensure that every Bank of America account number contains 11 digits and no letters or special characters. You must have the script return an error status, an error message, and a suggested value (which can be defined and tested as output parameters on the Test tab).

5. Click Save to compile and execute the script.

Extracting Data

By default, IMAGEdox automatically begins processing any image documents that are located in the input folder specified in the Application Settings Input screen (as described in “Editing input settings” above).

By default, the input folder is C: \SHSlmageCollaborator\Data\Input\PollingLocation. This document refers to the folder as the input folder.

You can get your document images into the input folder by either:
Configuring your scanner to output the image files (in TIFF format) there.
Manually copying the files there.

When IMAGEdox finds files in the input folder it performs the following steps:

Moves the document image files from the input folder into the workspace.

Performs optical character recognition on the image files

Applies the definitions contained in the document-specific and—if necessary—the default dictionaries to locate the data in which you are interested.

Extracts the data and moves the processed files to the appropriate output folder (as described in “Editing output folders” above).

Verifying Extracted Data

IMAGEdox client GUI enables you to review and verify (and, if required, modify) the extracted data. Using the GUI, you can navigate to each field in a document image (a field is each occurrence of a dictionary term or one of its synonyms), or between documents.

FIG. 31 is an exemplary verify data window display screen.

Introducing the Verify Data Window

This section introduces and explains the various GUI elements in the Verify Data window. The procedures associated with these elements are described in the sections that follow.

The left-hand pane is known as the Data pane. It displays the data extracted from the document image as specified by your dictionaries. The document image from which the data was extracted is displayed in the Image pane on the right. The Image pane displays the document image that results from the OCR processing.

The following table describes the elements in each pane.

| | Description: |
|---|---|
| Data pane element: | |
| Image File Path field | The name and location of the file currently displayed in the Image pane. |
| [symbol] | Specifies the size of the image displayed below the buttons in the |
| | Extracted Value field. The first button maximizes the image size in the |
| | field. The menu field allows a percentage value to be entered directly. |
| Extracted Value field | Displays the value extracted for the term listed below it in the |
| (no field label) | Dictionary Entry field (in this example, BankName). The extracted |
| | value is also outlined in red in the Image pane |
| Dictionary Entry field | Displays the term (as defined in the dictionary) that was searched for, |
| | and used to extract the value displayed in both the Extracted Value field |
| | and the Found Result field. In this example, IMAGEdox searched for a |
| | BankName (the term) and extracted Escrow Bank (the value). |
| Found Result field | Displays the ASCII format text derived from the Extracted Value field. |
| | If custom typefaces (fonts) are used in a company's logo, it may be |
| | difficult to render them in ASCII fonts. You should compare the value |
| | in this field with the image in the Extracted Value field to ensure they |
| | match. If they do not, you can type a new value in the Corrected Result |
| | field. |
| Error Message field | Displays an error message if a validation script determines the data is |
| | invalid. |
| Suggested Value field | Displays the value that the validation script suggests may be a better |
| | match than the value in the Found Result field. |
| Corrected Result field | Like the Found Result and Suggested Value fields, displays the text |
| | derived from the image in the Extracted Value field, but allows you to |
| | type in a new value. |
| [symbol] | Navigation buttons that enable you to navigate through the Dictionary |
| | Entry fields in the current document, and between image documents. |
| | The buttons from left to right are: First Image, Previous Image, First |
| | Field, Previous Field, Next Field, Last Field, Next Image, and Last |
| | Image. |
| | As you go from field to field, the red outline moves correspondingly in |
| | the Image pane, and the image and values are updated in the Data pane. |
| Save button | Saves the value currently displayed in the Corrected Result field. You |
| | only need to use this when you will not be moving to another field or |
| | page. Moving to another field or document image automatically saves |
| | your entries. Saved values are stored in XML files in the |
| | VerifiedOutput folder (by default, located in |
| | C: \SHSImageCollaborator\Data\Output\verifiedoutput) |
| Approve button | Uses the values defined in the Indexvariables.xml to collate: |
| | Individual .tif files into one large multi-page .tif file. |
| | Extracted data values into one or more XML files. |
| | These files are created in the Collated Image Output folder (by default, |
| | C: \SHSImageCollaborator\Data\Output\Collated Image Output). |
| | The Approve button can also be used to approve an entire batch of |
| | documents without going through each field in each image document |
| | individually. This feature should only be used after you are |
| | comfortable that your dictionary definitions and OCR processing are |
| | returning consistent, expected results. |
| Close button | Closes the Verify Data window. |
| Image pane element: | |
| [symbol] | The five buttons and the first menu specify the size of the image |
| | displayed in the Image pane. The first button maximizes the image size |
| | in the field. The first menu field allows you to enter a percentage value |
| | directly. The second menu field displays the specified page in a |
| | multiple page image document. |
| Accl # [symbol] | The red outline shows the extracted value for the corresponding term. |
| | In this case, for the term AccountNumber (with a synonym of Acct #), |
| | IMAGEdox has extracted 00001580877197. |

When the application extracts data from document images, it puts the data in the Unverified Output folder and shows you the images.

Using the Verify Data Window

The Data Verifier window enables you to review and confirm (or correct) data extracted from your scanned document images. The Data Verifier window enables you compare the extracted data and the document image from which it was extracted simultaneously.

1. Double-click the IMAGEdox icon on your desktop, or locate and double-click the IMAGEdox executable file (by default, located in C: \SHSImageCollaborator\Client\bin\ImageDox.exe).

The IMAGEdox Screen is Displayed.

2. Click Verify Data.

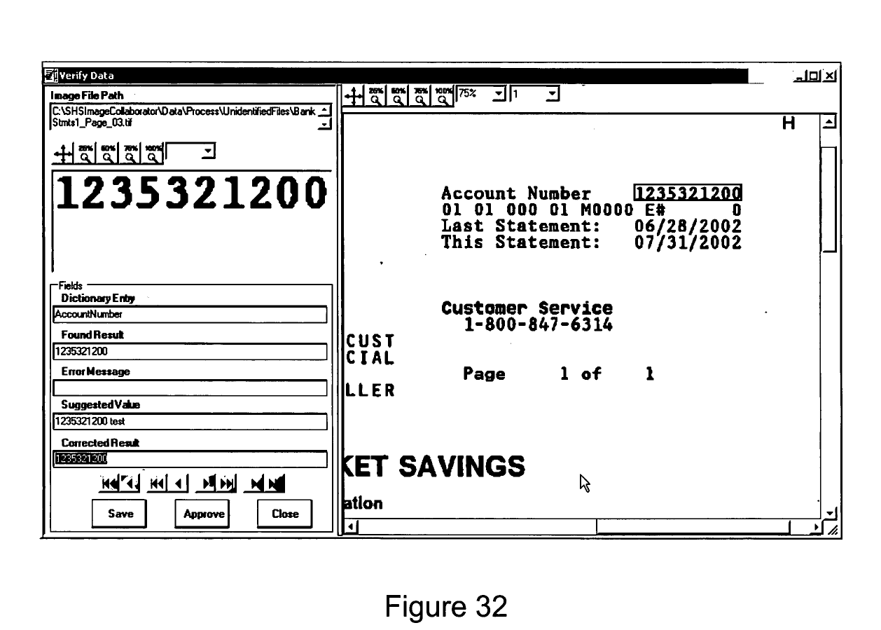

FIG. 32 is a further exemplary verify data window display screen.

The Verify Data window is displayed with the value (1235321200 in this example) for the dictionary entry (AccountNumber) extracted and displayed in the Data pane. The extracted value is also outlined in red in the Image pane.

3. Visually compare the extracted value in the Image pane to ensure it matches the outlined value in the document pane (you can use the magnification tools to resize the image in either pane).

Also ensure the ASCII format text in the Found Result field matches the value in the Extracted Value field. If, for example, you searched for a company name, and a custom typeface (font) was used in the company's logo, it may be difficult to render them in ASCII fonts.

If the extracted values do not match, type a new value in the Corrected Result field.

If there is a validation script running, the value it recommends is displayed in the Suggested Value-field. It may also display an error message. Consider the information before confirming the extracted value.

When you are satisfied with the result, proceed to step 4.

4. Click Next Field [symbol] to display the next dictionary entry's extracted value.

The extracted value is automatically confirmed and saved when you move to the next field.

5. Repeat the verification procedure (steps 3 and 4).

6. When you have confirmed all the dictionary entries in the current document, click Next Image [symbol] to display the next document image.

7. For each new document, repeat steps 3 through 6.

8. When you confirm all the dictionary entries in the last document image, click Approve.

IMAGEdox uses the values defined in the IndexVariables.xml to collate:
Individual .tif files into one large multi-page .tif file.
Extracted data values into one or more XML files.

These files are created in the Collated Image output folder (by default,

C:\SHSImageCollaborator\Data\Output\Collated Image Output).

It also saves individual XML files (which correspond with each input image document) in the VerifiedOutput folder (by default, C: \SHSImageCollaborator\Data\Output\VerifiedOutput).

The XML files that contain the extracted data values are described in the next section.

Extracted Data and Output Folders

IMAGEdox translates the data it extracts from your images into standard XML. The XML uses your terms (dictionary entries) as tags, and the extracted data as the tag's value. For example, if your dictionary entry is BankName, and you approved the value Wells Fargo that was returned by the data extraction process, the resulting AL would generally look like this:

<BankName>

Wells Fargo

</BankName>

The XML files created by the IMAGEdox extraction process contain the specific data that you want to make available to your other enterprise applications. The information is stored in a variety of files, located in the following output folders (by default, located in C: \SHSImageCollaborator\Data\Output):
CollatedFiles
Index
UnverifiedOutput
VerifiedOutput

The sections that follow describe the files that are created and placed in each of these folders.

CollatedFiles Folder

The CollatedFiles folder contains files that are created by IMAGEdox when a group (or batch) of processed image documents are approved at the end of the data verification procedure. Two types of files are created for each batch that is approved:

An image file—Multi-page .t if file that is created by combining each approved, single-page, TIFF-format document image.

One or more data files—XML files that are created by combining the extracted data values from each document image processed in the batch. The contents of each collated XML file is determined by the definitions in the IndexVariable.XML file.

These definitions control where one file ends and another begins. For example, if two five-page bank statements are processed, they are read as 10 individual graphic files. When the collation is done, the IndexVariable.XML file can define that a new document be created each time a new bank name value is located. In this example, the new bank name would be located in the sixth image file. Therefore, the first five pages would be collated into an XML file, as would the second five pages.

The location of the IndexVariable.XML file is defined in the Processing Data Application Settings described above. By default, it is located in C: \SHSImageCollaborator\Config\ApplicationSettings.

The Index Variable.XML file also is used to generate index XML files that populate the Index folder as described below.

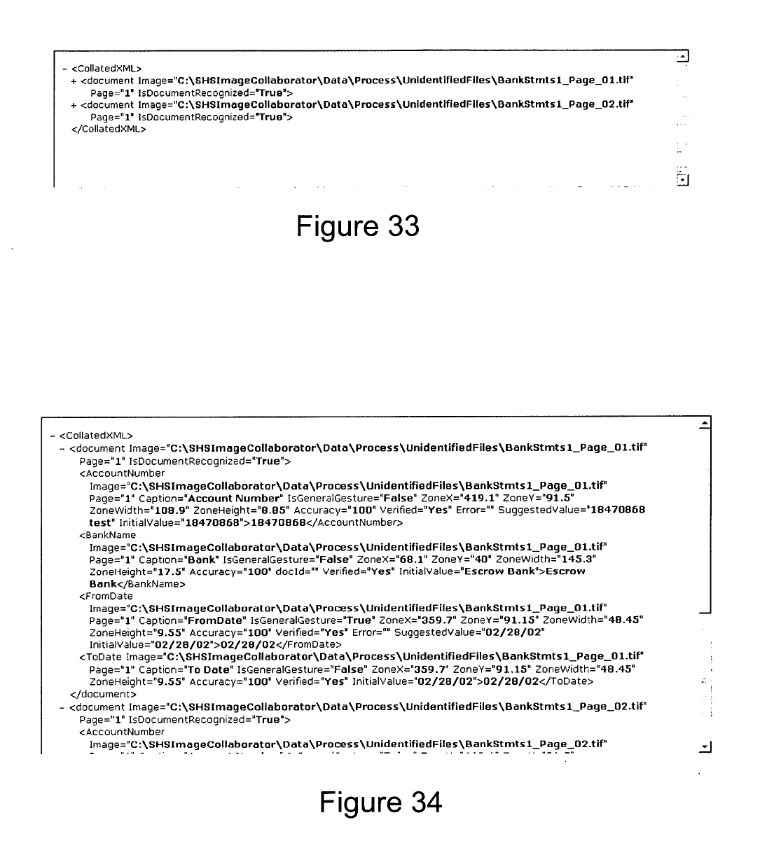

FIG. 33 is a graphic shows an example of a collated XML file.

Note the following in the graphic:
Only two document images were part of this batch job.
The file names are BankStmts1_Page_{—}01.tif and BankStmts1_Page_{—}02.tif.
The two files are stored in C:\SHSImageCollaborator\Data\Process\unidentifiedFiles\

FIG. 34 is an exemplary expanded collated XML file.

The plus sign (+) can be clicked to expand the list of attributes as follows (after clicking it, the plus sign is displayed as a minus sign (−):

The additional attributes show that visual clues (Zones) were used to define an area where to look for the terms and their corresponding values.

Index Folder

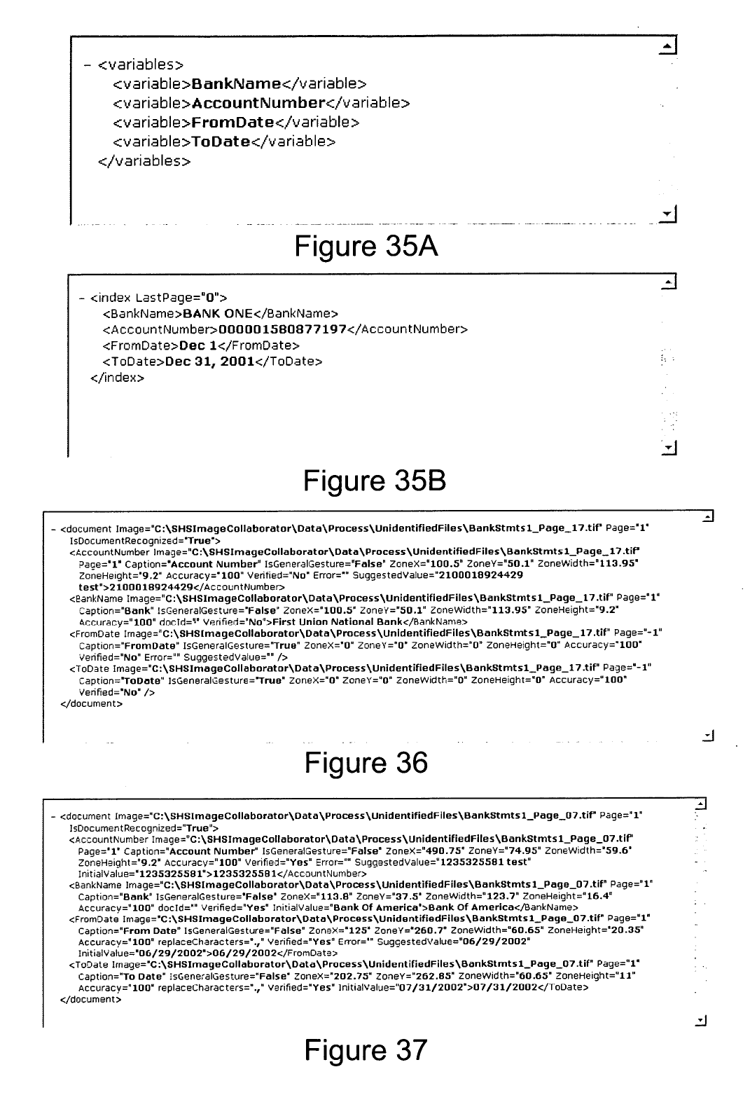

FIGS. 35A is an exemplary IndexVariable.XML fileand 35B are exemplary index folder display screens.

The Index folder contains an XML output file that corresponds with each input file (the document image files). Each index file contains the values extracted for each of the index values defined in the user-created IndexVariable.XML file. For example, the Indexvariable.XML file in FIG. 35A produces the index file in FIG. 35B.

UnverifiedOutput Folder

FIG. 36 is an exemplary unverified output XML file.

The unverifiedOutput folder contains XML files where some of the terms being searched for are not found and no value is entered in the Corrected Result field by the user doing the data verification. These files are often the last pages of a statement tat do not contain the information for which you were searching.

VerifiedOutput Folder

FIG. 37 is an exemplary verified output XML file.

The VerifiedOutput folder contains the XML files that contain values that have been confirmed by the user doing the data verification.

The following is an illustrative software development kit (SDK) for an illustrative implementation of IMAGEdox.

IMAGEdox SDK Overview

The IMAGEdox SDK is an integral product component that supports creating and running the workflow, batch-processing, and Windows service applications which involve data extraction from images.

This section provides an overview of IMAGEdox SDK functionality.
Image library—Provides a set of functions that implement the following features:
Retrieve image properties
Convert image formats
Modify image compression techniques
Split a multi-page image in to multiple images.
Merge multiple images in to a single multi-page image.
Identify whether an image is acceptable to the OCR engine, and modify it if it is not.
Application configuration settings—Provides the ability to load application configuration settings from a file.
Ability to group and process images—Provides an infrastructure to process a group of images that shares some common behavior or relation with one another.

For example, you can process of set of bank statement images that represent multiple pages in the same physical document.
Data extraction from images—Provides the ability to recognize and extract data from image files. It also provides the ability to extract data from the OCR engine output.

In the illustrative implementation, the following software programs are required by IMAGEdox SDK:
Microsoft Windows XP, Windows 2000, or Windows 2003 operating system
Microsoft .NET Framework SDK 1.1
ScanSoft OCR engine (installed by the IMAGEdox installation program)

Additionally, you have the option of installing image enhancement software from FormFix version 2.8.

Image Library

The image library functionality is implemented in the following classes:

| | Namespace | Module Name |
|---|---|---|
| Enumeration | | |
| ImagePropertyTag | SHS.ImageDataExtractor | SHS.TmageDataExtraCtOr.DLL |
| ImageCompressionCode | SHS.ImageDataExtractor | SHS.ImageDataExtractor.DLL |
| Class Name | | |
| ImageProperty | SHS.ImageDataExtractor | SHS.ImageDataExtractor.DLL |
| PageFrameData | SHS.ImageDataExtractor | SHS.ImageDataExtractor.DLL |
| ImageUtility | SHS.ImageDataExtractor | SHS.ImageDataExtractor.DLL |

SHS.ImageDataExtractor.DLL provides the following three sets of functionalities.

General Image Operations Using the ImageProperty Class:

Retrieving image metadata.

Converting image file format and changing the compression technique used in the image.

Related classes:

Image Collation Using the PageFrameData and ImagerUtility Classes:

Merging multiple images in to a single image

Splitting multi-page image in to multiple images.

Checking and Making Images Acceptable to the OCR Engine Using the ImageProperty and ImageUtility Classes.

These functions are provided to aid the integrating module to provide an image that can be processed by the OCR engine. If the integrating module does not control the nature of the image, it should ensure the given image can be processed by the OCR engine. If it cannot, determine the reasons and correct these issues before invoking the data extraction functions.

The OCR engine can reject images for the following reasons:
Image file format is not supported by the OCR engine
Image compression technique not supported by the OCR engine
Image resolution greater than 300 dpi
Image size, width, or both greater than 6600 pixels

The IMAGEdox SDK image library can correct the first two cases of rejection; the calling module must correct the third and fourth cases.

General Image Operations

A set of functions are provided to retrieve the image properties including—but not limited to-file format, compression technique, width, height, and resolution. This functionality also contains a set of functions for converting images from one format to another format, and changing the compression technique used on the image.

Retrieving Image Properties Example:

```
    static bool IsIlleagalImage(string_imagePath)
    {ImageProperty[ ] p = GetImageProperties (_imagePath);
    if ((double) ImageProperty.GetPropertyValue(p,
ImagePropertyTag.XResolution) > 300.0
        return false;
    if ((double) ImageProperty.GetPropertyValue(p,
ImagePropertyTag.YResolution)> 300.0
        return false;
    if ((uint) ImageProperty.GetPropertyValue(p,
ImagePropertyTag.ImageWidth) > 6600)
        return false;
    if ((uint) ImageProperty.GetPropertyValue(p,
ImagePropertyTag. ImageHeight) > 6600
        return false;
    return true;
}
```

Converting Bitmap to jpeg Example:

ImageUtility.ConvertImage(@ “C:\Temp\Sample.bmp”, @“C:\Temp\Sample.jpg”, “image/jpeg”, EncoderValue.CompressionNone);

Converting Bitmap to tiff Example:

ImageUtility.Convertlmage(@“C:\Temp\Sample.bmp”, @“C:\Temp\Sample.tif”, “image/tiff”, EncoderValue.CompressionCCITT4);

Image Collation and Separation

A scanned image can either contain one page or all of the pages from a batch. Because a single-page image may be part of a multi-page document, IMAGEdox needs to be able to collate the related single-page images into a single multi-page image.

Similarly, a multi-page image may contain more than one document (for example, one image file containing three different bank statements). In this case, IMAGEdox needs to divide the image into the multi-page image into multiple image files containing only the related pages.

If the source is a multi-page image, the collation function provides the ability to specify page numbers within the source. This information is captured using the PageFrameData class. The structure captures the source image and the page number. The target image is created from the pages specified through the input PageFrameData set. The PageFrameData set can point to any number of different images. The number of pages in the target image is controlled by the number of PageFrameData elements passed to the function. This same function also can be used to separate the images into multiple images.

This API can also be used to create a single-page TIFF file from a multi-page TIFF file.

Page Separation Example:

This example shows dividing a multi-page TIFF file into multiple single-page files. PageFrameData can also be used to divide a multi-page TIFF file into a multiple multi-page TIFF files.

```
    PageFrameData[ ] pageInfo = new PageFrameData[1];
    // Image Splitting
    pageInfo[0] = new PageFrameData(@“C:\Blank Sf424.tif”, 0);
ServiceUtility.Collate(pageInfo, @“C:\Sf424page1.tif”,
EncoderValue.CompressionCCITT4);
    // Image Splitting
    pageInfo[0] = new PageFrameData(@“C:\Blank Sf424.tif”, 1);
ServiceUtility.Collate(pageInfo, @“C:\Sf424_page2.tif”,
EncoderValue.CompressionCCITT4);
    // Image Collation
    pageInfo = new PageFrameData[2];
    pageInfo[0] = new PageFrameData(@“C:\Sf424_page1.tif”, 0);
pageInfo[1] = new PageFrameData(@“C:\Sf424_page2.tif”, 0);
ServiceUtility.Collate (pageInfo, @“C: \Sf424 .tif”,
EncoderValue.CompressionCCITT4);
```

Ensuring Images are Supported by the OCR Engine

Because the OCR engine does not support all possible image formats and compression techniques, the invoking module must ensure that the image can be processed by the OCR engine.

The OCR engine can reject images for the following reasons:
Image file format is not supported by the OCR engine
Image compression technique not supported by the OCR engine
Image resolution greater than 300 dpi
Image size, width, or both greater than 6600 pixels

The IMAGEdox SDK image library can correct the first two cases of rejection; the calling module must correct the third and fourth cases.

Before passing an image to the OCR engine, the invoking module can check whether an image is acceptable to the OCR engine. If the image is not acceptable, the application module should determine the reason why it is not acceptable.

If the reason the file is not acceptable is:

The file format or compression technique (or both) is not supported—The application module can correct the problem by using the appropriate function. The modified image can then be submitted to the OCR engine.

Image resolution is greater than 300 dpi, or the image size or width (or both) is greater than 6600 pixels—IMAGEdox can route the image to a separate workflow for manual correction before being submitted for data extraction.

OCR-Friendly Image Example:

The following example ensures an image is OCR-friendly. If the image is not acceptable to the OCR engine, the image is converted to the desired format which is acceptable.

```
if (!ImageProperty.IsOCRFriendlyImage (“C:\Sample.tif”))
{
    ImageUtility.ConvertImage(@“C:\Sample.tif”, @“‘C:\Sample1.tif”,
“image/tiff”, EncoderValue.CompressionCCITT4);
    System.IO.File.Copy(@“C:\Sample1.tif”, @“C:\Sample.tif”, true);
System.IO.File.Delete(@“C:\Sample1.tif”);
    }
```

Application Configuration Settings

This functionality captures and provides information for the successful processing of:
Image enhancement
OCR
Data extraction
Custom validation
Indexing.

It also captures information about the temporary file folders where IMAGEdox stores the temporary files created during processing.

The settings are captured in AppSettingsOptions class found in SHS.DataExtractor.DLL. The parameters in the AppSettingsOptions class are described in the following table.

| Parameter Name | Description |
|---|---|
| mLogAllErrors | Used by the client interactive application to |
| | decide whether or not all application errors |
| | that occurred should be written in a log file. |
| mShowAllErrors | Used by the client interactive application to |
| | decide whether or not all application errors |
| | that occurred should be displayed to the user. |
| mPackageIdentificationTblFilePath | FormFix image identification process settings |
| | file path. This is used to classify the images |
| | into document classes. For example, whether |
| | it is a bank statement, AP, AR, or a loan |
| | document. |
| mImageIdentificationTblFilePath | FormFix image identification process settings |
| | file path. This is used to classify the images |
| | into document variants. For example, whether |
| | it is a Bank Of America or Bank One |
| | document. |
| mEnableImageEnhancement | Controls whether or not an image should be |
| | enhanced using the imaging component |
| | before it is submitted to the OCR engine. |
| mPreIdentificationEnhancementOptionsFile | Specifies the type of image enhancement that |
| | should be done when the imaging component |
| | is enabled. |
| mOCRSettingsPath | Contains the settings for the OCR engine. |
| mDefaultDocSpecGestureFilePath | Full path of the document-specific gesture. |
| mDefaultDictionaryPath | Full path of the first set of document gestures. |
| mDefaultDictionaryPath2 | Full path of the second set of document |
| | gestures. |
| mExcelSheetPath | Full path of the Excel document that would be |
| | used by the document-specific custom data |
| | validation component. |
| LogProcessingStatistics | Flag that controls whether or not the |
| | processing statistics should be logged. |
| ProcessingStatisticsLogFile | Log file to be used when Process Statistics are |
| | enabled. |
| mFileStore | DLL used by the NT service that accesses the |
| | images that needs to be processed. This |
| | module should provide the set of images that |
| | needs to be processed, and should handle the |
| | result of processing. |
| mFileStoreClassUrl | Class implemented in the mFileStore DLL |
| | used by the NT service for the |
| | aforementioned image processing. |
| mIndexingVariableFilePath | XML file containing the list of variables that |
| | needs to be considered as part of document |
| | index. |
| mPollingLocation | Folder (containing the input image |
| | documents) that is monitored and processed |
| | by the NT service. |
| mOCROutputTempLocation | Folder in which the files created by the OCR |
| | process are temporarily stored (before being |
| | automatically deleted). |
| mOutputFolderLocation | Folder used by the NT service and client |
| | interactive application to store the less |
| | accurate result of data extraction. |
| mVerifiedOutputFolderLocation | Folder used by the NT service to store the |
| | result of data extraction when the extraction |
| | accuracy is 100%. Used by the client |
| | interactive application to store the verified |
| | data. In these cases the client interactive |
| | application will pick the data from |
| | mOutputFolderLocation and the verified data |
| | will be moved to the folder specified in the |
| | mVerlfiedOutputFolderLocation parameter. |
| mInvalidFilesStorageLocation | Folder in which the invalid files are placed. |
| | This parameter is used by NT service. |
| mIndexingFolderPath | Folder used by the NT service and the client |
| | interactive application to store the document |
| | index. |
| mImageCollationFolderPath | Folder used by the client interactive |
| | application to store the collated XML file and |
| | the collated image file. |

Infrastructure to Handle Groups of Images

The IMAGEdox SDK provides infrastructure to handle a group of images that shares some common information or behavior. For example, the SDK tracks the index of the previous image so that it can generate a proper index for the current image when some information is missing.

The JobContext class tracks the context of the batch currently being processed. It exposes AppSettingsOptions property that contains the configuration associated with the current batch processing.

An object of the JobContext class takes three parameters

The first parameter is the file path for the application settings that needs to be used for this batch processing.

The second parameter informs the IMAGEdox SDK whether or not the caller is interested in acquiring the OCR result in the OCR engine's native format.

The third parameter informs the IMAGEdox SDK whether or not the caller is interested in acquiring the OCR result in HTML format.

IMAGEdox SDK always provides the OCR result in XML format irrespective of whether or not the two aforementioned formats are requested. The OCR result in XML format can be reused to extract a different set of data.

The OCR native format document and the OCR HTML document are transient files and these needs to be stored somewhere by the caller before the next item in the batch is processed—otherwise the caller will delete this information.

Data Extraction

Data Extraction is the process of extracting data from an image file. This process involves using optical character recognition (OCR) on an image and converting the pixel information in the image to textual characters that can be used by IMAGEdox and other applications.

The Image SDK provides an optional Image Enhancement component to increase the quality of the image so that the accuracy of OCR component can be improved to a maximum extent.

The extraction process involves the following steps.
Enhance the input image if image enhancement functionality is enabled.
Using OCR processing, convert the graphic image into formatted text.
Extract the data from the formatted text.

This involves validation and verification of the data before it can be considered.

Call custom scripts for further validation and data filtering.

Create an index for the image using a subset of variables for extracted data if an index has been defined.

Return the result to the calling application.

The IMAGEdox SDK also provides a mechanism to extract data from the OCR data that has been extracted as part of prior processing. This prevents the time consuming operation of OCR processing an image more than once.

As previously mentioned, the IMAGEdox SDK provides infrastructure to perform document collation. Document collation is a process in which individual pages of a multi-page document are collated to form a single document. This involves collating individual page images in to a single multi-page image along with collating each page's extracted data in to a single set of data for that document. This collation is done with the help of index variables defined by the calling application.

Data extraction involves multiple processing phases. If an error occurs, an output parameter returns the specific processing phase in which the error occurred along with the error. This helps the calling application to build a workflow to handle the error cases along with capturing the intermediate result of successful phases. This enables you to avoid repeatedly processing successfully completed phases in the same document image.

The data extraction module can be used as a library or it can be used as a module in a workflow. Because the workflow process involves combining disparate components, it is possible that a module that precedes the IMAGEdox component would be different from a module that follows this IMAGEdox component. In these cases, the preceding module can pass information about what should be done with the data extraction result of a given item through the item's context object to the next module that would handle the data extraction result.

Use Cases

Data extraction from an image:

1. Select the application settings.

2. Create the JobContext object for the chosen application settings options.

3. Get the image file path.

4. Create Docltem instance for the image in step 3.

5. Call ProcessJobltem.

6. Save the enhanced image for the further use.

7. Save the resulting OCR data in XML format for further data extraction.

8. Save the extracted data.

9. Save the index value.

10. Repeat the process if more than one image needs to be processed.

11. If more than one image is processed, then based on index value, do the following:
Collate the images
Collate the extracted data.
Save the collated document image
Save the collated document data

Data extraction from resulting OCR data in XML format:

1. Select the application settings

2. Create the job context object for the chosen application settings

3. Get the file which contains OCR result data in XML data format

4. Create Docltem instance for the above OCR XML data

5. Call FindVarlablevalues function

6. Save the extracted data

7. Repeat the above process if more than one OCR result data exists from which data needs to be extracted.

The following classes and enumeration implement the data extraction functionality.

| | Namespace | Module Name |
|---|---|---|
| Enumeration | | |
| ProcessPhase | SHS.ImageDataExtractor | SHS.ImageDataExtractor. |
| | | DLL |
| Class Name | | |
| DocItem | SHS.ImageDataExtractor | SHS.ImageDataExtractor. |
| | | DLL |
| SearchVariable | SHS.ImageDataExtractor | SHS.ImageDataExtractor. |
| | | DLL |
| Seviceutility | SHS.ImageDataExtractor | SHS.ImageDataExtractor. |
| | | DLL |

ProcessPhase Enumeration

This enumeration defines the set of phases that are present in the processing algorithm. If any error occurs during processing, the IMAGEdox SDK returns the phase in which the error occurred along with the exception object.

| Phase | Description |
|---|---|
| UnknownPhase | An error occurred outside the data extraction |
| | processing. |
| PreProcessing | An error occurred during preprocessing stage. When |
| | the IMAGEdox SDK is called within the context of |
| | automated batch job processing with callbacks, it |
| | invokes calling application provided preprocessing |
| | callback function to prepare the given item for |
| | processing. This phase is called preprocessing. |
| | This would be applicable only when the |
| | IMAGEdox library is used in a workflow process. |
| | IMAGEdox NT service uses this module in workflow |
| | context. |
| ImageProcessing | During this phase, the image quality would be |
| | enhanced to improve the accuracy. This would be |
| | bypassed if image enhancement is turned off |
| | through application settings. |
| OCRRecognition | This phase includes the steps involved in converting an |
| | image into formatted text by the underlying OCR |
| | engine. |
| DataExtraction | This phase covers data extraction functionality. |
| Verification | During this phase, the calling application provided |
| | call back function would be invoked to validate and |
| | verify the extracted data. |
| Indexing | During this phase, an index is created based the index |
| | variables defined through application settings, |
| PostProcessing | During this phase, calling application provided |
| | callback function would be invoked with the |
| | processing result to let it handle the post-processing. |
| | This is called only within the context of automated |
| | batch job processing. This would be applicable |
| | only when the IMAGEdox library is used in a |
| | workflow process. IMAGEdox NT service uses |
| | this module in workflow context. |
| Completion | Indicates the successful completion of processing. |

Docltem Class

This class is implemented as a structure that carries input information for the processing function and carries back result of processing to the calling application.

The Docltem instance is passed as input in the following data extraction cases:
Data extraction from an image file.
Data extraction from prior OCR result data.

Input Parameters to the Processing Function:

| Data Type | Field Name | Description |
|---|---|---|
| Object | Context | This carries the context of processing |
| | | between calling module who feeds |
| | | the data to the result handling |
| | | module which handles the result of |
| | | the processing. This would happen |
| | | when IMAGEdox is configured to |
| | | run in a workflow where one |
| | | independent component feeds data |
| | | while another independent |
| | | component handles the result of the processing. |
| String | ImageName | The file path of the image from |
| | | which the data needs to be extracted. |
| | | An exception will be thrown when |
| | | the image format can't be accepted |
| | | by OCR engine. |

Methods for Processing Input Data:

The following output fields will have values only when the image enhancement option is turned on, and metadata is defined using the FormFix component to identify the images using imaging technique. Values for the following fields are generated during image enhancement phase of the processing.

| | | |
|---|---|---|
| bool | IsImageIndentified | This flag indicates whether |
| | | the FormFix component has |
| | | successfully identified the |
| | | image based on the metadata |
| | | defined in it. |
| bool | IsPartOfKnownDocument | This flag indicates |
| | | whether the FormFix |
| | | component has identified the |
| | | type document of this image. |
| bool | IsPartOfKnownPackage | This flag indicates |
| | | whether the FormFix |
| | | component has identified the |
| | | document package of this |
| | | image. |
| string | FormId | Contain the document |
| | | name (for example, Bank of |
| | | America) when |
| | | IsPartOfKnownDocument is |
| | | set to true. |
| String | FormName | Contain the |
| | | package name or document |
| | | class (for example, bank |
| | | statement) when |
| | | IsPartOfKnownPackage is set |
| | | to true. |
| String | ImageIdErrorMessage | Contains the error |
| | | message that occurred within |
| | | FormFix component during |
| | | identification. |

Values for the following output fields are generated during image OCR phase:

| | | |
|---|---|---|
| String | EnhancedImageName | Path of Enhanced image. This |
| | | includes image enhancements like |
| | | deskew, despeckle, and rotation. If |
| | | image is rotated during OCR |
| | | processing then the extracted |
| | | data's zone details would |
| | | be relative to this image rather |
| | | than the original image. |
| Bool | Recognized | This flag tells whether |
| | | or not the OCR engine has |
| | | successfully converted the image |
| | | into formatted text. |
| Bool | IsBlank | This flag tells whether |
| | | the given page is a blank page or not. |
| String | RecognizedDocName | Path of native |
| | | OCR document. This document |
| | | would be created only if the |
| | | JobContext is set to create one. This |
| | | document is transient and temporary. |
| | | The calling application should store |
| | | it somewhere before calling the clean |
| | | up function. |
| String | HTMLFileName | Path of HTML |
| | | formatted data file created as part of |
| | | OCR processing. This file will be |
| | | created only if JobContext is set to |
| | | create one. This is transient and |
| | | temporary. So the calling application |
| | | should store it somewhere before |
| | | calling clean up function. This file |
| | | can be used for standard text-index |
| | | searching as an alternate document |
| | | for the image. |
| String | DataFileName | Path of formatted text |
| | | generated by the OCR processing in |
| | | XML data format. This file can be |
| | | used to bypass OCR processing of |
| | | this image again in the subsequent |
| | | data extraction |

Values for the following output fields are generated during data extraction phase:

| | | |
|---|---|---|
| String | szText | An intermediate text file |
| | | generated from formatted text in |
| | | XML format (this formatted text is |
| | | generated by the OCR engine). This |
| | | text file is used for the data extraction. |
| String | szXML | Extracted raw data in |
| | | XML format |
| String | szVerifiedXML | Extracted data |
| | | in XML format. This includes the |
| | | validation and verification made |
| | | using script and the custom |
| | | component. |
| Search | Variable | List of extracted |
| | | variable's |
| | | Variable [ ] |
| | | properties. Refer |
| | | Search Variable class for more |
| | | information. |

Values for the following output fields are generated during indexing phase:

| | | |
|---|---|---|
| Bool | IsLastPage | Whether the given page |
| | | is the last page of separated |
| | | document or not based on |
| | | the generated index |
| | | for this document. |
| String | szIndexXML | An XML data |
| | | containing index information |
| String[ ] | IndexVariables | List of |
| | | variables specified in |
| | | indexvariables. xml settings |
| | | in the order of appearance. |
| String[ ] | IndexVariableValues | Values |
| | | for the index variables found |
| | | in the IndexVariables field. |
| String[ ] | IndexVariableLeveledValues | Leveled values for the |
| | | index variables found in the |
| | | IndexVariables field. This |
| | | leveling is done by the |
| | | IMAGEdox component using |
| | | heuristics mechanism based |
| | | current document's index |
| | | values and the prior |
| | | document's index values. |

Search Variable Class

This class is implemented as a structure that carries output information that is generated as part of data extraction.

Parameters Used in the SearchVariable Class:

| Data Type | Field Name | Description |
|---|---|---|
| String | Name | Variable name against which |
| | | the data has been extracted |
| String | Caption | Caption of the variable |
| | | name against which the data |
| | | has been extracted. |
| String | Value | Extracted value for the given |
| | | variable. |
| String | SuggestedValue | A suggested |
| | | value generated by the validation |
| | | script or application supplied |
| | | custom component. |
| String | ImagePath | File path of the image |
| | | from which the data has been |
| | | extracted. |
| Int | PageNo | Page number of the |
| | | image from which the data has |
| | | been extracted. Page number |
| | | starts from 1. |
| Double | ZoneX | Left position of the region |
| | | covering the extracted value in |
| | | points scale. This geometrical |
| | | information can be used in data- |
| | | verifier component, to build a |
| | | learning engine and so on. |
| Double | ZoneY | Top position of the region |
| | | covering the extracted value in |
| | | points scale |
| Double | ZoneWidth | Width of the region |
| | | covering the extracted value in |
| | | points scale |
| Double | ZoneHeight | Height of the region |
| | | covering the extracted value in |
| | | points scale |
| Int | Accuracy | Accuracy scale. By |
| | | default, the data extraction |
| | | component will set the accuracy |
| | | level to 100%. This value will be |
| | | set to a value lesser than 100% |
| | | when the script or application |
| | | supplied component suggests |
| | | another value against this |
| | | variable. |
| NameValue[ ] | ExtendedProperties | Set of name/value |
| | | pair associated with this |
| | | extracted value through the gesture |
| | | that is used for the extraction. This |
| | | is provided to extend the |
| | | functionality of this application. |
| | | This can include the set of |
| | | information that is needed for |
| | | integration, how the data needs to |
| | | be handled, where the data needs |
| | | to be sent and so on. |

The following is a description of illustrative Image Collaborator/IMAGEdox API.

Library Module: SHS.ImageDataExtractor.DLL Namespace: SHS.ImageDataExtractor

JobContext Class

This class initializes all resources needed to process a specific class item. This class exposes an AppSettingsOptions field that contains configuration settings for this specific class of documents.

JobContext( )

Purpose: Creates an instance of the JobContext class.

Syntax: JobContext (string_appSettingsFileName, bool_persistSSDoc, bool_persistOCRHtml);

| Parameter | Description |
|---|---|
| _appSettingsFileName | XML file containing configuration settings |
| | required to process a specific class of documents. |
| _persisSSDoc | Flag that states whether the caller is interested |
| | in persisting OCR document in ScanSoft |
| | document format for reloading in any other |
| | client application. Note that, due to disk |
| | space issues, only a temporary file is |
| | created regardless of whether this |
| | parameter is set to true or false. When |
| | the DLL responds to a request, it returns |
| | control to the caller. The caller must specify |
| | if it wants to save the file (and if so, where |
| | it is to be saved). |
| _persistOCRHtml | Flag that states whether the caller is interested |
| | in persisting OCR document in HTML format for |
| | reloading in any other client application. Note |
| | that, due to disk space issues, only a temporary |
| | file is created regardless of whether this parameter |
| | is set to true or false. When the DLL responds to |
| | a request, it returns control to the caller. The |
| | caller must specify if it wants to save the file |
| | (and if so, where). |

Returns: JobContext( ) creates an instance of this class. An exception is thrown if any error occurs during the initialization of this instance.

Docltem Class

This class is used as an item context to track an item's information and its process results.

Fields:

| Data Type | Field Name | Type | Description |
|---|---|---|---|
| Object | Context | Input | Item context |
| String | ImageName | Input | Image file path |
| Int | ImagePage | Input | Page number within TIFF file |
| string | EnhancedImageName | Output | Enhanced image path |
| string | RecognizedDocName | Output | ScanSoft document path for this |
| | | | image |
| string | HTMLFileName | Output | HTML file path containing |
| | | | recognized |
| string | DataFileName | Output | Path of the file used for data |
| | | | extraction |
| bool | IsImageIndentified | Output | Whether the class of the document |
| | | | is identified using image signature |
| bool | IsPartOfKnownDocument | Output | A flag indicating whether the |
| | | | document class for this image is |
| | | | identified or not |
| bool | IsPartOfKnownDocument | Output | A flag indicating whether the |
| | | | document type for this image is |
| | | | identified or not |
| string | FormId | Output | Identified document class name if |
| | | | successful |
| string | FormName | Output | Identified document type name if |
| | | | successful |
| string | ImageIdErrorMessage | Output | Error message when the image |
| | | | identification fails |
| bool | Recognized | Output | Whether the page is |
| | | | successfully processed |
| | | | for data extraction |
| bool | IsBlank | Output | Whether the given page |
| | | | is a blank page or not |
| bool | IsLastPage | Output | Whether the given page |
| | | | is the last of page of |
| | | | separated document |
| String | szText | Output | OCR Extracted text that |
| | | | is used for data |
| | | | extraction |
| string | szXML | Output | Extracted data in XML |
| | | | text |
| string | szVerifiedXML | Output | Verified extracted data |
| | | | in XML text |
| SearchVariable[ ] | Variable | Output | List of extracted |
| | | | variable's properties |
| String | szIndexXML | Output | An XML text containing |
| | | | index values |
| String[ ] | IndexVariables | Output | List variables marked as |
| | | | index. |
| string[ ] | IndexVariableValues | Output | Index variable's values |
| string[ ] | IndexVariableLeveledValues | Output | Index variable's leveled |
| | | | values |

DocItem( )

Purpose: Creates an instance of the Docltem class.

Syntax: DocItem (object_itemContext, string_imagePath, int _imagePageNo, AppSettingsOptions_appSettings);

| Parameter | Description |
|---|---|
| _itemContext | Tracks the caller-provided item context. This is |
| | an infrastructure to facilitate chained application |
| | architecture where one component would initiate the |
| | item processing while the other independent component |
| | would process the result of this data extraction |
| | processing. The library passes this object to the next |
| | component in the chain if one exists. |
| _filePath | Path of the image that needs to be processed, or |
| | the path of the OCR-generated XML from which the data |
| | needs to be extracted. |
| _pageNo | By default, pass 1 to process all pages in the |
| | TIFF file. If the processing needs to be restricted to a |
| | specific page, then pass its page number. |
| _appSettings | Configuration settings for the item's class documents. |

Returns:

DocItem( ) creates an instance for the given input image. An exception is thrown if any error occurs during the initialization of this instance.

NewItem( )

Purpose: Clears the contents of the object and reinitializes the current instance to a new item.

Syntax: Void NewItem (object_itemContext, string_imagePath, int _imagePageNo, AppSettingsOptions_appSettings);

| Parameter | Description |
|---|---|
| _itemContext | Tracks the caller-provided item context. This is an |
| | infrastructure to facilitate chained application architecture |
| | where one component would initiate the item |
| | processing, while the other independent component |
| | would process the result of this data extraction |
| | processing. The library passes this object to the |
| | next component in chain if one exists. |
| _filePath | Path of the image that needs to be processed, |
| | or the path of the OCR-generated XML from which |
| | the data needs to be extracted. |
| _pageNo | By default, pass 1 to process all pages in the TIFF file. |
| | If the processing needs to be restricted to a specific page, |
| | then pass its page number. |
| _appSettings | Configuration settings for the item's class documents. |

Returns: Void

Cleanup( )

Purpose: Clears the contents of the item and frees all intermediate results and resources used by the item.

Syntax: Void Cleanup (void);

Parameters: None

Returns: Void

PageFrameData Class

This class is used as an item context to track an item's information and its process results.

Fields:

| Data | Field | |
|---|---|---|
| Type | Name | Description |
| string | ImagePath | Path of the TIFF file from which this variable's value |
| | | was extracted |
| Int | PageNo | Page number in the image file where the value was |
| | | extracted. |

PageFrameData( )

Purpose: Creates an instance of the PageFrameData class.

Syntax: public PageFrameData(string_imagePath, int_pageNo);

| Parameter | Description |
|---|---|
| _imagePath | Path of the image that needs to be processed. |
| _pageNo | By default, pass 1 to process all pages in the TIFF file. |
| | If the processing needs to be restricted to a specific page, |
| | then pass its specific page number. |

Returns:

PageFrameData( ) creates an instance for the given input image. An exception is thrown if any error occurs during the initialization of this instance.

SearchVariable Class

This class provides a set of information associated with the extracted data. This information is generated by the library during data extraction.

Fields:

| Data | | | |
|---|---|---|---|
| Type | Field Name | Type | Description |
| Object | Context | Input | Item context |
| String | Name | Output | Name of the variable |
| String | Caption | Output | Caption/Description of the variable |
| | | | for display |
| string | Value | Output | Extracted value for the this variable |
| string | Suggested | Output | Suggested value for this variable |
| | Value | | |
| string | ImagePath | Output | Path of the TIFF file from which this |
| | | | variable's value was extracted |
| Int | PageNo | Output | Page number within the above image |
| | | | file where the value was extracted |
| Double | ZoneX | Output | Left position of the region covering |
| | | | the extracted value in points scale |
| Double | ZoneY | Output | Top position of the region covering |
| | | | the extracted value in points scale |
| Double | ZoneWidth | Output | Width of the region covering the |
| | | | extracted value in points scale |
| Double | ZoneHeight | Output | Height of the region covering the |
| | | | extracted value in points scale |
| Int | Accuracy | Output | Accuracy scale |

| Data Type | Field Name | Type | Description |
|---|---|---|---|
| NameValue[ ] | Extended- | Output | Set of name/value pair |
| | Properties | | associated with this value |
| | | | extraction. This is provided to |
| | | | extend the functionality of this |
| | | | application. This can include |
| | | | the set of information that is |
| | | | needed for integration, how the |
| | | | data needs to be handled, where |
| | | | the data needs to be sent and |
| | | | so on. |

ServiceUtility Class

This class exposes a set of library calls that can be called by third-party applications to perform data extraction processes. All functions in this class are static (they do have to be used with an object).

ProcessJobItem( )

Purpose: Performs the data extraction from the given image.

Syntax: ProcessPhase ProcessJobltem(JobContext_jobContext, Docltem _item, out Exception_exception);

| Parameter | Type | Description |
|---|---|---|
| _jobContext | Input | This provides the data extraction information |
| _item | Input | The item for which the data extraction needs |
| | | to be done. |
| _exception | Output | Return the exception information if any |
| | | error occurs during data extraction process. |

Returns: A ProcessPhase enumeration value is returned indicating the last phase that has been completed successfully. The phase values are:

UnknowPhase,

PreProcessing,

ImageProcessing,

OCRRecognition,

DataExtraction,

Verification,

Indexing,

PostProcessing,

Completion

If a value other than Completion is returned, the next value (from the list) is the phase where the failure occurred.

FindVariableValue( )

Purpose: Performs data extraction from the XML document which was generated as part of the earlier data extraction using an OCR document as the input. It extracts data as dictionary terms.

Syntax: ProcessPhase FindVariableValue(JobContext_jobContext, DocItem_item, out Exception_exception);

| Parameter | Type | Description |
|---|---|---|
| _jobContext | Input | Provides the data extraction information |
| _item | Input | Item for which the data extraction needs to be |
| | | done |
| _exception | Output | Returns the exception information |
| | | if an error occurs during the data |
| | | extraction process |

Returns: A ProcessPhase enumeration value is returned indicating the last phase that has been completed successfully. The phase values are:

UnknowPhase,

PreProcessing,

ImageProcessing,

OCRRecognition,

DataExtraction,

Verification,

Indexing,

PostProcessing,

Completion

If a value other than Completion is returned, the next value (from the list) is the phase where the failure occurred.

Collate( )

Purpose: Performs the image collation. This function can either be used to collate multiple images in to single image file or separate single, multi-page images in to multiple images.

Syntax: void Collate(PageFrameData[]_pageInfo, string _targetImagePath, EncoderValue_compressionType);

| Parameter | Type | Description |
|---|---|---|
| _pageInfo | Input | Contains the set of information about |
| | | what page of the image should be inserted at |
| | | what page in the new target image |
| _targetImagePath | Input | Path where the newly created image should |
| | | be saved |
| _compressionType | Input | Type of compression that needs to be |
| | | applied on the newly created image |

Returns: True (if successful) or False (if it fails)

ChangeCompressionMode( )

Purpose: Saves the source image in the target path with the specified compression applied to it. This function can be also used to remove any compression used in the source image.

Syntax: void ChangeCompressionMode(string_srcImage, string _targetImage, EncoderValue_compressionType);

| Parameter | Type | Description |
|---|---|---|
| _srcImage | Input | Input image on which the specified |
| | | compression needs to be applied |
| _targetImage | Input | Path where the updated image needs to be |
| | | saved |
| _compressionType | Input | Type of compression that needs to be applied |

Returns: True (if successful) or False (if it fails)

ImageProperty Class

This class exposes a set of library calls that can be called by third-party applications to validate whether or not the given image is OCR friendly (that is, the OCR engine recognizes it as an acceptable image).

IsOCRFriendlyImage(string_imagePath)

Purpose: Checks whether the image will be accepted for OCR.

Syntax: bool IsOCRFriendlyImage(string_imagePath);

| Parameter | Type | Description |
|---|---|---|
| _imagePath | Input | Image file |

Returns:

Returns true if the image will be accepted for OCR.

An image will be rejected for OCR if any of the following conditions are true:
It uses compression that is not supported by the OCR engine.
Either the X- or Y-axis resolution is greater than 300 dpi.
Either the height or width of the image is greater that 6600 pixels.

IsOCRFriendlyImage(image_image)

Purpose: Checks whether the image will be accepted for OCR.

Syntax: bool IsOCRFriendlyImage(string_imagePath);

| Parameter | Type | Description |
|---|---|---|
| _image | Input | Image object |

Returns: True if the image is accepted by the OCR engine.

UsesOCRFrinedlyCompression(string_imagePath)

Purpose: Checks whether the image uses compression that is accepted by the OCR engine.

Syntax: bool UsesOCRFriendlyCompression(string_imagePath);

| Parameter | Type | Description |
|---|---|---|
| _imagePath | Input | Image file |

Returns:

Returns true if the image uses compression that is accepted by the OCR engine.

SubmitIt Server Image Collaborator API Guide© 2004 Sand Hill Systems 18

UsesOCRFrinedlyCompression(Image_image)

Purpose: Checks whether the image uses compression that is accepted by the OCR engine.

Syntax: bool UsesOCRFriendlyCompression(string_imagePath);

| Parameter | Type | Description |
|---|---|---|
| _image | Input | Image object |

Returns:

Returns true if the image uses compression that is accepted by the OCR engine. SubmitIt Server Image Collaborator API Guide C© 2004 Sand Hill Systems 19

ImageUtility Class

This class exposes a set of library calls that can be called by third party applications to manipulate input images making them acceptable to the OCR engine. All functions in this class are static (they do have to be used with an object).

ConvertToOCRFriendlyImage(string_srcImage, string_targetImage)

Purpose: Replaces the compression technique used in the image with a compression technique that is acceptable to the OCR engine.

Syntax: void ConverToOCRFriendlyImage(string_srcImage, string _{'}targetImage);

| Parameter | Type | Description |
|---|---|---|
| _srcImage | Input | Source image file path |
| _targetImage | Input | Target image file path where the modified image |
| | | is saved |

Returns: True (if successful) or False (if it fails)

Sample Code

The following C# sample code is used to process a single .tif file (which can have one or more pages):

1. Include SHS.ImageDataExtractor.DLL in the project by browsing to the SHSimagecollaborator\bin directory.

2. Include the following code as part of your calling application:

using System;

using SHS.ImageDataExtractor; —This is the namespace that needs to be included in the code. Also as part of the project SHS.ImageDataExtractor.DLL

```
public class Sample
{
  public static void Main( )
  {
    Exception ex;
    JobContext jobContext = new JobContext
    (“C:\SHSImageCollaborator\BankStatementsSettings.xml”, false,
    false);
    DocItem docItem = new DocItem(null, “C:y\Temp\image.tif”, 1,
    jobContext.AppSettings);
    ServiceUtility.ProcessJobItem(jobContext, docItem, out ex);
    \\ Pick the original image from the source directory after the
    completion of the process. API will not delete this file. This file
    cleanup has to be done by the calling application.
    if (ex != null)
    HandleError( ); // User functions
    else
    UploadResult( ); // User functions
    docItem.Cleanup( );
  }
}
```

Where BankStatementsSettings.xml is the application setting which includes details including:
The appropriate dictionary to use
Location of the Work file folders

For each document group the user can choose to have separate setting files. The following file shows a sample BankStatementsSettings.xml:

```
  <?xml version=“1.0” ?>
- <AppSettingsOptions xmlns:xsd=“ http://www.w3.org/2001/XMLSchema” xmlns:xsi=“
    http://www.w3.org/2001/XMLSchema-instance”>
<mSelectedReportFormat>3</mSelectedReportFormat>
<mSaveReportAsFile>true</mSaveReportAsFile>
<mOpenLastWS>false</mOpenLastWS>
<mLogAllErrors>true</mLogAllErrors>
<mShowAllErrors>true</mShowAllErrors>
<mShowExcelSheet>false</mShowExcelSheet>
<mOCRoutputTempLocation>C:\SHSImageCollaborator\Data\Process\OCROutput</mOCR
    outputTempLocation>
<mOutputFolderLocation>C:\SHSImageCollaborator\Data\Output\UnverifiedOutput
    </mOutputFolderLocation>
<mVerifiedOutputFolderLocation>C:\SHSImageCollaborator\Data\Output\VerifiedOutput
    </mVerifiedOutputFolderLocation>
<mXMLFileSplitting>0</mXMLFileSplitting>
<mDefaultDocSpecGestureFilePath>C:\SHSImageCollaborator\Config\Gesture\Document_{—}
    Specific_Gesture.xml</mDefaultDocSpecGestureFilePath>
<mDefaultDictionaryPath>C:\SHSImageCollaborator\Config\Dictionary\Empty_Dictionary.
    DIC</mDefaultDictionaryPath>
<mExcelSheetPath>C:\SHSImageCollaborator\Config\Callout\BankAccts.xls</mExcelSheetPath>
<mImageCheckingParameterFilePath>C:\SHSImageCollaborator\Config\Application
Settings\IC.xml</mImageCheckingParameterFilePath>
<mInvalidFilesStorageLocation>C:\SHSImageCollaborator\Data\Process\InvalidFiles</
    mInvalidFilesStorageLocation>
<mPackageIdentificationTblFilePath>C:\SHSImageCollaborator\Config\Application
    Settings\Test.tbl</mPackageIdentificationTblFilePath>
<mImageIdentificationTblFilePath>C:\SHSImageCollaborator\Config\Application
    Settings\TestGMAC.tbl</mImageIdentificationTblFilePath>
<mOutputPackageCreationPath>C:\SHSImageCollaborator\Data\Process\PackageOutput
    </mOutputPackageCreationPath>
<mPollingLocation>C:\SHSImageCollaborator\Data\Input\PollingLocation</mPollingLocation>
<mZonefilesFolder>C:\SHSImageCollaborator\Config\Zones</mZonefilesFolder>
<mAutoClassify>false</mAutoClassify>
<mUnidentifiedFilesStorageLocation>C:\SHSImageCollaborator\Data\Process\UnidentifiedFiles
    </mUnidentifiedFilesStorageLocation>
<mPackgerFolderNamePrefix>Folder</mPackgerFolderNamePrefix>
<mUnIdentifiedPackageName>Default Package</mUnIdentifiedPackageName>
<mUnIdentifiedDocumentName>Default Document</mUnIdentifiedDocumentName>
<mEmbedDataWithMasterImage>true</mEmbedDataWithMasterImage>
<mInputFilesSorting>1</mInputFilesSorting>
<mPreIdentificationEnhancementOptionsFile>C:\SHSImageCollaborator\Config\Application
    Settings\PreIdentificationEnhancement.ini</mPreIdentificationEnhancementOptionsFile>
<mUnIdentifiedImagesEnhancementOptionsFile>C:\SHSImageCollaborator\Config\Application
    Settings\UnIdentificationEnhancement.ini</mUnIdentifiedImagesEnhancementOptionsFile>
<mImageCollationFolderPath>C:\SHSImageCollaborator\Data\Output\CollatedFiles
    </mImage CollationFolderPath>
<mOCRSettingsPath>C:\SHSImageCollaborator\Config\Application
    Settings\OCRSettings.xml</mOCRSettingsPath>
<mNotRecognizedImageFilePath>C:\SHSImageCollaborator\Config\Application
    Settings\filecouldnot.jpg</mNotRecognizedImageFilePath>
<mCollationKey>BankName</mCollationKey>
<mCollatedFilesCompressionType>CompressionCCITT4</mCollatedFilesCompression
Type>
<mIndexingvariableFilePath>C:\SHSImageCollaborator\Config\Application
    Settings\IndexVariables.xml</mIndexingvariableFilePath>
<mIndexingFolderPath>C:\SHSImageCollaborator\Data\Output\index<mIndexingFolderPath>
<mFileStore>C:\SHSImageCollaborator\bin\SHS.ImageDataExtractorFileStore.dll</mFileStore>
<mFileStoreClassUrl>SHS.ImageDataExtractorFileStore.JobStore</mFileStoreClassUrl>
<mEnableCleanUp>false</mEnableCleanUp>
  </AppSettingsOptions>
```

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method for electronic document management using at least one computer comprising the steps of:
receiving an electronic document including document image data;
storing said electronic document including document image data;
automatically extracting data from said electronic document; and
indexing the document based upon the extracted data.

2. A method according to claim 1, wherein said step of receiving includes the step of receiving said electronic document from a facsimile machine.

3. A method according to claim 1, wherein said step of receiving includes the step of receiving said electronic document from a document scanner.

4. A method according to claim 1, further including the step of verifying that the received document image data has predetermined properties.

5. A method according to claim 4, wherein the step of verifying includes the step of verifying that the received electronic document comprises a TIF image.

6. A method according to claim 4, further including the step of placing the received document in an invalid files folder if the document image data does not have the predetermined properties.

7. A method according to claim 1, further including the step of enhancing the document image data.

8. A method according to claim 7, wherein the step of enhancing the document image data includes the step of eliminating erroneous data.

9. A method according to claim 8, wherein said step of eliminating erroneous data includes the step of eliminating watermark-related data.

10. A method according to claim 8, wherein said step of eliminating erroneous data includes the step of eliminating handwritten-notation related data.

11. A method according to claim 7, wherein the step of enhancing the document image data includes the step of rotating the image data.

12. A method according to claim 1, further including the step of matching the received document image data to a document template.

13. A method according to claim 12, wherein a document template has associated search zones from which data is to be extracted and further including the step of applying at least one search zone associated with a template to received document image data if a matching template is found.

14. A method according to claim 1, further including the step of performing optical character recognition on received document image data.

15. A method according to claim 1, wherein said at least one computer includes a memory including at least one dictionary file and wherein the step of automatically extracting data includes the step of searching the received document image data for an entry in said at least one dictionary file.

16. A method according to claim 15, wherein the step of searching further includes the step of conducting a regular-expression search of received document image data for entries of said at least one dictionary.

17. A method according to claim 1, wherein said at least one computer includes a memory including a dictionary file, further including the step of writing entries of terms for extraction from received document image data into said dictionary file.

18. A method according to claim 1, further including the step of converting said document image data to a standard format.

19. A method according to claim 18, wherein said standard format is XML.

20. A method according to claim 18, wherein said standard format is HTML.

21. A method according to claim 1, further including the step of verifying that the extracted data is correct.

22. A method according to claim 21, further including the step of correcting errors in extracted data.

23. A method according the claim 1, wherein said document image data represents a bank statement and the extracted data is an account number.

24. A method according to claim 1, further including the step of collating received electronic documents.

25. A method for electronic document management using at least one computer having an associated memory comprising the steps of:
receiving an electronic document including document image data from a facsimile machine, or a document scanner, or a computer system;
storing said document image data in predetermined storage locations in said memory;
monitoring said predetermined storage locations for received document image data; and
automatically extracting data from said document image data in response to the detection of document image data in said predetermined storage locations.

26. A method according to claim 25, further including the step of indexing the received document based upon the extracted data.

27. A method according to claim 25, wherein said step of monitoring includes the step of periodically checking said predetermined storage locations to determine if document image data has been received from at least one of said facsimile machine, said document scanner, or said computer system.

28. A method according to claim 25, further including the step of verifying that the received document image data has predetermined properties.

29. A method according to claim 28, wherein the step of verifying includes the step of verifying that the received electronic document comprises a TIF image.

30. A method according to claim 25, further including the step of enhancing the document image data.

31. A method according to claim 30, wherein the step of enhancing the document image data includes the step of eliminating erroneous data.

32. A method according to claim 25, further including the step of matching the received document image data to a document template.

33. A method according to claim 32, wherein a document template has associated search zones from which data is to be extracted and further including the step of applying at least one search zone associated with a template to received document image data if a matching template is found.

34. A method according to claim 25, further including the step of performing optical character recognition on received document image data.

35. A method according to claim 25, wherein said memory includes a dictionary file and wherein the step of automatically extracting data includes the step of searching the received document image data for an entry in said dictionary file.

36. A method according to claim 35, wherein the step of searching further includes the step of conducting a regular-expression search of received document image data for dictionary entries.

37. A method according to claim 25, wherein said memory including a dictionary file, further including the step of writing entries of terms for extraction from received document image data into said dictionary file.

38. A method according to claim 25, further including the step of converting said document image data to a standard format.

39. A method according to claim 38, wherein said standard format is XML.

40. A method according to claim 25, further including the step of verifying that the extracted data is correct.

41. A method according to claim 40, further including the step of correcting errors in extracted data.

42. A method according the claim 25, wherein said document image data represents a bank statement and the extracted data is an account number.

43. A method according to claim 25, further including the step of collating received electronic documents.

44. A document management system including at least one computer comprising:
an input image data receiver for receiving electronic documents including document image data;
a document image identifier for attempting to recognize received electronic documents;
a data extractor responsive to said document image identifier for extracting data from received electronic documents; and
an image processor for organizing received documents using data extracted from said received electronic documents.

45. A document management system according to claim 44, wherein said input image data receiver receives said electronic document from a facsimile machine.

46. A document management system according to claim 44, wherein said input image data receiver receives said electronic document from a document scanner.

47. A document management system according to claim 44, further including an image verifier for verifying that the received document image data has predetermined properties.

48. A document management system according to claim 47, wherein said image verifier verifies that the received electronic document comprises a TIF image.

49. A document management system according to claim 44, further including an image enhancing module for enhancing the document image data.

50. A document management system according to claim 49, wherein said image enhancer is operable to eliminate erroneous data.

51. A document management system according to claim 49, wherein said image enhancer eliminates watermark-related data.

52. A document management system according to claim 49, wherein said image enhancer is operable to eliminate handwritten-notation related data.

53. A document management system method according to claim 49, wherein said image enhancer rotates the image data.

54. A document management system method to claim 44, wherein said document image identifier matches the received document image data to a document template.

55. A document management system according to claim 54, wherein a document template has associated search zones from which data is to be extracted and wherein said image processor applies at least one search zone associated with a template to received document image data if a matching template is found.

56. A document management system according to claim 44, further including an optical character recognition module for operating on received document image data.

57. A document management system according to claim 44, wherein said at least one computer includes a memory including a dictionary file and wherein said data extractor extracts data by searching the received document image data for an entry in said dictionary file.

58. A document management system according to claim 57, wherein said data extractor conducts a regular-expression search of received document image data for dictionary entries.

59. A document management system according to claim 44, wherein said image processor is operable to convert said document image data to a standard format.

60. A document management system according to claim 59, wherein said standard format is XML.

61. A document management system according to claim 59, wherein said standard format is HTML.

62. A document management system according to claim 44, further including a data verification system for verifying that the extracted data is correct.

63. A document management system according to claim 62, wherein said data verification system is operable to correct errors in extracted data.

64. A document management system according the claim 44, wherein said document image data represents a bank statement and the extracted data is an account number.

65. A document management system according to claim 44, wherein said image processor is operable to collate received electronic documents after they have been processed.

66. A method for electronic document management using at least one computer having an associated memory comprising the steps of:
receiving a plurality of electronic documents including document image data from a facsimile machine, or a document scanner, or a computer system;
storing said plurality of electronic documents including said document image data in predetermined storage locations in said memory;
analyzing said document image data of a first of said plurality of electronic documents to determine its document type;
sorting said first electronic document based upon its determined document type; and
extracting data from said first electronic document.

67. A method according to claim 66, wherein said analyzing step includes the step of determining whether said first document is a bank statement type document.

68. A method according to claim 66, further including the steps of analyzing said document image data of a second of said plurality of electronic documents to determine its document type, and processing said first and second electronic documents in a common processing path if the first and second documents are of the same type.

69. A method according to claim 66, further including the step of indexing the first document based upon the extracted data.

70. A method according to claim 66, further including the step of verifying that the received document image data has predetermined properties.

71. A method according to claim 70, wherein the step of verifying includes the step of verifying that the received electronic document comprises a TIF image.

72. A method according to claim 66, further including the step of enhancing the document image data of said first document.

73. A method according to claim 72, wherein the step of enhancing the document image data includes the step of eliminating erroneous data.

74. A method according to claim 66, further including the step of matching the received document image data to a document template.

75. A method according to claim 74, wherein a document template has associated search zones from which data is to be extracted and further including the step of applying at least one search zone associated with a template to received document image data if a matching template is found.

76. A method according to claim 66, further including the step of performing optical character recognition on received document image data of said first document.

77. A method according to claim 66, wherein said memory includes a dictionary file and further including the step of searching the received document image data for an entry in said dictionary file.

78. A method according to claim 77, wherein the step of searching further includes the step of conducting a regular-expression search of received document image data for dictionary entries.

79. A method according to claim 66, further including the step of converting said document image data of said first document to a standard format.

80. A method according to claim 79, wherein said standard format is XML.

81. A method according to claim 66, further including the step of verifying that the extracted data is correct.

82. A method according the claim 66, wherein said document image data represents a bank statement and the extracted data is an account number.

83. A method according to claim 66, further including the step of collating received electronic documents.

84. A method for electronic document management using at least one computer having an associated memory comprising the steps of:
receiving an electronic document including document image data from a facsimile machine, or a document scanner, or a computer system;
storing said document image data in said memory;
identifying a region on said electronic document expected to contain desired information; and
searching said region for said desired information.

85. A method according to claim 84, further including the steps of identifying the format of said desired information, and searching said region for said desired information having the identified format.

86. A method according to claim 85, wherein said format of desired information is specified using a regular expression.

87. A method according to claim 84, wherein said desired information is a document date.

88. A method according to claim 84, wherein said desired information is an account number.

89. A method according to claim 84, wherein said step of identifying a region includes the step of accessing the location of said region from at least one dictionary.

90. A method according to claim 84, wherein said step of identifying includes the step of identifying a certain proximate location on said electronic document of a logo.

91. A method according to claim 84, further including the step of indexing the received document based upon said desired information.

92. A method according to claim 84, further including the step of verifying that the received document image data has predetermined properties.

93. A method according to claim 92, wherein the step of verifying includes the step of verifying that the received electronic document comprises a TIF image.

94. A method according to claim 84, further including the step of enhancing the document image data.

95. A method according to claim 94, wherein the step of enhancing the document image data includes the step of eliminating erroneous data.

96. A method according to claim 84, further including the step of matching the received document image data to a document template.

97. A method according to claim 96, wherein a document template has associated search zones from which data is to be extracted and further including the step of applying at least one search zone associated with a template to received document image data if a matching template is found.

98. A method according to claim 84, further including the step of performing optical character recognition on received document image data.

99. A method according to claim 84, wherein said memory includes a dictionary file and wherein the step of automatically extracting data includes the step of searching the received document image data for an entry in said dictionary file.

100. A method according to claim 99, wherein the step of searching further includes the step of conducting a regular-expression search of received document image data for dictionary entries.

101. A method according to claim 84, wherein said memory including a dictionary file, further including the step of writing entries of terms for extraction from received document image data into said dictionary file.

102. A method according to claim 84, further including the step of converting said document image data to a standard format.

103. A method according to claim 102, wherein said standard format is XML.

104. A method according to claim 84, further including the step of verifying that the extracted data is correct.

105. A method according to claim 104, further including the step of correcting errors in extracted data.

106. A method according the claim 84, wherein said document image data represents a bank statement and the desired information is an account number.

107. A method according to claim 84, further including the step of collating received electronic documents

108. A method for electronic document management using at least one computer having an associated memory comprising the steps of:
receiving an electronic document including document image data from a facsimile machine, or a document scanner, or a computer system;
storing said document image data in said memory;
accessing a set of alternative expressions for a term to be searched;
searching said electronic document for a match for any one of said set of alternative expressions of said term to be searched.

109. A method according to claim 108, further including the steps of identifying the format of information to be searched, and searching said document for said desired information.

110. A method according to claim 109, wherein said format of said information to be searched is specified using a regular expression.

111. A method according to claim 108, wherein said information to be searched is a document date.

112. A method according to claim 108, wherein said set of alternative expressions are accessed from at least one accessible dictionary.

113. A method according to claim 108, further including the step of indexing the received document based upon the term to be searched.

114. A method according to claim 108, further including the step of monitoring said memory to determine if said document image data is stored and automatically extracting image data in response to detecting that said document image data is stored.

115. A method according to claim 114, wherein said step of monitoring includes the step of periodically checking predetermined storage locations to determine if document image data has been received from at least one of said facsimile machine, a document scanner, and a computer system.

116. A method according to claim 108, further including the step of verifying that the received document image data has predetermined properties.

117. A method according to claim 116, wherein the step of verifying includes the step of verifying that the received electronic document comprises a TIF image.

118. A method according to claim 108, further including the step of enhancing the document image data.

119. A method according to claim 118, wherein the step of enhancing the document image data includes the step of eliminating erroneous data.

120. A method according to claim 108, further including the step of matching the received document image data to a document template.

121. A method according to claim 120, wherein a document template has associated search zones from which data is to be extracted and further including the step of applying at least one search zone associated with a template to received document image data if a matching template is found.

122. A method according to claim 108, further including the step of performing optical character recognition on received document image data.

123. A method according to claim 108, wherein said memory includes a dictionary file and wherein the step of automatically extracting data includes the step of searching the received document image data for an entry in said dictionary file.

124. A method according to claim 123, wherein the step of searching further includes the step of conducting a regular-expression search of received document image data for dictionary entries.

125. A method according to claim 108, wherein said memory including a dictionary file, further including the step of writing entries of terms for extraction from received document image data into said dictionary file.

126. A method according to claim 108, further including the step of converting said document image data to a standard format.

127. A method according to claim 126, wherein said standard format is XML.

128. A method according to claim 108, further including the step of verifying that the extracted data is correct.

129. A method according the claim 108, wherein said document image data represents a bank statement and the term is an account number.

130. A method according to claim 108, further including the step of collating received electronic documents.

131. A method for electronic document management using at least one computer having an associated memory comprising the steps of:
receiving an electronic document including document image data from a facsimile machine, or a document scanner, or a computer system, said document having at least one key term;
storing said document image data in said memory;
accessing a stored dictionary; and
identifying at least one key term in said document using information obtained from said dictionary.

132. A method according to claim 131, wherein said key term has an associated value in said electronic document and further including the step of storing said associated value.

133. A method according to claim 132, further including the step of generating a table containing dictionary entries and their corresponding associated values.

134. A method according to 131, wherein said dictionary identifies a set of synonyms that represent a key term.

135. A method according to 131, wherein said key term is a user's account number.

136. A method according to claim 131, further including the step of verifying that the received document image data has predetermined properties.

137. A method according to claim 136, wherein the step of verifying includes the step of verifying that the received electronic document comprises a TIF image.

138. A method according to claim 131, further including the step of enhancing the document image data.

139. A method according to claim 138, wherein the step of enhancing the document image data includes the step of eliminating erroneous data.

140. A method according to claim 131, further including the step of matching the received document image data to a document template.

141. A method according to claim 140, wherein a document template has associated search zones from which data is to be extracted and further including the step of applying at least one search zone associated with a template to received document image data if a matching template is found.

142. A method according to claim 131, further including the step of performing optical character recognition on received document image data.

143. A method according to claim 131, further including the step of searching the received document image data for an entry in said dictionary.

144. A method according to claim 143, wherein the step of searching further includes the step of conducting a regular-expression search of received document image data for dictionary entries.

145. A method according to claim 131, further including the step of writing entries of terms for extraction from received document image data into said dictionary.

146. A method according to claim 131, further including the step of converting said document image data to a standard format.

147. A method according to claim 146, wherein said standard format is XML.

148. A method according to claim 131, further including the step of verifying that the extracted data is correct.

149. A method according to claim 148, further including the step of correcting errors in extracted data.

150. A method according the claim 131, wherein said document image data represents a bank statement and the term is an account number.

151. A method according to claim 131, further including the step of collating received electronic documents

152. A method for electronic document management using at least one computer having an associated memory comprising the steps of:
receiving an electronic document including document image data from a facsimile machine, or a document scanner, or a computer system, said document having at least one key term;
creating a dictionary that contains terms desired to be recognized and extracted from a received document;
accessing said dictionary; and
identifying at least one key term in said received document using information obtained from said dictionary.

153. A method according to claim 152, further including the step of indexing the received document based upon the key terms.

154. A method according to claim 152, further including the step of verifying that the received document image data has predetermined properties.

155. A method according to claim 154, wherein the step of verifying includes the step of verifying that the received electronic document comprises a TIF image.

156. A method according to claim 152, further including the step of enhancing the document image data.

157. A method according to claim 156, wherein the step of enhancing the document image data includes the step of eliminating erroneous data.

158. A method according to claim 152, further including the step of matching the received document image data to a document template.

159. A method according to claim 158, wherein a document template has associated search zones from which data is to be extracted and further including the step of applying at least one search zone associated with a template to received document image data if a matching template is found.

160. A method according to claim 152, further including the step of performing optical character recognition on received document image data.

161. A method according to claim 152, further including the step of searching the received document image data for an entry in said dictionary.

162. A method according to claim 161, wherein the step of searching further includes the step of conducting a regular-expression search of received document image data for dictionary entries.

163. A method according to claim 152, further including the step of writing entries of terms for extraction from received document image data into said dictionary.

164. A method according to claim 152, further including the step of converting said document image data to a standard format.

165. A method according to claim 164, wherein said standard format is XML.

166. A method according to claim 152, further including the step of verifying that the extracted data is correct.

167. A method according to claim 166, further including the step of correcting errors in extracted data.

168. A method according the claim 152, wherein said document image data represents a bank statement and the extracted data is an account number.

169. A method according to claim 152, further including the step of collating received electronic documents.

170. A method for electronic document management using at least one computer having an associated memory comprising the steps of:
receiving an electronic document including document image data from a facsimile machine, or a document scanner, or a computer system, said document having at least one key term;
storing said document image data in said memory;
searching said electronic document for said key term;
accessing a first dictionary if said key term is present in said electronic document; and
accessing a second dictionary if said key term is not present in said electronic document.
